(19) United States
(12) Patent Application Publication
(10) Pub. No.: US 2026/0143100 A1
(43) Pub. Date: May 21, 2026

(54) PT/PT-Z CAMERA COMMAND, CONTROL & VISUALIZATION SYSTEM AND METHOD UTILIZING ARTIFICIAL INTELLIGENCE

(71) Applicant: Digital Path, Inc., Chico, CA (US)

(72) Inventors: Jim Higgins, Chico, CA (US); Scott Schifando, Chico, CA (US); Derek Higgins, Chico, CA (US); Ethan Higgins, Chico, CA (US); Jeremiah Lang, Chico, CA (US); David Grassi, Chico, CA (US)

(21) Appl. No.: 19/312,211

(22) Filed: Aug. 27, 2025

Related U.S. Application Data
(63) Continuation-in-part of application No. 18/363,566, filed on Aug. 1, 2023.
Application No. 18/363,566 is a continuation of application No. 17/814,632, filed on Jul. 25, 2022, now Pat. No. 12,309,340.
(60) Provisional application No. 63/260,788, filed on Aug. 31, 2021.

(51) Int. Cl. H04N 13/111; H04N 13/167; H04N 13/282

(52) U.S. Cl. CPC H04N 13/111; H04N 13/167; H04N 13/282; H04N 23/69; H04N 23/698

(57) ABSTRACT

A system and method for wildfire detection, monitoring, and consequence modeling integrate digital cameras with artificial intelligence to identify, track, and predict fire behavior. The system processes camera imagery, satellite data, environmental inputs, aircraft telemetry, and contextual information to detect ignition points, triangulate fire locations, and model projected fire spread. A fire propagation engine generates maps, graphs, and consequence estimates, including burned area, affected infrastructure, population exposure, and financial loss. Alerts are triggered based on detection and modeled impact, with filters to suppress false positives, merge repeated detections, and escalate based on user-defined risk thresholds. The system includes tools for managing prescribed fires, tracking smoke-only detections, and customizing alert logic by geography, asset proximity, or scenario. External datasets may be ingested via API or file upload to support consequence scoring and operational prioritization. Users may run simulations, analyze historical conditions, and export results for planning, response coordination, or regulatory reporting.

### CROSS-REFERENCE

This application claims priority to U.S. patent application Ser. No. 18/363,566 filed on Aug. 1, 2023 which is a continuation-in-part of U.S. patent application Ser. No. 17/814,632, now U.S. Pat. No. 12,309,340, filed on Jul. 25, 2022, which claims priority to U.S. patent application Ser. No. 63/260,788 filed on Aug. 31, 2021, all of which are incorporated herein for all purposes.

### FIELD OF THE INVENTION

The embodiments of the present invention relate to software and systems used to monitor and remotely control a network of visual, audio, and meteorological data capturing devices, augment device functionality, process data, display data and allow users and devices to upload data to improve user situational awareness.

### SUMMARY

The embodiments of the present invention broadly contemplate the use of various types of digital cameras, command and control software and systems (C&C system or C&C systems), 3^{rd} party system inputs, machine learning, artificial intelligence and a method and system to visually display data. The system may be used for a multitude of reasons including, but not limited to, providing rapid enhanced situational awareness for the public, emergency command centers, first responders responding to wildfires or other natural disasters, or other entities or situations where this system may be desired. This information may be used to make real-time decisions, such as determining when to evacuate a town in the path of a fire, deploying fire resources to a newly developed spot fire, and where to prioritize aircraft fire retardant drops. Digital cameras utilized may capture various wavelengths across the electromagnetic spectrum. Cameras may be located within various networks worldwide (including in outer space), may be mobile, attached to a vehicle (including aircraft) or affixed to a structure. Camera functionality types may include static, pan, tilt, and zoom or some combination thereof. Cameras may communicate with C&C systems over various network topologies and configurations.

The C&C systems may perform a variety of functions including, but not limited to, manually or automatically scheduling, capturing, processing, storing, sorting, displaying, retrieving, transmitting data, and communicating with 3rd party systems directly or through an Application Programming Interface (API). The C&C system may virtualize cameras in a way to provide scheduled image acquisition allowing multiple users and/or systems to simultaneously view their respective target areas from the same camera or cameras without interrupting other system or users'image capture requests. Said scheduled image acquisition may include panoramic image creation utilizing one or more images or videos captured by one or more cameras at one or more locations and combining said image(s) or video(s) to form a new panorama with up to a 360-degree field of view. Said C&C system may provide the ability for a C&C system user, the C&C system, a 3^{rd} party system or Artificial Intelligence (AI) to dynamically or statically select multiple points within an image, panoramic image, video or on a map and use those points to build a camera patrol pattern or collection of images in a vertical and/or horizontal grid manner to create an image quilt (quilt or quilts) that may be displayed and/or updated at desired time intervals. Said software, systems and functions may generate quilts by selecting desired camera names, camera icons or defining an area on a map then displaying one or more images, panoramic images, and/or videos where displayed imagery may be real-time, historical snap shots in time or a playback of timelapse imagery. During quilt timelapse playbacks, a user may view a single camera image full screen and then collapse the image back into the quilt without stopping the timelapse playback.

The embodiments of the present invention may improve emergency services resource allocation and response times. For example, during a 911 call for a new fire detection, dispatchers can type in GPS coordinates, an address, point of interest, intersection or any other location into the C&C system which may then move some or all cameras within a certain distance of the entered location to view the location, capture one or more images per camera, and then generate an image quilt displaying all the individual camera images simultaneously. The camera images may then update on a periodic basis. Camera images or videos may be projected onto two-dimensional (2D) or three-dimensional (3D) digital elevation models, street maps, satellite maps, elevation maps, or terrain maps to help emergency services personnel to quickly direct resources to the location or object of interest. The C&C system may allow users to click on a location on a 2D or 3D map or image to turn cameras to that location to capture one or more image(s) or video(s). The C&C system may utilize AI or Machine Learning (ML) to identify, detect, measure, locate, sort, alert, track, and/or display objects of interest such as fire or smoke. As used herein, Artificial intelligence is technology that enables a machine to simulate human behavior while machine learning is a subset of AI which allows a machine to automatically learn from past data without programming explicitly. Once detected, the C&C system may extract object boundaries by comparing historical and current visual data then analyze and predict the object's future change in direction, position, size, temperature, and movement over time, such as a fires growth path. Weather data may also be incorporated into fire growth modeling such as factoring in wind direction, wind speed, humidity and pressure levels utilizing field deployed sensors that report into the C&C system. Current and projected locations of objects of interest may be displayed on some form of map or other image. The C&C system may also prioritize, sort, select, unselect and/or display camera images or locations based on a user or system selected map area, an identified location of interest, AI object detection, satellite heat signature detection, camera user login counts, image view counts, or last moved cameras. The C&C system may also track, log, display and export all user actions within the system on a per camera, per user, per company, or global basis to improve user collaboration, situational awareness and possibly prevent camera control conflicts between users.

To support operational scalability and reduce alert fatigue, the system incorporates a filtering and suppression framework that identifies and manages both false positives and redundant detections. The filtering engine may suppress repeated non-fire events such as chimney smoke, dust, or industrial plumes, while also consolidating valid detections of the same fire across multiple cameras and time intervals into a single incident. Pixel-level analysis may be used to locate smoke or fire within an image, and when detections are confirmed, vectors from multiple camera angles may be combined with elevation data to triangulate the real-world location of the fire. This location may then be visualized on a map and used to drive downstream modeling, alerting, and response coordination. These filtering and triangulation tools allow the system to scale effectively across large camera networks and fire-prone regions without overwhelming users.

In one embodiment, the system includes a fire propagation modeling engine that simulates wildfire spread from AI-confirmed, user-defined, or API-submitted ignition points. These simulations may incorporate real-time and forecasted weather, fuel moisture, terrain, suppression activity, and satellite-derived inputs to estimate spread direction, time to impact, and consequence severity. Outputs may include projected burn perimeters, affected infrastructure, population exposure, and financial loss estimates, which may be visualized on maps or within dashboards and alert messages. In some embodiments, simulations are automatically triggered in response to new detections, with results embedded in associated alerts and paired with real-time camera imagery. The system may also automatically command nearby cameras to orient toward projected spread zones, enhancing situational awareness and visual confirmation. Consequence data such as burned area over time or impact to structures may be updated dynamically and used to prioritize response actions.

In certain embodiments, the system may further incorporate dynamic fuel moisture content modeling using multispectral satellite imagery and vapor pressure deficit indices to improve simulation accuracy under varying environmental conditions. Fire modeling capabilities may be used for real-time response as well as for forward-looking planning, including risk forecasting, insurance loss modeling, and public safety power shutoff (PSPS) scenario evaluation. The system may execute bulk simulations across thousands or millions of ignition points and assets, supporting use cases for utilities, insurers, and land managers. Additional modules may track vegetation encroachment near utility lines, recommend suppression strategies, and evaluate the effectiveness of mitigation treatments. In the context of prescribed burns, the system may suppress alerts within defined perimeters and time windows while retaining the ability to escalate if observed behavior deviates from expected fire characteristics. These integrated modeling and alerting tools transform the system into a comprehensive platform for wildfire detection, risk assessment, and operational coordination.

The embodiments of the present invention may include, but are not limited to, applications in fire surveillance, security surveillance, aircraft flight planning, animal behavior (such as migration patterns), seasonal, climate, vegetation, metrological and environmental changes. Weather data, topographic maps, satellite imagery, 2D maps, 3D maps, landmarks, messages, or any other desired information may be overlaid on camera images, videos or panoramic images created by the system or shown independent of the image elsewhere within a user's display. A user's geographic location may be identified from their personal device (such as a cell phone or tablet) GPS receiver and utilized within the C&C system to track users and display data relevant to the user's location. Users may be able to share their location and upload photos or video for others to see in the C&C system. Users may also share images, videos, timelapses, quilts, weather data or any combination thereof with other system users, or the public by copying or sharing a web link or posting directly to social media sites. The C&C system and image acquisition software may be installed and operated on any type of device or network capable of operating said software.

Other variations, embodiments and features of the present invention will become evident from the following detailed description, drawings, and claims.

### BRIEF DESCRIPTION OF THE DRAWINGS

FIG. 1 illustrates one process for generating a panoramic image, store it in a database and various ways the panoramic images may be used within the system according to the embodiments of the present invention;

FIG. 2 illustrates an exemplary C&C system network design according to the embodiments of the present invention;

FIG. 3 illustrates how various user requests to move a camera may be prioritized and scheduled according to the embodiments of the present invention;

FIGS. 4A-4C illustrate various exemplary camera movement sequences to generate up to a three hundred sixty (360) degree panoramic image according to the embodiments of the present invention;

FIG. 5 illustrates how panoramic images from various sites may be aligned to a target location and displayed for users'rapid situational awareness according to the embodiments of the present invention;

FIG. 6 illustrates how image acquisition servers may schedule image feeds for multiple users from a camera according to the embodiments of the present invention;

FIG. 7 illustrates a flow chart detailing how a user may search for a target location or click on a map to cause cameras to turn to view the target location and generate an image quilt according to the embodiments of the present invention;

FIG. 8 illustrates a flow chart detailing how a user may select a group of cameras on a map and generate an image quilt according to the embodiments of the present invention;

FIG. 9 illustrates a flow chart detailing how a user may identify a location on a map from a camera image according to the embodiments of the present invention;

FIG. 10 illustrates a flow chart detailing how AI may be utilized to analyze images to detect, locate and alert users when a new object of interest is identified according to the embodiments of the present invention;

FIG. 11 illustrates a modeler schematic detailing how AI may be able to predict object of interest changes over time and become more accurate over time as more data is captured according to the embodiments of the present invention;

FIG. 12 illustrates a schematic flow chart detailing how images are evaluated to be objects of interests “Hits”, metadata and geographic data is added according to the embodiments of the present invention;

FIG. 13 illustrates a schematic flow chart detailing how AI may be able to assist with filtering out certain “Hits” from being identified as “Incidents” according to the embodiments of the present invention;

FIG. 14 illustrates how multiple software-defined radios use signal strength and angle of arrival to triangulate the source of a transmission according to the embodiments of the present invention;

FIG. 15 illustrates how distributed SDRs detect a high-energy RF event, triangulate its location, trigger nearby cameras and AI fire detection, and display results with camera and fire overlays according to the embodiments of the present invention;

FIG. 16 illustrates dual ML pipelines that infer site-specific weather in sensor-limited areas and correct anomalies in real-time feeds for fire modeling input according to the embodiments of the present invention;

FIG. 17 illustrates how a camera performs standard and zoomed-in panoramas, using AI to detect anomalies and trigger zoomed confirmation or proactive sweeps according to the embodiments of the present invention;

FIG. 18 illustrates how a panoramic or PTZ camera uses celestial calibration and tilt sensing to trace image pixels to GPS coordinates using a digital elevation model according to the embodiments of the present invention;

FIG. 19 illustrates how terrain-based calibration uses DEMs and panoramic imagery to align camera metadata through synthetic view matching according to the embodiments of the present invention;

FIG. 20 illustrates how the system estimates fire or smoke location using pixel matching, terrain collision, and camera metadata according to the embodiments of the present invention;

FIG. 21 illustrates how the system deduplicates repeated fire detections across multiple cameras using metadata, pixel similarity, and time proximity according to the embodiments of the present invention;

FIG. 22 illustrates how AI-verified Hits are shown on a map with metadata, allowing operators to promote them to alerts or incidents based on location, modeled consequences, and operational judgment according to the embodiments of the present invention;

FIG. 23 illustrates how the system performs multi-step fire detection by first identifying smoke or fire in wide-angle imagery, then triggering zoomed-in capture for refined location estimation using pixel matching and metadata according to the embodiments of the present invention;

FIG. 24 illustrates how the system estimates a fire's ground origin using pixel-level analysis and triangulation across one or more camera images over time according to the embodiments of the present invention;

FIG. 25 illustrates how the system tracks smoke plume growth by measuring pixel area expansion across image sequences, escalating incidents when thresholds are exceeded according to the embodiments of the present invention;

FIG. 26 illustrates how users define and annotate false-positive detection zones, which are stored and used to suppress alerts for matching future detections according to the embodiments of the present invention;

FIG. 27 illustrates how smoke features extracted from camera imagery are used to estimate fire spread probability, direction, and speed, with optional integration of weather or fuels data according to the embodiments of the present invention;

FIG. 28 illustrates how the system ingests real-time geographic and operational context to dynamically adjust consequence risk levels for a detected fire according to the embodiments of the present invention.

FIG. 29 illustrates how an AI model maps the fire perimeter by analyzing spatial and temporal smoke behavior, including convergence across camera views according to the embodiments of the present invention;

FIG. 30 illustrates a two-phase training pipeline for the AI fire model: synthetic simulation followed by real-world calibration according to the embodiments of the present invention;

FIG. 31 illustrates an AI/ML architecture that ingests satellite, weather, imagery, aircraft, and contextual data through multiple encoders, fuses the features, and generates a fire spread map using transformer and convolutional layers according to the embodiments of the present invention;

FIG. 32 illustrates how FMC layers are generated using satellite bands, vegetation indices, and vapor pressure deficit index, and integrated into the fire spread modeling workflow according to the embodiments of the present invention;

FIG. 33 illustrates how modeled fire spread is intersected with infrastructure, population, and valuation datasets to calculate consequence metrics such as people at risk and estimated loss according to the embodiments of the present invention;

FIG. 34 illustrates how wildfire alerts are filtered, suppressed, or prioritized using rules based on incident overlap, model forecasts, and exposure of critical assets according to the embodiments of the present invention;

FIG. 35 illustrates how fire propagation model outputs are attached to alerts, encoded as geospatial layers, and delivered to dashboards or external platforms for operational use according to the embodiments of the present invention;

FIG. 36 illustrates how users configure alert thresholds from model outputs such as spread rate, smoke column height, or exposure severity, with logic to prioritize across incidents according to the embodiments of the present invention;

FIG. 37 illustrates how third-party alerts are ingested and displayed with metadata, enabling automated actions such as camera tasking, incident creation, or model execution according to the embodiments of the present invention;

FIG. 38 illustrates how the system analyzes fire spread forecasts, terrain data, and suppression zones to recommend resource deployment such as aircraft or engines according to the embodiments of the present invention;

FIG. 39 illustrates how operators draw fire lines or suppression features which are then evaluated by the model to simulate potential mitigation outcomes according to the embodiments of the present invention;

FIG. 40 illustrates how AI-derived fire risk forecasts are used to generate optimal staging locations based on terrain access, water sources, and travel time constraints according to the embodiments of the present invention;

FIG. 41 illustrates a dynamic dashboard that updates risk layers, ranks staging zones by impact potential, and applies tiered allocation logic with override capabilities according to the embodiments of the present invention;

FIG. 42 illustrates how fire threat levels are translated into alert tiers and routed to communication channels and user roles, with suppression logic to manage alert fatigue according to the embodiments of the present invention;

FIG. 43 illustrates how users initiate fire propagation simulations by selecting a map location, configuring weather and fuel inputs, and receiving projected burn area and impact data according to the embodiments of the present invention;

FIG. 44 illustrates how ignition points and asset references are ingested via API, with batch-mode fire spread simulations producing probabilistic impact zones and time-to-impact estimates according to the embodiments of the present invention;

FIG. 45 illustrates an interactive dashboard for viewing and adjusting wildfire consequence modeling outputs, with scenario filters by asset, risk level, and environmental inputs according to the embodiments of the present invention;

FIG. 46 illustrates how user-defined mitigation objectives like dozer lines and evacuations are evaluated against model outputs to assess feasibility, including countdowns and clearance rates according to the embodiments of the present invention;

FIG. 47 illustrates parallel fire spread simulations initiated from multiple utility assets, ranked by severity metrics such as population exposure, financial loss, and structural impact according to the embodiments of the present invention;

FIG. 48 illustrates how observed fire perimeters are ingested to reinitialize modeling, enabling forward projections, impact checks on locations of interest, and alert generation according to the embodiments of the present invention;

FIG. 49 illustrates a risk monitoring interface showing an asset filter panel, alert configuration panel, risk-coded map display, timeline graph, and active alerts list used to visualize, configure, and respond to infrastructure-specific wildfire risk according to the embodiments of the present invention;

FIG. 50 illustrates how the system simulates past fire conditions to identify utility assets with repeated wildfire exposure, producing frequency scores, heatmaps, and consequence statistics for grid hardening and planning according to the embodiments of the present invention;

FIG. 51 illustrates how the system simulates historical fire behavior from ignition points at utility assets using past weather and fuel data to generate ranked consequence metrics according to the embodiments of the present invention;

FIG. 52 illustrates a workflow for detecting utility assets repeatedly intersected by wildfire perimeters in historical simulations, visualized as exposure density maps for infrastructure risk analysis according to the embodiments of the present invention;

FIG. 53 illustrates how model outputs are compared to archived weather forecasts and actual fire outcomes to calibrate simulation accuracy, with outputs including deviation maps and overlay tools according to the embodiments of the present invention;

FIG. 54 illustrates how forecast data is used to estimate future fire impacts to utility assets, allowing for asset ranking by projected consequence to inform proactive mitigation according to the embodiments of the present invention;

FIG. 55 illustrates a dashboard panel showing forecasted fire risk metrics, including asset exposure statistics and a time-series view of risk evolution over the forecast window according to the embodiments of the present invention;

FIG. 56 illustrates how user-defined risk budgets are monitored against forecasted consequence outputs, with alerts triggered when thresholds are exceeded to support mitigation workflows according to the embodiments of the present invention;

FIG. 57 illustrates how simulated fire ignitions are used to evaluate actual PSPS boundaries under historical conditions, estimating avoided and residual fire impacts according to the embodiments of the present invention;

FIG. 58 illustrates how rule-based or weighted scoring is applied to infrastructure, population, and customer layers to calculate consequence impacts at both layer and aggregate levels according to the embodiments of the present invention;

FIG. 59 illustrates how the system divides a region into spatial grid cells and models ignition probability, fire spread potential, and consequence severity for each cell according to the embodiments of the present invention;

FIG. 60 illustrates how spatial grid cells are scored using terrain, fuel, weather, and ignition history to visualize ignition risk, spread rate, and consequence severity in map overlays according to the embodiments of the present invention;

FIG. 61 illustrates how simulated fire ignitions from utility assets along a line are processed to eliminate overlapping consequence zones, resulting in a unified impact footprint and accurate risk scoring according to the embodiments of the present invention;

FIG. 62 illustrates how the system consolidates impact zones from multiple utility line ignition simulations into a single, non-redundant view of system-wide fire consequences according to the embodiments of the present invention;

FIG. 63 illustrates how modeled fire risk and consequence severity are used to trigger alerts through multiple channels including email, SMS, push notifications, and dispatch systems according to the embodiments of the present invention;

FIG. 64 illustrates how the system tracks fire perimeter proximity to user-defined assets, applying buffer zones, polygon tools, and threshold logic to trigger alerts as fire lines approach according to the embodiments of the present invention;

FIG. 65 illustrates how the system simulates fires originating near a parcel to evaluate the specific exposure risk of that structure or location for insurance or mitigation purposes according to the embodiments of the present invention;

FIG. 66 illustrates how fire simulation data for each parcel is aggregated to produce exposure metrics including flame intensity, ember probability, and suppression difficulty, which are used to calculate a consequence score according to the embodiments of the present invention;

FIG. 67 illustrates how each parcel is treated as a target while the system runs ignition scenarios from surrounding grid cells across different weather profiles to calculate cumulative risk according to the embodiments of the present invention;

FIG. 68 illustrates how wildfire simulations are executed in batch across large insurance portfolios, with outputs rolled up by region to support exposure classification, pricing, and capital-at-risk estimation according to the embodiments of the present invention;

FIG. 69 illustrates how fire risk results are delivered through dashboards, APIs, and export files to support underwriting workflows, pricing tools, and regulatory filings according to the embodiments of the present invention;

FIG. 70 illustrates how simulations are refined near structures using high-resolution terrain, vegetation, and fuel data to improve the accuracy of parcel-level wildfire risk modeling according to the embodiments of the present invention;

FIG. 71 illustrates how the system uses a modular AI pipeline combining spatial encoders, environmental interpreters, and scoring layers to produce parcel-specific wildfire risk predictions according to the embodiments of the present invention;

FIG. 72 illustrates how structure loss data and historical fire perimeters are used to calibrate and improve fire risk models through a continuous feedback loop according to the embodiments of the present invention;

FIG. 73 illustrates how insurers simulate future environmental and development scenarios such as drought, construction, or mitigation to evaluate risk changes at both parcel and portfolio levels according to the embodiments of the present invention;

FIG. 74 illustrates how users define vegetation treatments, ingest pre-and post-treatment data, simulate fire behavior, and compare outcomes to assess the effectiveness of mitigation strategies according to the embodiments of the present invention;

FIG. 75 illustrates how AI-generated vegetation encroachment data is aligned with utility infrastructure and integrated into consequence models to prioritize vegetation management and ignition risk reduction according to the embodiments of the present invention;

FIG. 76 illustrates how users manage prescribed fire records within an interface that allows configuration of time windows, burn perimeters, assigned parties, and data permissions according to the embodiments of the present invention;

FIG. 77 illustrates how prescribed fire datasets are uploaded via API or manual input and rendered as interactive map layers to support situational awareness and alert suppression according to the embodiments of the present invention;

FIG. 78 illustrates how users configure suppression rules for prescribed burn alerts based on location, operational status, timing, and risk forecasts according to the embodiments of the present invention; and

FIG. 79 illustrates how prescribed fire behavior is evaluated against thresholds to suppress or escalate alerts, notify personnel, and reclassify events when deviation criteria are met according to the embodiments of the present invention.

### DETAILED DESCRIPTION

The embodiments of the present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention may be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

Applicant herein incorporates by reference for any and all purposes U.S. Pat. No. 6,831,921 entitled “Wireless Internet Access System,” U.S. Pat. No. 9,838,065 entitled “Methods and Systems for High-Capacity Wireless Broadband Delivery,” U.S. patent application Ser. No. 62/607,871 entitled “Wireless Internet Access System and Method of Using the Same,” U.S. Pat. No. 11,006,297 entitled “Wireless Remote Monitoring System and Data Collection and Control and Method of Using the Same” and U.S. patent application Ser. No. 63/260,788 entitled “PT/PT-Z Camera Command, Control & Visualization System and Method.”

### Camera Types, Locations, Uses

The embodiments of the present invention utilize one or more visual data capturing device(s) (“Camera” or “Cameras”) such as Pan Tilt (PT), Pan Tilt Zoom (PTZ), electronic Pan Tilt Zoom (ePTZ), Forward Looking InfraRed (FLIR), Multispectral and/or Hyperspectral cameras. Fixed Cameras such as security cameras, or doorbell cameras may also be incorporated into the C&C system and may employ digital ePTZ zoom to simulate movements to the extent possible. Cameras may be temporarily or permanently affixed to a structure, semi portable such as on a towable trailer that is setup at a desired location and later removed, configured to be air lifted and set into place at a desired vantage point via a helicopter, mounted to any sort of mobile vehicle including, but not limited to, cars, trucks, motorcycles, ATVs, UTVs, boats, airplanes, helicopters, and drones, or fully portable such as a user's mobile device (cell phone, laptop, tablet) and may be located and operate anywhere from underground or under water and into outer space. Cameras may be connected to and located within one or more internal, public, 3^{rd} party, or stand-alone network(s) worldwide. Cameras may be permanently installed throughout a geographic area or temporarily installed during an event such as a fire or other natural disaster. Cameras may receive power from the utility grid, battery, solar, wind, generator or any other power producing source. Camera imagery and data may be stored and accessed in a database or in some other data storage system (database) such as on the camera hardware, an onsite server, a server cluster, a remote server on the Internet, within a private network, or on a cloud service such as AWS. Camera data may include, but is not limited to, physical Camera data such as equipment type, serial number, make/model, GPS location, mounting structure type, site owner information, mobile camera or user location history, location elevation, Camera elevation or height above or below ground level, Camera software data such as firmware version, network configuration information, uptime, downtime, configuration files and other network performance data. Other data may also be derived and stored from the Camera(s) software, image(s), or video(s). Extracted data examples include, but are not limited to, Camera zoom level, azimuth, elevation angle, resolution, contrast, day/night mode, camera type (visual, near infrared, or IR), image and video timestamp(s), audio recordings, infrared temperature ranges by area within image(s) or video(s), last time a Camera moved or time duration since last movement, home location, patrol mode points, frame capture rate, text or image camera overlays, ambient temperature, fire perimeter boundary(ies), fire hot spot location(s) within image(s) or video(s), and/or other objects of interest and/or data. Collectively the visual image or video and derived data are referenced as “image” or “video” herein and meant to include both the visual image or video and derived data as they may be used within the C&C system.

### C&C System Network Design

One or more cameras may be configured to communicate directly or indirectly with one or more image acquisition Servers and/or C&C systems using one or more fiber, wired or wireless (including cellular or satellite) connections. Camera(s) may be configured for direct access using publicly accessible IP addresses with or without firewall rules for security or configured for private access using Private IP addresses and may use some form of protocol such as IEEE 802.1Q for security and communication with C&C systems that may be located on other networks. The C&C system and image acquisition software may be installed and operated on any type of device or network capable of operating said software including, but not limited to, one or more local network(s), remote location(s), physical server(s), virtualized server(s), cloud service(s) (such as AWS), browser window(s), user device(s) (such as a PC, laptop, tablet, or cellphone), or directly on the Camera(s) hardware and software.

### Image Acquisition Servers Moving Cameras/Network Design

The embodiments of the present invention may allow coordinated and scheduled visual data acquisition requests to be made via user(s), software, and/or machine input(s) to accommodate many different needs from one or more Camera(s) simultaneously. The C&C system or a user may utilize existing camera APIs and Software Development Kits (SDKs), 3^{rd} party APIs, the C&C system, physical servers, cloud hosted servers, AI, satellite data, and weather data or some combination thereof to sequentially or simultaneously move one or more Camera(s) to one or more static or dynamically generated position(s) based on user specified criteria, or the C&C system to may utilize various inputs to determine these dynamic Camera positions in real-time. As the C&C system requests one or more camera(s) to move to one or more new target location(s), the C&C system may extract image(s) and/or video(s), Camera orientation, user control data and any other desired information from the one or more camera(s). The C&C system may use one or more Servers including cloud Servers to: store images and/or videos, control camera movements and image acquisition, operate the C&C system, perform AI functions, and provide user access and display data. The Server(s) may operate independently or cooperatively and may be set up redundantly. The system may utilize one or more image acquisition Servers to collect one or more image(s) or video(s) from one or more camera(s) and forward them to a database or other Server for storage, review, and/or analysis. To reduce latency and improve image acquisition rates, image acquisition Servers may be located as close to Cameras as possible. By scheduling all visual data needs, Camera efficiency may be maximized and allow for different use needs to be simultaneously accommodated. A C&C system may utilize more than one image acquisition Server or cluster of Servers if different subsets of Cameras are located on different networks, which may ensure that an image acquisition Server is always as close as possible to each Camera or subset of Cameras. The image acquisition Server(s) may also manage user requests or requests from an image acquisition scheduler to move and/or control the camera or cameras connected to the image acquisition Server. Visual data acquisition requests include, but are not limited to, one-time captures, recurring captures at specific or random time intervals, 3^{rd} party captures, C&C system captures by users controlling Cameras, AI captures, user or C&C system generated manual or automatic panorama generations and/or visual data requests of a specific location for Cameras during a 911 call. The C&C system may prioritize requests based on defined priorities. A user or system request may be prioritized above other pending requests and cause the Camera(s) to immediately deliver an image or video to the user or system before returning to the queue of Camera image or video acquisitions scheduled to be collected. A timing mechanism or scheduler may be used to prevent too many users or system requests from delaying other pending and prioritized requests. Acquisition requests may utilize an API that routes each request to one or more image acquisition schedulers, the scheduler(s) then determine the optimal one or more image acquisition Server(s) to route the request based on the network(s) on which the desired Camera(s) are located. Once the Camera network(s) are determined, the scheduler commands the Camera(s) to orient themselves to the desired vantage point(s), capture the targeted image(s) or video(s), then transmit the visual data to the C&C system. The C&C system then store and display the visual data for one or more user(s), send the data to internal or 3^{rd} party AI/ML algorithms to scan for, detect, display and/or alert on any newly found objects of interest, or to store the visual data in a historical image archive for later retrieval by various users, websites and/or analysis by various systems.

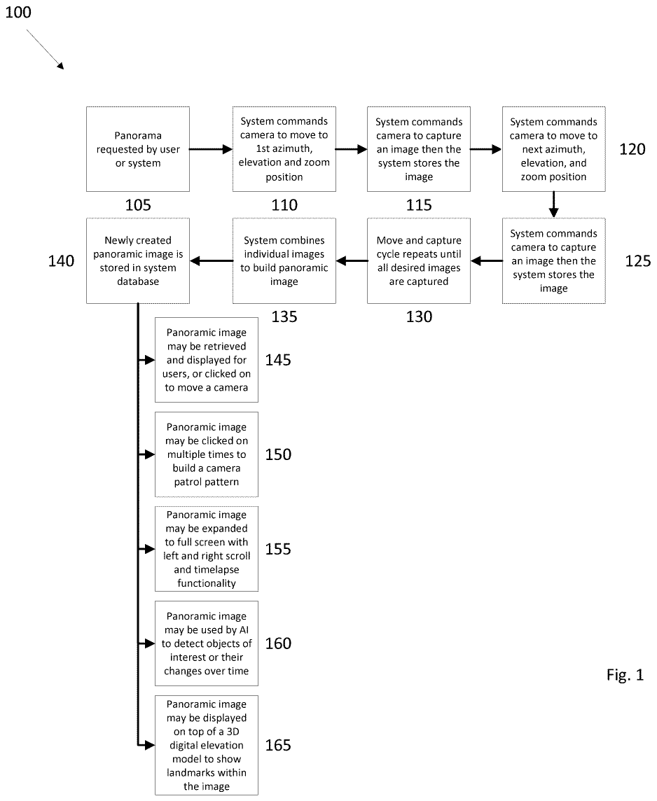

Now referring to FIG. 1, flow chart 100 shows a process for generating a panoramic image and storing it in a database and various ways the panoramic images may be used within the system according to the embodiments of the present invention. At 105, a panorama is requested by a user or the system. At 110, the system commands the camera to the first azimuth, elevation and zoom position. At 115, the system commands an image to be captured and then stores the image. At 120, the system commands the camera to the next azimuth, elevation and zoom position. At 125, the system commands an image to be captured and then stores the image. At 130, the system repeats the camera movements until all images are captured and stored. At 135, the system combines the images to build the panoramic image. At 140, the panoramic image is stored. Steps 145-165 show various actions that can be taken with the panoramic image. At 145, the panoramic image may be displayed and clicked on to move a camera. At 150, the panoramic image may be displayed and clicked on multiple times to build a camera patrol pattern. At 155, the panoramic image may be expanded to full screen with left and right scroll and timelapse functionality. At 160, the panoramic image may be used by AI to detect objects of interest or their changes over time. At 165, the panoramic image may be displayed on top of a 3D digital elevation model to show landmarks within the image.

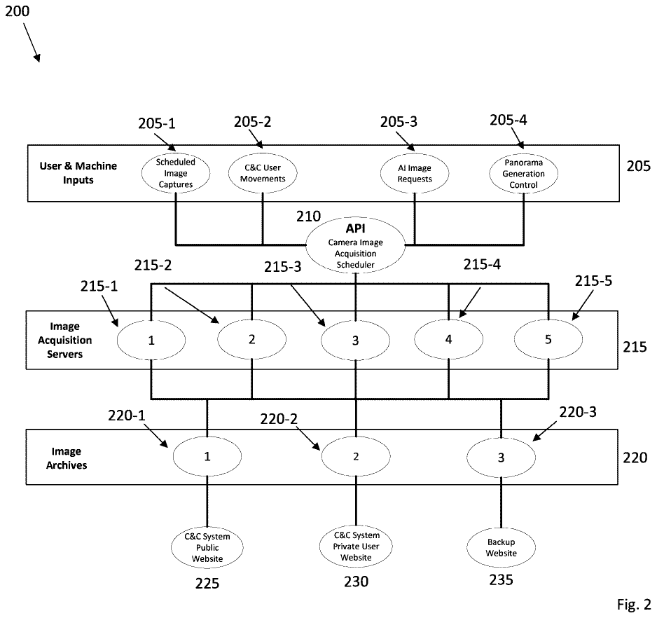

Cameras, the C&C system, and the system network design may be redundantly configured to maintain high levels of availability. For larger scale users or system visual data needs, Content Distribution Networks (CDNs) may be implemented to scale data delivery as necessary. Now referring to FIG. 2, an exemplary C&C system network design 200 is shown according to the embodiments of the present invention. In one embodiment, user and machine inputs 205 comprise scheduled image captures 205-1, C&C user movements 205-2, all image requests 205-3 and panorama generation control 205-4. Those skilled in the art will recognize that other user and machine inputs may be incorporated. The user and machine inputs communicate with a plurality of image acquisition servers 215 comprising servers 215-1 through 215-5 via the camera image capture scheduler 210. The image acquisition servers 215-1 through 215-5 communicate with a plurality of image archives (e.g., databases) 220 comprising archives 220-1 through 220-3. The system archives 220-1 through 220-3 may be accessed via a C&C public website 225, C&C private user website 230 and backup website 235.

### Image Acquisition Scheduler

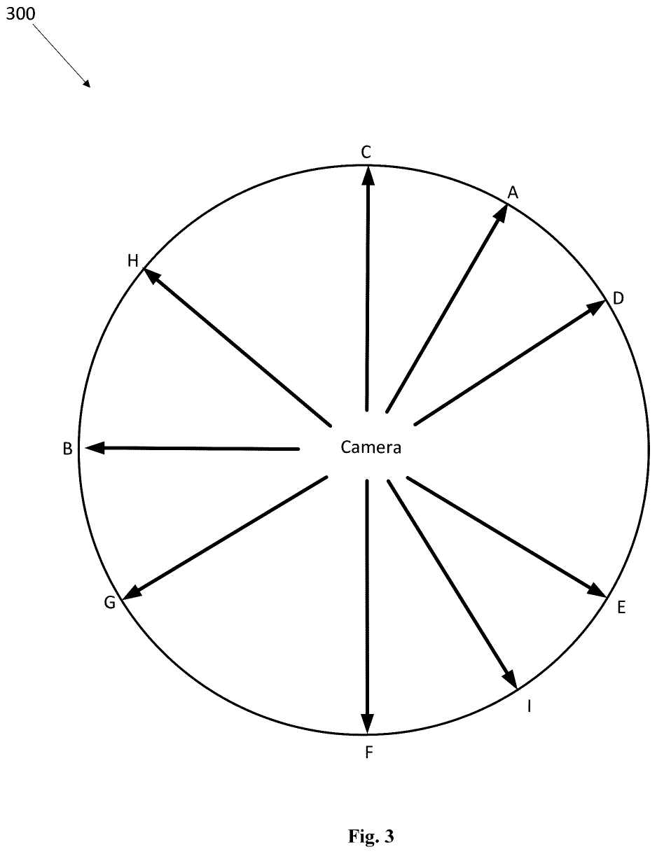

The image acquisitioned through the C&C system to control one or more cameras, each task may be assigned a priority, time, azimuth, elevation and/or zoom setting. The image acquisition scheduler may schedule tasks within a defined time interval, and the image acquisition scheduler may have one or more of the cameras perform additional tasks in between scheduled tasks, as necessary. Now referring to FIG. 3, a camera 300 may be scheduled, via the image acquisition scheduler 210, to perform a series of tasks shown as A through I. The additional tasks may include building panoramic images, AI requesting to scan areas for objects of interest, tracking animal or environmental changes over time or any other desired use. Priority use of the C&C system may be assigned to certain users or system uses or detected objects of interest, such as when AI detects a fire. The C&C system may limit access, override a scheduled task, or not allow a user or 3^{rd} party system to request a task (temporarily or permanently) if the request conflicts with a priority use or user of the camera or a priority object of interest. This control may be initiated through the C&C System, image acquisition Server, or database.

### User Login/Access

The C&C system may control access to the C&C system through authentication methods including, but not limited to, username, email address, phone number, email domain name, IP address, QR code, passcode, and/or username/password authentication. Users may have the ability to reset their password by receiving a password reset code via text, phone call or email. The C&C system may allow various account levels to be created, edited, updated, and/or deleted including, but not limited to, user, company, group, group administrator, and super user level accounts. Account and access level information may be logged and stored in the system including, but not limited to, name, username, phone number, mailing address, job title, company name, default group, group administrator status, individual or global camera control and priority level attributes and historical activity. Historical activity may include user/group/company camera movements, successful and unsuccessful login attempts and other interactions with the system encompassing logging for all aspects of a user's use of the C&C system.

### Cameras/Groups/Group Administration

The C&C system may allow a user to access one or more Cameras, be added or removed from one or more user groups, and/or added or removed from one or more camera groups. Cameras may be added or removed from one or more users, cameras may be added or removed from one or more user groups or some combination thereof. Users may be assigned various permission level attributes for an individual camera, within a camera group, or on a global level. Group administrators may be assigned to one or more groups and may be able to add, modify, or remove users or camera access levels within their group. Group permission level attributes may be categorized in a numerical format such as 1-10 or 1-100 based on what permissions are granted or excluded. Group permission level attributes may include, but are not limited to, active or deactivated user status flags, camera or group or incident or global chat permissions, ability to view cameras, ability to move cameras, ability to request panoramic images, ability to set up camera patrol modes, ability to request live video feeds, ability to lock camera controls to prevent lower priority users or uses from moving cameras, allow root level camera access, ability to setup messages that may display within the C&C system (such as emergency evacuation messages), a subset of C&C system users, 3^{rd} party system users or to the public. These permission attribute levels may be visually displayed in the C&C system allowing group or system administrators to quickly toggle user or group access levels on or off by clicking a button or sending a command to the C&C system. Users, group administrators and/or system administrators may have the ability to visually see what cameras a user and/or group have privileges to access within the C&C system. As an option, a user, group administrator or system administrator may have the ability to click a cameras icon on a map to add or remove said camera from a user, user group or camera group. The C&C system may display a user's: location, access levels, camera control permissions, and priority levels using different icons, shapes, map/icon colors, text indicators or various other types of identifying features on the display interface. The C&C system may display said above items directly on displayed images and/or maps to indicate to users their various access levels. User, company, or Camera group areas may be designated by one or more shape areas or perimeters on a map including, but not limited to, rectangles, circles, and/or polygons. Cameras within said areas may be automatically added to a user, company, or group on a temporary or permanent basis. Cameras may also be automatically added to user or company groups based on company jurisdiction areas which may be shown on maps using various map overlays. This may be useful when new cameras are installed and operational, eliminating the need for system administrators to add each new camera to every camera group and user group affected by the new camera being added to the C&C system. As another option a certain subset of users or all users may automatically be assigned certain permissions by the C&C system based on their detected GPS location. This may be useful if, for example, a firefighter is assigned to a fire outside the firefighter's normal operating area. In this situation the C&C system may automatically assign the firefighter permission to move cameras within a certain number of miles of their GPS location until the firefighter leaves the area and returns to their normal operating area.

### Navigation Bar

The C&C system interface may include multiple components including a navigation bar. Within the navigation bar or elsewhere in the C&C system, users may be able to access certain functionality including, but not limited to, a clickable button to login to the system, contact information, a ticketing system (for user communications, support, feature and bug fix requests), user permission modification, user agreements, user code of conduct, incident management, onboarding of new cameras into the system, camera movement logs, user login attempts and session logs, a user's or group's cameras access list or map, user profile and account information, user management, weather data, bulk data management, a calendar to request or conduct user training, reports for system and network performance including offline cameras, and a page to manage network connection providers or other agencies responsible for installing and maintaining specific cameras. One or more interfaces may display a search bar to allow users to search for: cameras by name, GPS coordinates, address, or geographic location. Additionally, cameras may be searched by their proximity to a specific location such as a road intersection or other specific location. The navigation bar may have a clickable button or logo to return the user to the home page from any page within the system.

### Map Types/Layers/Functionality

The C&C system may utilize one or more maps to provide spatial and situational awareness to users. Maps may be displayed anywhere throughout the system. Maps may have the ability to expand to full screen or scaled back into the page from which it was expanded. Maps may include the ability to toggle on and off various icons, images, map types, and map layers. Icons may be manually sized or automatically resize as users zoom in or out on the map and map icons may change color based on user access levels or camera status. Icon examples include, but are not limited to, cameras, arrows, GPS location tear drops, house shapes to depict home locations, colored Wi-Fi symbols, rectangle/circle/polygons, and “+” and “−” zoom level icons. Examples of map types include, but are not limited to, roads, 2D and 3D street/satellite/terrain/topographic, 3D digital elevation models or some combination thereof. Map layer examples include, but are not limited to, camera targets, camera viewsheds, online and offline cameras, active fire incidents, current and historical fire perimeters, Integrated Reporting of Wildland-Fire Information (IRWIN), fire agency direct protection areas, Office of Emergency Services regions, fire agency region boundaries such as local, State and Federal fire units, County & State Boundaries, National Forest Boundaries, high fire threat areas such as the California Public Utilities High Fire Threat Tier 2 and Tier 3 areas, weather sensor location and data such as data obtained from MesoWest, static or dynamic wind flow visualizations, user and equipment GPS locations including mobile equipment (such as bulldozers, water tenders, fire engines and aircraft), Aircraft ADS-B transponder locations, critical infrastructure, and utility operating areas and infrastructure (including transmission/distribution lines/gas pipelines). Maps may also incorporate the ability to display an icon showing a user's location on a map. The C&C System may zoom the map into a static or dynamically sized area around the user's location. The C&C system may also have a clickable button to “display cameras images near me” within a user or system generated distance from the user or allow a user to click a button to generate an image quilt of nearby cameras or even click a button to watch a timelapse of all cameras near the user simultaneously. Map legends may be displayed permanently or toggled on and off by a user or system.

### User-Configured Data Views and Map Layers

In one embodiment, the C&C system allows users to build custom data views or maps by selecting from pre-loaded layers and importing additional data. Users may upload or import datasets from local files, external applications, or agency-internal systems, including weather data, camera feeds, or situational awareness overlays. These datasets may be incorporated into the user interface as configurable layers, enabling personnel to tailor the map to their operational context. Examples include utility-specific infrastructure, evacuation zones, or vegetation risk buffers. Imported data may support standard formats such as GeoJSON, shapefile, KML, or CSV. The interface may include drag-and-drop functionality to reorder layer visibility or prioritize certain datasets, along with tools for styling, filtering, and toggling display options. Users may also save and share custom map views with other personnel or agencies. These views may be used for operational planning, collaborative response, or after-action review, and may be integrated with camera imagery, AI detections, and weather or risk overlays for unified situational awareness.

### Overlays-Map and Image

The C&C system may incorporate a home page with one or more maps, images and/or text overlays, examples include, but are not limited to, weather data, landmarks, messages, user warnings, incident areas, GPS locations, area selector tools, timers, weather or environmental data or any other desired information may be overlaid on camera images, videos and/or panoramic images created by the system or shown independent of the image elsewhere within a user's display. The overlaid data may be limited to data pertinent to the area displayed on an image or video or an identified geographic location. Dynamic overlays may be used on camera streams and extracted images or panoramic images to display real-time information to enhance the user experience and situational awareness. These dynamic overlays include, but are not limited to, near real-time or real-time weather data, points of interest, maps, satellite imagery, sensor alarms, external alarm databases and other statistics. These dynamic overlays may become integrated into the image or video and be available for replay as static images, videos, or time-lapse playback.

### Home Page—Page Layout/Map/Image Tiles

The display interface may have some form of map for user navigation as well as display a grid of image tiles showing current or historical views from cameras within the current map display boundary area. As a user clicks and drags to move the map or zooms in or out on the map, the displayed image tiles may automatically adjust to show updated camera image tiles based on cameras located within the updated map boundary area. Each time a user moves a map, this process may repeat and display new image tiles. The display interface may allow camera or camera site names to be displayed over or near their respective camera image(s) and toggled on or off via a clickable button. As an option, the display interface may divide image tiles into various areas on the display. For example, one area of the display may show the four most recently moved cameras including displaying the duration of time since each of the four cameras was last moved and by which user or system. Another area of the display may show additional camera image tiles where some or all tiles may be prioritized, sorted, selected, unselected, or displayed in various ways such as in alphabetical order, closest distance to a user's GPS or home location or object of interest, most recently moved, most visited, most viewed, most logged in current or historical users, displayed map area, identified locations or objects of interest determined by a user of AI, AI detection counts, or satellite heat signatures. As another option individually displayed image tiles may be expanded to full screen by clicking a button. Clicking the same button or another button may collapse the image back into the tile display area. A user may also click a button to initiate a historical timelapse playback on an individual or group of camera image tiles. From this display interface, a user may also click on a camera image to take the user directly to that camera's console page to control the camera if the user has appropriate permissions.

### Camera Icons & Icon Movement

Maps within the C&C system may display camera locations and camera orientation directions by displaying one or more camera directional icons on a map for each camera within the field of view. Each camera icon or directional icon may be placed at the specific GPS location on the map where that camera is located. Camera icons and/or directional icons may rotate around the GPS location based on the current or historical compass direction of a camera. When a camera is moved by the C&C system, user, AI, or a 3^{rd} party system or through an API, that camera's direction may update on one, several or all maps in real time or near-real time. Camera icons and/or directional icons may be displayed as different colors or shapes for different users based on a user's assigned access level to view or move the camera(s). For example, if a user's access level allows the user to move a camera, the camera icon or directional icon may display in a green color but if the user is not able to move the camera but only view the camera, the icon may display in some other color such as blue. In situations where a camera may be virtualized, more than one camera icon or directional icon may be displayed for a single camera showing the multiple directions a camera is returning image feeds for.

### Camera Target Lines

The C&C system maps may incorporate camera target lines and the ability to toggle one, some, or all target lines on or off via use of a toggle, button or camera icon. Target lines may extend a user or system defined distance (such as 10 or 20 miles) from one or more camera locations in whatever direction the camera is currently (or historically during timelapse playback) oriented. Target lines are useful to help system users and the public visualize exactly where each camera is pointed. When two or more cameras from different locations are pointed at the same target location (such as a fire), triangulation may be possible. The greater number of cameras pointed at the same target location may result in a higher degree of target location accuracy. The C&C system may allow users to quickly determine exact target location coordinates by clicking on a map where target lines intersect to display a pin and a popup textbox on the map that may include GPS coordinates which the user may be able to copy and/or share with other C&C system users within their company, group, all C&C system users or with the public including additional options for common social media channel buttons. The C&C system may determine the exact target location via the use of AI, ML or other method, and display the target location coordinates for use by users, the public, the C&C system, or other systems. As another option, camera target lines may automatically be displayed on a map based on when each camera was last moved (AI or system movements such as patrol modes may be included or excluded from automatically being displayed), camera target lines may change color based on how recently a camera was last moved. For example, the target line for a camera moved within the previous 15 minutes may be displayed in red, the target line for a camera moved within the previous 30 minutes may be displayed in orange and the target line for a camera moved within the previous hour may be displayed yellow. This method of displaying camera target lines may help reduce map clutter by not displaying irrelevant camera target lines where the cameras have not recently been moved towards an object of interest. As another option, cameras that have not moved for a duration of time longer than the pre-established time defined for display by a defined color may display black camera arrows and target lines or may not be displayed at all causing recently moved cameras to standout on the map. In another embodiment, users may have the option to select and display a map overlay (showing camera arrows, camera target lines and/or other data) and an image thumbnail grid, where both the map and image thumbnail grid only display cameras moved within a certain time period, said time period may be pre-established by the C&C system or user selectable. This option may allow users and/or the public to display only recently moved cameras (greatly reducing clutter compared to displaying all cameras) to help users and/or the public to quickly detect the cameras that have been moved towards an object of interest (such as a fire) and ignore cameras that have not recently moved. Additionally, when C&C system users have moved multiple cameras to view an object of interest, the cameras'corresponding target lines may triangulate at the object of interest's location on the map providing the ability for C&C system users and/or the public to click on the map at the intersection of the target lines to display the object's GPS coordinates and distance from the user's location (if the C&C system is able to detect the user's location). Some form of measuring tool may also be available on the map allowing a user to click on multiple points on the map and determine the distance between them. As another option, once cameras are directed towards an object of interest(such as a fire), the C&C system may automatically detect the object of interest via AI. Once two or more cameras are displaying the object of interest, the C&C system may automatically alert certain users about the location of the object of interest. As another option, users may be able to hover their cursor over camera target lines and the C&C system may display a current camera image. This may be useful to determine which target lines are viewing an object of interest and which target lines are not.

### Camera Viewshed Cones

Camera viewsheds may be represented on a map, maps or an image or images by a cone shape. Camera viewshed cones may be displayed on a map in various colors, transparency levels and toggled on or off as desired for a single, multiple, or all cameras. Camera viewshed coverage may be displayed as a simple viewshed cone projecting from the camera location oriented in the direction and field of view the camera is directed. Camera viewshed cones may rotate around the GPS location of the camera on the map as the camera moves appearing as a flashlight beam, rotating, widening, or narrowing based on the camera's field of view. Viewshed cones may extend a user or system defined distance from the camera location, such as 10 or 20 miles. The C&C system may display one or more types of camera viewshed layers. An example of a viewshed layer may resemble a 2D or 3D flashlight beam (a cone shaped projection that is narrow at the camera location and widens as it extends in distance from the camera's location) projecting from one or more cameras in the direction the camera azimuth is currently oriented, displaying the cameras field of view as the flashlight beam's width and length on the map. When a 3D map is displayed, the flashlight beam may also incorporate the camera's elevation setting in displaying the vertical viewshed area(s) to be displayed on the map. A camera's flashlight beam may display on the map as a filled area comprising some transparency level. This type of layer may include locations that the camera cannot view because it may not consider obstructions such as mountains, valleys, trees, or structures. As another option, a viewshed layer may only display each camera flashlight beam's outline.

### Viewshed and Viewshed Editing

The C&C system may provide the ability to generate, edit and/or show highly detailed camera viewsheds using Light Detection and Ranging (LiDAR) data and viewshed mapping software (integrated into the C&C system or utilizing some other system). Utilizing LiDAR and viewshed mapping software may allow obstructions to be considered that may block a camera's ability to view certain areas. The detailed viewshed coverage may display everywhere a camera can see ground level, see above common obstructions (such as treetops) or show viewshed wherever a camera views some arbitrary height above ground level. The use of a camera view at a height above ground level (for example, 500 feet) may be advantageous in detecting objects of interest such as a smoke column or aircraft. This arbitrary height above ground may be user or system defined and adjustable on a user, user group or system wide basis. Common obstructions include, but are not limited to, mountains, valleys, trees, buildings, or other structure types such as towers, grain silos, water towers and lookouts. LiDAR viewshed mapping may be incredibly useful in determining placement of camera site locations and/or when users or systems (including the C&C system) need to know which cameras can or cannot view a specific location or object of interest. As an option, LiDAR viewsheds may only display viewshed coverage within a camera's current field of view or display viewshed coverage everywhere a camera (or site with more than one camera) can possibly view (up to 360 degrees) regardless of which direction a camera is currently oriented. These highly detailed viewsheds may be toggled on and off per camera, site, geographic area or globally. The C&C system may also incorporate a viewshed editing tool to allow a user, the C&C system or AI to review one or more images or panoramic images from one or more cameras to highlight certain areas within the images or panoramas where the camera may or may not be able to view due to some sort of obstruction. As another option, the C&C system may incorporate LiDAR mapping data in addition to or in lieu of the area selector tool to allow a user, the C&C system or AI to modify a camera viewshed based on a cameras location data such as GPS location, height above ground and structure type. Laser range finders may be incorporated into camera housings or mounted close to cameras and used to detect any obstructions close to the camera's location and mark those obstructed areas within the C&C system and camera viewsheds. These highly detailed viewsheds may be editable through the C&C system by a user or AI to ensure camera viewsheds are as accurate as possible. Viewsheds may be utilized to determine which cameras can see a specific point and may be helpful for situations such as a call to 911 to report a fire where a dispatcher needs to quickly determine which cameras can view the location of interest and/or an area a certain height above ground over the location of interest. As an option, the system may utilize the location input by a user or the system to determine all cameras that can view the location and turn some or all cameras towards the location of interest.

### Hover Over Image/arrow/map Moving Target Line

To improve location awareness in the C&C system, when a user moves a cursor over the display interface, the C&C system may track the cursor movement and cursor location to perform certain actions based on the cursor location. When a cursor is hovered over a camera image tile, that camera's icon or arrow icon may change and highlight a different color on the map area on the display interface. That camera's viewshed and target lines may also be displayed in a user or system defined color while a user is hovering over that camera's image with a cursor. Moving the cursor off the camera image tile, may cause the camera's icon or arrow icon to no longer be highlighted a different color and the viewshed and target lines to disappear. Another C&C system feature is the ability to briefly hover over a camera's icon or arrow icon on the map portion of a display interface with a cursor in order to highlight a border around that corresponding camera's image within a larger image tile set. As another option, when hovering over the camera's icon or arrow icon, the C&C system may automatically expand that camera's icon or arrow icons'corresponding image tile into a larger image on the display interface to improve viewability. In cases where sites have more than one camera at a location, initially hovering over the icons associated with the site may expand camera image(s) for one of the camera's (for example, camera A). To expand the camera image(s) for additional cameras at the site, the user may briefly move their cursor off the icons associated with the site then hover over the site icons again. Each time a user moves their cursor off a set of camera icons and back onto them, the displayed image(s) may change if more than one camera is present at the arrow location. Another useful cursor or input tracking function of the C&C system is the ability to move a cursor horizontally across a camera image or panorama and have the corresponding map display a target line that represents where in the image the cursor is located on the map. As the user moves a cursor across the image to various locations of interest, the target line on the map moves accordingly to show the user what direction those locations of interest are in relation to the camera site. The C&C system may analyze each camera image captured and utilize orientation data from camera software to determine the exact elevation and azimuth coordinates for the center and each corner of a captured image. By doing this, the C&C system may correlate cursor location (when hovering or clicking on an image) to a map heading or a geographic location. This functionality may be utilized in all portions of the C&C system including within images, videos, panoramas, timelapses and various other functions of the system. Additionally, an azimuth bar may display in, above or below an image showing the azimuth headings that correspond to various sections within the image. For example, if an images field of view is 60 degrees starting at an azimuth of 0 degrees and ending at an azimuth of 60 degrees, the azimuth bar may display 5 degree marks (5,10, . . . 55,60) to help users determine what azimuth specific sections of the image correspond to on a map in relation to the camera site.

### Camera Console Page

Within the C&C system users may access one or more camera console pages through a webpage URL or an application on their personal device. Camera console pages allow users to view one or more cameras, move and control one or more cameras or view additional information from one or more cameras or locations. When a user accesses a camera console page, multiple viewing areas may be displayed, including, but not limited to, a camera image or video viewing area, a map area, a camera movement log, a chat window, a weather data window, a C&C system generated panoramic image (up to 360 degrees) and a link to direct a user to a historical image archive where historical images or videos may be viewed, downloaded or shared. Camera console pages may be navigated to within the C&C system a multitude of ways, including, but not limited to, clicking directly on a camera's image tile on any page, searching for a camera name in a search field, clicking a camera icon on a map, or by clicking a camera image in an image quilt or timelapse.

### Map/Camera Movement And Control

When using the C&C system, a user, the C&C system, a web server or a 3^{rd} party system may control one or more camera(s) using a variety of methods including, but not limited to, clicking one or more desired target location(s) on an image, panorama, video or 2D/3D map, clicking a button, clicking and holding a mouse button, double tapping with an input device, finger motions on a device with a touch screen, dragging a cursor across an image, panorama, video or 2D/3D map and then releasing the mouse button to define one or more target location(s); drawing some sort of shape such as a polygon, circle or rectangle on an image, panorama, video or a 2D/3D map to allow one or more target location(s) to be defined; or by inputting GPS coordinates, an address, a point of interest (such as a 911 call location), a satellite heat detection, combination of azimuth/elevation/zoom levels or other location identifying data into a search field. The C&C system may display a camera zoom bar proximate to the camera image to allow users to quickly increase or decrease zoom levels. The C&C system may allow users to click on a location on a 2D or 3D map or image to control camera movement or turn cameras to that location to capture image(s) or video. This system is not limited to controlling a single camera at a time—for example, a user or system may request one or more image(s) or video(s) from every camera within a defined radius of a desired target location. Once the user request is received by the C&C system, the C&C system may then command the cameras to simultaneously reorient themselves to view the specific location. Once reoriented, each camera may return one or more requested image(s) or video(s) to the system or user. As another option, all cameras within the defined area may be set to patrol mode and oriented at the target location, programmed to then return one or more image(s) of the target location(s) based upon user set, or dynamic time interval(s) (such as a new image every 30 seconds) to provide situational updates of the target location. The C&C system may schedule other camera movements and image captures during idle camera time or optimize image capture sequencing by capturing images close to each other or at similar zoom levels before moving to other areas to eliminate wasted camera movement cycles or inefficiencies.

### Tracking User Movements via a Movement Log

The C&C system may incorporate a camera movement log allowing users, based on user access levels, to see other users'camera movements within the system and to document camera movement reasons. The camera movement log may be displayed on the camera console page in a table format and record all camera movements. Data fields within the camera movement log for each camera movement may include, but not be limited to name, username, company name, camera movement message, user phone number, pan/tilt/zoom orientation of the camera, a timestamp of when the movement occurred and the movements priority level. When a user clicks on an image or panorama on a camera console page, a camera movement request popup box may display on the screen. The movement request popup box may allow a user to type in the reason for moving the camera, display their username, phone number, and mark the intended camera movement as high or low priority. After the user clicks a confirm button in the camera movement popup box, a data entry may be recorded in the camera movement log, and the C&C system may send a command to the camera to move to the user's desired location they clicked on or highlighted the area of on the image. Once a user confirms the intended initial camera movement, the C&C system may display a popup alerting the user they have enabled live viewing mode and display a countdown timer. During the countdown, the user may continue to move the camera as many additional times as needed within the set time interval (such as 60 seconds) before another camera movement request popup may be required to move the camera again. During the live viewing mode, even though a user is not required to comment on every camera movement, all the users'movements may be recorded. Live viewing mode allows users to optimize the view of their object of interest by making additional camera orientation adjustments without requiring a confirmation for each adjustment. If the user in live viewing mode attempts to move the camera in a radically different direction than the initial movement, for example over 90 degrees to the right or left, that action may disable the set time interval and immediately display a new camera request popup to document the reason for the new camera movement. Additionally, users may be able to click a button, icon, or ‘x’ to end live viewing mode prior to the set time interval expiring if they no longer desire to control camera movement. During live viewing mode, the C&C system may increase the frame refresh rate for the user so the user may see immediate camera movements or enable live video playback for a temporary period of time for that user. The camera movement log may display all historical camera movement position settings and users may be able to return a camera to a previously viewed location by clicking on a historical position setting within the displayed movement log. Camera movements may be labeled and/or uniquely identified within the movement log. This may be very useful to quickly move between multiple objects of interest (such as spot fires). Users may also request images and/or generate a patrol mode request or an image feed quilt based on the different prior movement locations.

### Weather Data Incorporated Into The System

The C&C system and camera console page may collect, store and display weather data from a variety of weather stations in various locations within the C&C system. Weather data may be inserted directly into image frames from the camera software or inserted during post processing by the C&C system or image acquisition Servers. By inserting weather data into image frames before storing the images, historical image playbacks may display weather data without needing to correlate image and weather data capture timestamps. As another option, the system may display weather data in addition to or separately from camera images including during timelapses or historical playback. As another option, users may be able to click a button or icon to view available weather data at the camera location. As another option, weather data may be displayed from the nearest weather station to a camera location and may alert the user that the weather data provided is not at the camera's location. For displayed weather data that is not at a camera's location, the C&C system may show the user how far away, in what direction and the elevation difference between the camera and weather station locations. Weather stations may provide the C&C system with various types of data including but not limited to temperature, humidity, wind speed, wind direction, wind acceleration, and precipitation. Each data type may include measurements for current, average, minimum, maximum values over certain time periods and may include historical graphs and timelapse playbacks. As another option, the C&C system may incorporate weather data from private or public weather stations as well as 3^{rd} party weather data systems such as MesoWest. The C&C system may allow a user to toggle on and off a layer showing one, some, or all available weather stations on a map. As an option, a user may select the type of weather data displayed and/or the source of the weather data. As another option a user may be able to draw a rectangle, polygon or circle on a map to display all available weather stations within the user defined area. As another option, a user may be able to display a timelapse of the weather data for the selected area.

### Sub Systems

C&C systems may comprise one or more standalone systems to service specific geographic areas such as a state or country. As another option, two or more different C&C systems may work in conjunction with each other and share cameras, camera imagery and data feeding into each other or into a master C&C system. For example, each state within a country may utilize a different C&C system. Once a user accesses the C&C system for a state, the user may, based on their permissions, be allowed to view and/or access C&C system cameras from other states on the same map to improve functionality across various jurisdictions such as state lines.

### Portable Camera Platform With Integrated Sensors

In one embodiment of the present invention, the C&C system supports the deployment of small, solar-powered AI camera units designed for wildfire detection and situational awareness. These units may be permanently affixed or installed as portable systems on infrastructure such as utility transmission or distribution poles, city-owned streetlights, local fire agency towers, or mounted on mobile trailers. Mini and portable camera units enable rapid expansion of system coverage, particularly in high-risk or remote wildfire zones. These deployments offer a cost-effective method to densify AI-based detection and provide targeted visibility across critical terrain. Each unit contains an onboard control board that manages solar charging, lithium battery storage, and low-voltage cutoff protection. The control board also supports multiple connectivity pathways, including 4G/5G cellular modems, GPS receivers for geolocation and time synchronization, and optional Starlink terminals for redundant satellite backhaul in areas with limited terrestrial network access. In addition to powering and networking the camera system, the control board functions as a modular communications hub, allowing seamless integration of auxiliary sensor packages. Optional inputs may include compact meteorological stations, fuel and soil moisture sensors, lightning detectors, and software-defined radios (SDRs). These sensors may be hardwired or wirelessly paired to the camera unit and managed via the same or different processing board(s). The system is designed to support plug-and-play operation, enabling rapid field deployment with minimal configuration. Upon activation, the unit automatically establishes a secure websocket connection to the C&C platform, allowing persistent bidirectional communication for command, control, and data transfer. The camera may also transmit its GPS coordinates to the C&C platform on an ongoing basis, allowing portable cameras to dynamically update their location on maps, user displays, and other system interfaces. Once installed, the control board aggregates data from all attached subsystems and transmits it to the C&C platform, where it is visualized, analyzed, and incorporated into AI detection workflows, fire spread modeling, or situational awareness dashboards. This communications hub architecture ensures that each unit functions not only as a detection point, but as a multi-sensor gateway adaptable to evolving operational needs.

### Weather Station Integration

In one embodiment, the system supports the integration of compact weather stations that may be affixed to camera units or deployed as stand-alone sensors. These stations may collect real-time local atmospheric data including temperature, humidity, wind speed and direction, barometric pressure, rainfall, and optionally fuel and soil moisture. Sensor data may be transmitted to the C&C system over cellular, satellite, or long-range wireless links. In one embodiment, weather stations may be deployed using systems and methods described in U.S. Pat. Nos. 11,006,297 and 11,533,726 which are owned by Applicant and incorporated herein by reference. These patents describe the use of a wireless gateway node that relays sensor data over long distances using 900 MHz frequency hopping or other low-power, long-range protocols. This architecture enables wide-area sensor coverage in remote, off-grid environments where traditional communications infrastructure is limited or unavailable.

### SDR Integration for Operational Monitoring

In one embodiment, the system includes software-defined radios (SDRs) that may be embedded within mini or portable camera units, or deployed as standalone modules at strategic locations. Each SDR unit is connected to the system's control board and may be powered via the same solar-battery infrastructure as the camera and sensor systems. The SDR operates by digitizing analog radio signals across a wide frequency spectrum, allowing the system to flexibly monitor and decode multiple channels using software rather than hardware-specific components. This flexibility enables real-time reception of public safety radio traffic, including VHF/UHF fire dispatch channels, tactical communication channels used during incident response, and local mutual aid nets. SDRs may also be used to monitor lightning detection frequencies, ADS-B aircraft beacon signals for fire-related air traffic tracking, and other situationally relevant channels. Each SDR includes a digital tuner, analog-to-digital converter (ADC), and field-programmable gate array (FPGA) or dedicated software signal processing stack. These components enable dynamic frequency hopping, simultaneous multi-channel monitoring, and digital demodulation of AM, FM, narrowband FM, or digital modulation schemes such as P25 or DMR. The system may support SDR front-ends with wideband coverage (e.g., 25 MHz-1.7 GHz), allowing for flexible deployment across rural, suburban, and urban environments. High-gain or directional antennas may be selected based on local terrain or incident monitoring requirements. Noise filtering, squelch control, and gain adjustments may be managed remotely through the system's configuration interface.

### Radio-Based Location Triangulation Using Signal Strength and Angle of Arrival

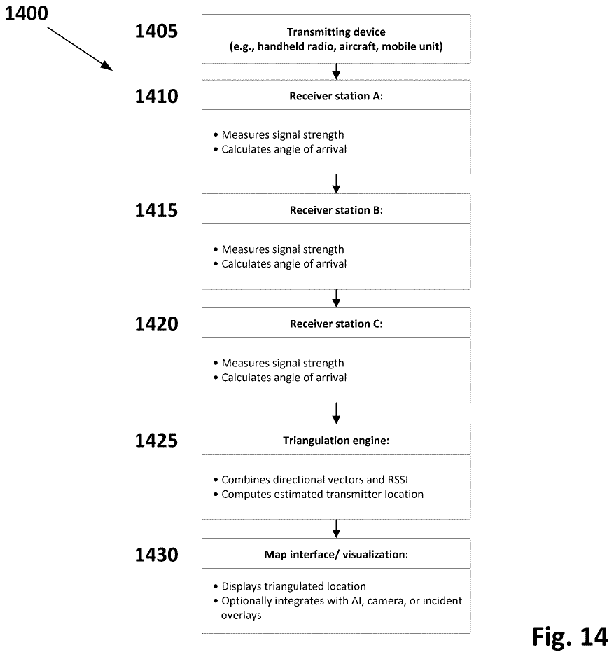

In one embodiment, the system uses multiple software-defined radios positioned at different locations, each equipped with directional antennas or signal processing capabilities to estimate the origin of a radio transmission. Referring now to FIG. 14, a transmitting device such as a handheld radio, aircraft, or mobile unit 1405 emits a signal that is received at a plurality of receiver stations 1410, 1415, 1420. Each receiver station measures the signal strength and calculates the angle of arrival of the received signal. These measurements are fed into a triangulation engine 1425, which combines the directional vectors and received signal strength indicator (RSSI) data to compute the estimated location of the transmitter. The resulting triangulated position is then presented on a map interface or visualization system 1430, which may integrate with AI modules, camera systems, or incident overlays to enhance situational awareness. This allows responders to locate radio-emitting devices even in GPS-denied environments, improving emergency response coordination and field personnel tracking.

### Lightning And Powerline Fault Detection Using Distributed Software-Defined Radios

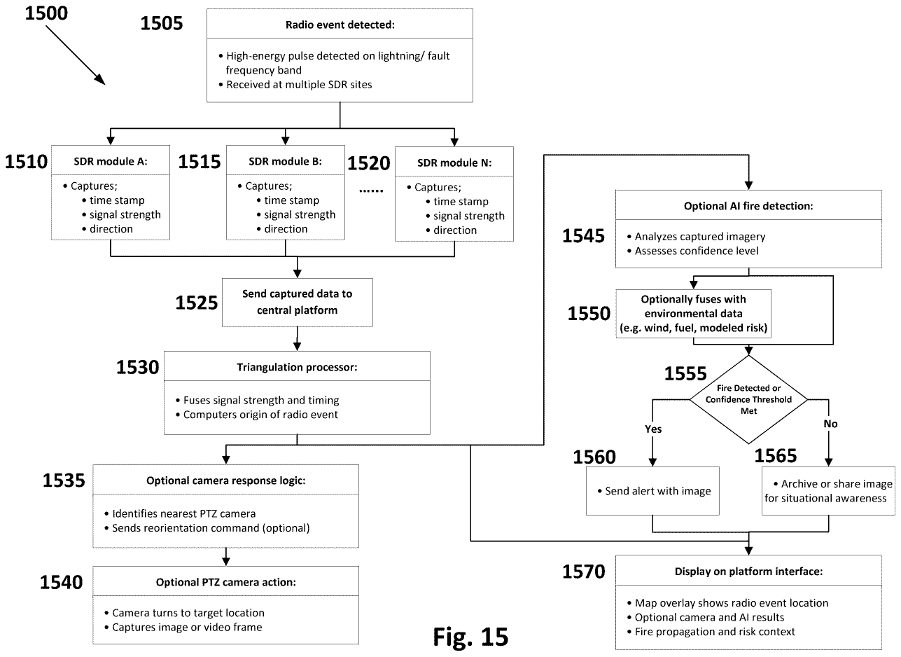

In one embodiment, the system integrates multiple software-defined radio (SDR) modules across the network to monitor frequency bands associated with lightning activity, arcing, and other high-energy radio events. Referring now to FIG. 15, when a high-energy pulse is detected on a monitored frequency band 1505, the signal is received at multiple SDR modules 1510, 1515, 1520, each of which records the timestamp, signal strength, and directionality of the signal and sends the data to a central platform 1525. A triangulation processor 1530 fuses the time-synchronized signal data to compute the estimated origin of the event. This triangulated location may correspond to lightning strikes or powerline faults such as arcing or flashovers. Following triangulation, the system may optionally initiate a camera response workflow 1535, identifying the nearest PTZ camera and issuing a reorientation command to view the strike or fault location 1540. The resulting image is then analyzed using a fire detection AI 1545, which may also incorporate environmental risk data such as wind, fuel state, or modeled fire behavior 1550. If fire is detected or if the AI confidence level exceeds a predefined threshold 1555, an alert with the associated image may be sent to users 1560. If no fire is detected, the image may still be archived or shared for situational awareness 1565. In either case, the detection event, including the triangulated location, camera view, AI results, and any relevant overlays such as fire propagation outputs, is presented on the platform's display interface 1570. This configuration enables detection and verification of ignition sources and supports rapid triage and response decisions by responders.

### SDR Configuration, Audio Streaming, and Incident Linkage

In one embodiment, the C&C system includes a software interface for managing SDR behavior. This interface allows authorized users to assign specific SDR units to ongoing incidents, dynamically tune frequencies based on operational zones, or configure scan groups to cycle through a list of priority channels. Frequencies may be selected manually, searched by keyword (e.g., “CalFire Tac 5”), or pulled from predefined regional frequency maps that are auto-populated based on the SDR's GPS coordinates. Channel presets may also include usage metadata, such as the agency name, purpose (dispatch, air-to-ground, law enforcement), and modulation type. Once configured, the SDR audio stream is digitized, timestamped, and transmitted securely to the cloud for real-time access or archival playback. The audio may be linked to incident timelines, fire propagation simulations, or camera views to enable synchronized multi-modal review. API endpoints may allow third-party platforms such as dispatch consoles or incident logging tools to ingest live or recorded SDR streams. Role-based access control may restrict who can listen, configure, or associate SDR units with incidents. The system may also support audio tagging, where users can annotate or flag key transmissions for review, training, or compliance. Advanced features may include keyword detection (e.g., “evacuation,” “spot fire,” etc.), automated alert escalation based on speech-to-text analysis, and dynamic audio prioritization during multi-incident events.

### SDR System Interface and Audio Integration

In one embodiment, SDR audio streams are ingested by the system and transmitted to cloud infrastructure for real-time access or historical retention. Audio data may be indexed and time-aligned with associated camera imagery, detection alerts, and fire propagation model outputs to enable multimodal correlation. System architecture may expose these streams through secure APIs for integration with third-party platforms or internal dashboards. Authorized users may remotely assign SDR channels to specific incidents, adjust tuning parameters, or configure monitoring profiles for defined geographic or operational zones. Captured audio may be injected into incident replay modules or analytical interfaces supporting temporal navigation, transcription, and event tagging.

### AI Model for Optimal SDR Channel Assignment

In one embodiment, the system includes an AI-based orchestration model that evaluates a distributed network of software-defined radios (SDRs) across a defined area to assign and manage radio frequency monitoring based on signal quality, operational priority, and system resource constraints. When a target radio frequency or dispatch channel is selected, the AI model assesses each SDR's reception performance using metrics such as received signal strength indicator (RSSI), signal-to-noise ratio (SNR), and historical signal reliability. The model selects the optimal SDR and reconfigures it in real time to monitor that channel, ensuring the clearest possible audio stream is delivered to downstream systems. This assignment is continuously re-evaluated as new SDRs are deployed, or reception conditions change. To support system reliability, the model also incorporates automated audio quality diagnostics. Each active stream is evaluated for packet loss, static, clipping, background interference, and other quality indicators. SDRs producing degraded audio may be deprioritized or flagged for maintenance. In high-volume situations where multiple channels are being monitored concurrently, the model dynamically adjusts stream resolution or recording depth based on operational value, such as current incident relevance, channel usage rate, or proximity to known events.

### Multi-Channel Radio Monitoring Dashboard

In one embodiment, the system includes a web-based dashboard that enables users to stream and monitor multiple radio feeds simultaneously. Each SDR unit may transmit its live audio stream to the cloud, where it is accessible via secure, role-based user sessions. The dashboard presents each stream in a configurable panel that may display the radio frequency, channel label, waveform visualization, volume control, and real-time transcription when AI decoding is available. Users may select which SDRs to monitor, filter streams by geographic region or incident, and assign descriptive labels for easier situational tracking. The interface may include features such as keyword-triggered audio alerts, playback buffering, and tagging of transmissions for later review. Streams may be prioritized based on current incident assignments or detected activity levels.

### Multi-Channel Radio Interface With Parallel Streaming and Translation

In one embodiment, the system enables users to monitor multiple radio frequencies simultaneously through a centralized web-based interface. Unlike conventional scanner platforms that limit users to a single stream per session, the system supports real-time playback of multiple SDR feeds within the same browser session or application panel. Each active feed is displayed as a discrete module with independent controls for volume, mute, and priority tagging. Streams may be filtered by location, incident relevance, or channel assignment. Each stream may include a waveform display, activity indicator, channel label, and real-time transcription when AI decoding is active. The interface may allow drag-and-drop reordering, bookmarking of high-traffic channels, and audible or visual alerts triggered by detected keywords, incident correlation, or sudden signal activity. Users may drag and drop individual streams to preferred locations on the page layout to create a custom monitoring dashboard that reflects operational priorities or geographic zones.

### AI Model for Radio Traffic Transcription and Interpretation

In another embodiment, the system incorporates an AI model designed to decode and transcribe live radio traffic captured by SDR units. The model receives digitized audio streams and applies automatic speech recognition (ASR) tuned for noisy, multi-speaker, and domain-specific environments such as fireground radio communications. The transcription engine may be trained on annotated datasets of public safety radio logs and includes specialized vocabularies for wildfire operations, unit call signs, tactical instructions, and acronyms. Once transcribed, the system tags and timestamps each transmission and can associate it with ongoing incidents, camera detections, or geographic areas. Natural language processing (NLP) modules may further classify transmissions by topic, such as evacuation orders, structure threats, or resource requests, and flag relevant keywords for alerting or downstream automation. Transcribed content may be displayed in real time within incident dashboards, logged for after-action review, or made accessible via API for integration into command platforms, recordkeeping systems, or analytics pipelines. Transcribed radio traffic may also be used to influence fire propagation and consequence modeling. For example, if radio communications indicate that structure protection resources have been deployed to a specific area, or that aircraft are actively working a fire line, the system may reduce projected fire spread into that zone to reflect active suppression. Similarly, if a fire location is verbally confirmed on the radio and differs from earlier detection coordinates, the system may adjust the modeled ignition point to reflect the field-confirmed location. Transcribed reports of evacuation orders, observed flame lengths, or shifting wind conditions may also trigger updates to consequence estimates, such as projected population impact or asset exposure. This integration allows radio-derived intelligence to dynamically inform simulation parameters and improve model realism in the absence of visual confirmation.

### System Performance Benchmarking Via Radio Traffic Alignment

In one embodiment, the system includes a benchmarking module designed to measure the performance and effectiveness of its AI-based fire detection capabilities by comparing detection times to external benchmarks such as Integrated Reporting of Wildland Fire Information (IRWIN) incident records and emergency tone-out timestamps derived from radio traffic. The module leverages transcribed SDR audio streams and automatically extracts key timing signals, such as dispatch tone-outs, initial attack orders, or field-reported confirmations. These timestamps are matched against the system's internal AI detection logs to calculate detection lead time, alert latency, and alignment with verified incident reports. The results may be compiled into structured performance metrics that quantify how early the system detects fires relative to human or external sources. Benchmarking results may be displayed in dashboards, exported for reporting, or used to guide system tuning. In some embodiments, system performance can be filtered by geography, detection confidence, incident type, or time of day to support operational analysis. This capability enables transparent evaluation of detection speed and supports third-party validation of system effectiveness across operational contexts.

### AI Model For Radio Traffic Anomaly Detection

In one embodiment, the system includes an AI-based model that analyzes incoming SDR audio streams in real time to detect anomalous patterns or operationally significant shifts in communication volume or content. The model continuously monitors each stream for indicators such as sudden increases in message frequency, use of known emergency terms (e.g., “evacuate,” “structure threat,” “air attack,” etc.), or deviations from baseline traffic patterns. Natural language processing (NLP) components may be used to extract keywords, classify urgency, and infer context. If the model detects conditions indicative of an unfolding emergency or field activity not yet tied to a camera detection or incident report, it may trigger internal notifications, elevate the stream's processing priority, or prompt an operator to investigate. This enhances early situation awareness and enables the system to surface relevant intelligence even before visual confirmation is available.

### Sensor Data Collection and Utilization

In one embodiment, all environmental sensor data is continuously transmitted to a centralized C&C database, where it is stored, visualized, and analyzed in real time. This data may be displayed alongside AI detections, camera imagery, and risk overlays to support operational decision-making. Meteorological inputs are directly integrated into AI fire models, influencing fire propagation simulations, alert thresholds, and consequence forecasting. System operators may monitor incoming sensor feeds to track environmental trends, validate AI performance, detect outliers, or initiate diagnostics in response to system anomalies. Stand-alone weather stations may also be deployed in locations that do not require cameras but still benefit from atmospheric monitoring and risk model refinement.

### Weather Data Layers in C&C System

In another embodiment of the present invention, the C&C system incorporates weather layers—including wind speed (with gusts) and direction, temperature, and relative humidity—that enhance overall situational awareness and strengthen wildfire response capabilities. The weather layers provide real-time environmental metrics that improve the system's ability to model wildfire spread, allowing responders to anticipate fire behavior and adjust deployment strategies in real time. Wind speed and direction data offer predictive insights into fire movement, while temperature tracking highlights periods and locations with elevated ignition risk. Relative humidity monitoring further refines risk assessments by identifying critically dry conditions that amplify fire potential.

### Location-Specific Weather Estimation Via Model Inference in Sensor-Limited Zones

In one embodiment, the system includes a weather estimation module configured to generate site-specific meteorological forecasts for Locations of Interest lacking proximal weather instrumentation. This module applies machine learning models trained on a multivariate dataset that includes terrain elevation models, aspect, slope, land cover classifications, vegetation indices, and historical weather archives indexed to nearby sensor data. The model performs spatial interpolation using terrain-corrected vectors, combined with temporal regression on known environmental transitions, to produce forecast metrics including wind speed and direction, temperature, relative humidity, and vapor pressure deficit at high spatial and temporal resolution. Outputs from this module feed directly into downstream fire consequence modeling and ROS estimation layers, improving prediction accuracy in sensor-sparse regions.

### Machine Learning-Based Weather Sensor Validation and Imputation

In one embodiment, the system incorporates a data integrity subsystem that uses machine learning to identify and correct anomalous readings from distributed weather stations. The system establishes baseline spatiotemporal correlations between co-located sensors and reference weather surfaces, then applies anomaly detection models (e.g., time series deviation thresholds, inter-sensor divergence) to flag statistically inconsistent values. Detected anomalies may be replaced using imputation models trained on historical and contextual datasets. Corrected weather metrics are configured as a separate data layer and may be tagged with provenance metadata indicating original value, source station ID, anomaly type, and correction confidence. These validated data streams are used as primary inputs for AI-based fire modeling workflows including ROS layer generation, ignition likelihood estimation, and alert triggers.

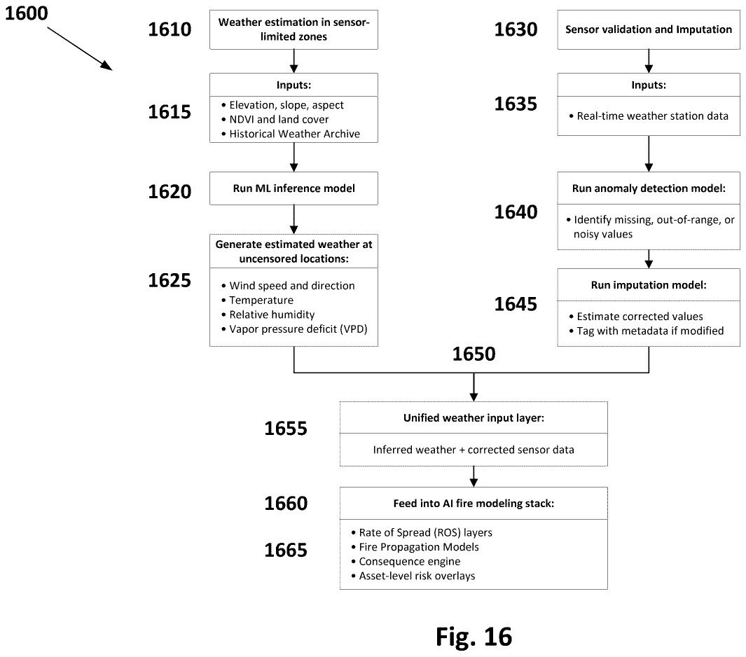

Referring now to FIG. 16, a block diagram is shown illustrating an example dual-path weather data processing pipeline used for fire modeling. The process begins at block 1605 with system initialization or input readiness. At block 1610, a first path (Branch A) initiates weather estimation for sensor-limited zones. Inputs to this process, shown at block 1615, may include terrain elevation, slope, aspect, NDVI, land cover classifications, and historical weather archives. These inputs are processed by a machine learning inference model at block 1620. The output of this model, shown at block 1625, is a set of localized weather estimations such as wind speed and direction, temperature, relative humidity, and vapor pressure deficit (VPD). Concurrently, block 1630 represents a second path (Branch B) for validation and correction of real-time weather station data. Raw weather inputs are received at block 1635 and passed to an anomaly detection model at block 1640, which identifies values that are missing, inconsistent, or statistically abnormal. An imputation model at block 1645 corrects these anomalies based on trained historical and contextual data. At block 1650, the outputs of both branches are merged into a unified data stream. Block 1655 represents the unified weather input layer composed of inferred values and corrected sensor data. This enriched data layer is then passed to the fire modeling stack at block 1660, which includes subcomponents for rate of spread (ROS) estimation, fire propagation models, consequence analysis, and asset-level risk overlays, collectively represented at block 1665.

In another embodiment of the present invention, the C&C system integrates essential risk layers—including Rate of Spread (ROS), Fire Potential Index (FPI), fuel types and density, canopy cover, and satellite imagery—to provide a precise, real-time assessment of wildfire risk and behavior. The ROS layer estimates potential fire spread speed and direction, while the FPI evaluates ignition likelihood based on fuel and weather conditions. Fuel types and density layers identify vegetation characteristics that affect burn rates, and canopy cover provides insights into fire intensity and spread potential in forested areas. Satellite imagery further enhances the system with up-to-date visuals and thermal data, enabling accurate monitoring and rapid response to emerging fire threats.

### Historical Weather Scenario Planning Tool

In another embodiment of the present invention, the C&C system integrates a historical weather risk tool and a weather scenario planning tool to assist utilities, fire agencies, and public safety organizations in making informed, data-driven decisions for wildfire risk mitigation. The historical weather risk tool identifies areas of concern by analyzing patterns of historical weather data—such as wind speed and direction, humidity, temperature, and fuel moisture levels—that have contributed to elevated wildfire risks in the past. The weather scenario planning tool allows users to simulate various environmental conditions, including wind speed and direction, humidity, and temperature, while incorporating terrain and fuel classifications to assess potential fire behavior under specific scenarios.

Using the tools in combination, utilities can pinpoint high-risk areas based on both historical weather patterns and potential future scenarios, enabling targeted infrastructure upgrades, such as undergrounding power lines or enhancing vegetation management in vulnerable zones. Fire agencies can leverage this information to optimize resource prepositioning, strategically positioning firefighting personnel and equipment in areas that are historically prone to dangerous weather conditions or are likely to be impacted by forecasted conditions. Additionally, the tools support emergency managers in developing proactive public awareness and alerting protocols, providing communities with timely notifications based on both historical and scenario-driven risk assessments.

While the satellite-based ROS and the image-based ROS models offer valuable predictive power individually, their combined use brings a new level of accuracy and reliability. By leveraging two independent models that rely on distinct datasets and methodologies, the C&C system achieves robust validation through convergence. When both models, analyzing different inputs such as satellite-derived environmental data and camera-based smoke analysis, reach the same conclusions regarding fire spread, the likelihood of accuracy is significantly strengthened.

To ensure reliable convergence, the C&C system is trained using a comprehensive framework that incorporates supervised and semi-supervised learning. By analyzing historical wildfire incidents with both satellite data and camera feeds, the system learns patterns of alignment between the models, identifying conditions that reliably predict similar spread rates.

The system leverages labeled event data, allowing the AI to fine-tune weighting for variables such as fuel moisture, wind speed, fire perimeters, and smoke dynamics, enhancing sensitivity to factors that indicate convergence. Through iterative training and real-world feedback, convergence parameters are continuously optimized, improving the models'accuracy in accurately modeling wildfire events.

In one embodiment of the present invention, like the ROS models, a Fire Potential Index (FPI) model provides critical, data-driven insights that support both operational and planning decisions. The FPI model processes key inputs—such as fuel moisture, vegetation type and density, wind speed and direction, temperature, relative humidity, and drought levels—to generate a fire risk score indicating ignition likelihood and potential intensity across specific areas.

For operational use, the FPI score enables utilities, fire agencies, and emergency managers to make informed decisions on actions like PSPS, resource allocation, and emergency response prioritization, much like ROS models do with spread prediction. In a planning context, the FPI model helps identify high-risk zones where preventive work should be prioritized—such as vegetation management, equipment upgrades, and infrastructure hardening—by focusing on areas with consistently elevated scores.

### Panoramic Images

The C&C system may display panoramic images or videos in multiple locations within the C&C system including on the camera console page, within quilts, timelapses, or any other desired location within the system. Panoramic images providing up to 360-degree views may be created by combining two or more images and/or videos captured from one or more cameras. The images may be processed, aligned, and combined to each other in such a manner that a combined image or video with a wider field of view (up to 360-degrees) is generated, displayed, stored, and/or made available to a user or system. Users and/or the C&C system may have the ability to determine the desired detail level for panoramic images by selecting image quality and scan ranges for camera azimuth, elevation and zoom level. The C&C system may automatically increase or decrease the quantity of images captured based on the requested panorama detail level. As an option, panoramas may initially display within the C&C system based on a user's browser or window size. A user may be able to expand the panorama to a larger image size with more detailed imagery and navigate left, right, up and down to view the desired locations within the panorama in more detail by clicking a button, icon or selecting an image. Additionally, once a panorama is expanded, a user may still click anywhere on the expanded panorama or image to move the camera to that location. The C&C system may generate panoramas by scheduling one or more camera(s) to complete a user, system, machine, or AI defined sequence of movements. The C&C system may then collect all the images or videos captured from the movement sequence and may align and combine them.

### Zoomed-In Panoramic Acquisition with AI Detection

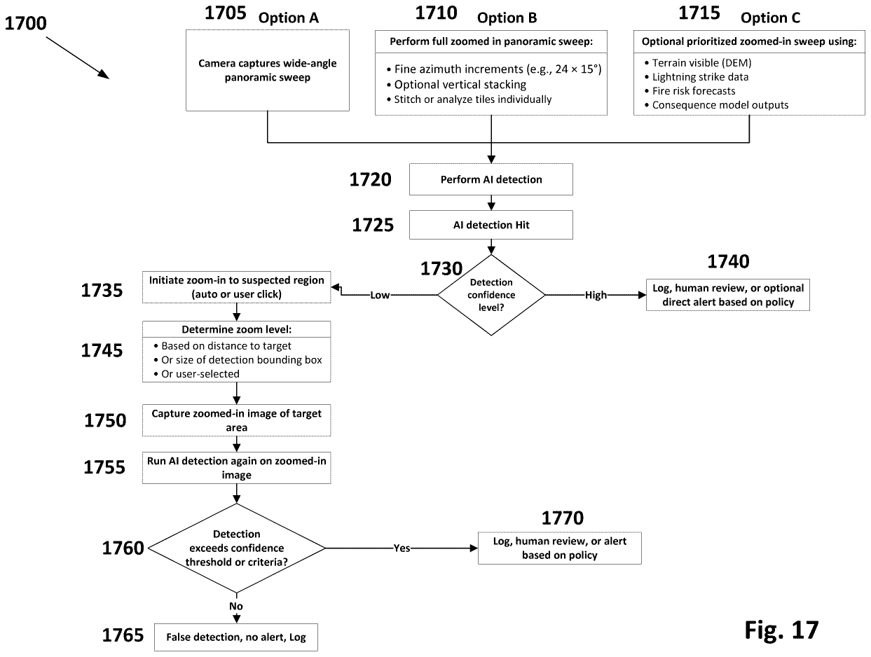

In one embodiment, the system enhances AI-based visual detection by capturing higher-resolution panoramic imagery using zoomed-in acquisition techniques. Rather than relying solely on wide-angle frames, the system can generate panoramas composed of multiple narrower field-of-view images captured at increased optical zoom. Referring now to FIG. 17, the system may perform a wide-angle panoramic sweep 1705, a full zoomed-in panoramic sweep using fine azimuth increments with optional vertical stacking 1710, or a prioritized zoomed-in sweep that focuses attention based on terrain visibility, lightning strike data, fire risk forecasts, or consequence model outputs 1715. After image acquisition, AI detection is performed on each captured segment 1720, and if an anomaly is detected 1725, the system evaluates its confidence level 1730. High-confidence detections may result in an immediate alert, human review, or log entry based on system policy 1740. For low-confidence detections, the system may initiate a zoom-in on the suspected region either automatically or via user click 1735, determine the appropriate zoom level based on bounding box size, target distance, or user selection 1745, and capture a zoomed-in image of the target area 1750. A second round of AI detection is then run on the zoomed-in image 1755, and if the result exceeds a defined confidence threshold or meets other criteria 1760, the system logs, alerts, or flags the result per policy 1770; otherwise, the detection is classified as a false detection and logged without alert 1765. This approach enables earlier and more confident detection of small or distant indicators, reduces false positives, and prioritizes imaging resources toward areas with elevated risk.

### Dynamic Vertical Stacking For Complete Panoramic Coverage

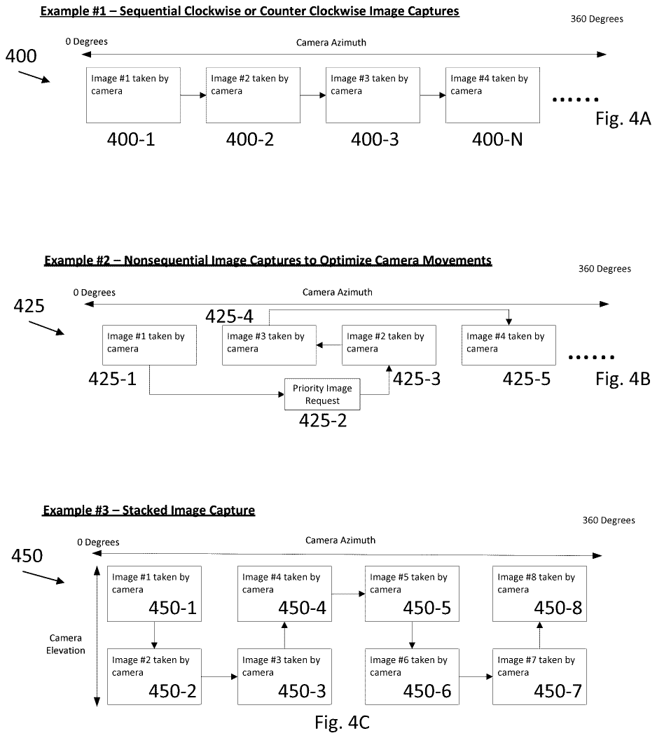

When operating in a zoomed-in panoramic mode, the system may reduce the camera's vertical field of view, resulting in only a portion of the landscape being captured in each frame. For example, a zoom configuration using a 12-degree horizontal field of view may limit vertical coverage to less than the full terrain profile visible from the camera's position, especially when monitoring ridgelines, valleys, or distant hills. To address this, the system may capture multiple vertically stacked image layers at each azimuth position, as illustrated in FIG. 4C. The number of vertical layers may vary dynamically based on the zoom setting and an analysis of terrain visibility derived from a digital elevation model (DEM). In directions where the visible landscape spans a significant vertical range, the system may engage two or more stacked images to ensure full coverage. In contrast, for flatter terrain or limited visibility zones, a single vertical frame may suffice. This adaptive stacking behavior ensures that high-resolution panoramic imagery captures the complete vertical and horizontal extent of the observable environment, preserving detail for later detection or analysis.

AI-Based Image Analysis and Temporal Change Detection

Once the high-resolution panoramic image or segmented tile set has been acquired, the system may apply AI-based detection models to identify early wildfire indicators. AI inference may be performed either on the full stitched panorama or on individual image segments, depending on system configuration and processing constraints. To improve input quality, the system may first apply image enhancement techniques such as super-resolution, semantic up sampling, AI-guided deblurring, denoising, contrast normalization, or low-light correction. These enhancements may be applied in real time or as part of a preprocessing pipeline. The system may also analyze sequences of consecutive images from the same field of view to detect visual changes over time. Temporal change detection methods may include motion vector analysis, background subtraction, temporal feature tracking, or frame differencing. These spatial and temporal AI techniques may be used individually or in combination to detect fine-grained wildfire indicators such as plume emergence, heat shimmer, ignition flicker, or progressive smoke buildup. This layered inference strategy improves detection sensitivity, reduces false negatives, and enhances situational awareness in high-risk and long-range observation scenarios.

Now referring to FIGS. 4A through 4C, various camera movement sequences are shown. FIG. 4A shows sequential clockwise or counter-clockwise image captures 400. In this embodiment, a camera sequentially captures images 400-1 through 400-N at pre-established sequential camera azimuths. FIG. 4B shows a non-sequential image capture 425 wherein a priority request 425-2 causes the images to be taken out of sequence. At 425-1 image 1 is captured and then at 425-3 image 2 (in image position 3) is captured after which image 3 (in image position 2) is captured 425-4 followed by image 4 being captured 425-5. FIG. 4C shows a stacked image capture arrangement 450 where multiple images are taken at same camera azimuths but different elevations. As shown, two images are captured at the same first camera azimuth but at different elevations 450-1, 450-2, a second set of images is captured at a second camera azimuth and different elevations 450-3, 450-4, a third set of images is captured at a third camera azimuth and different elevations 450-5, 450-6 and a fourth set of images is captured at a fourth camera azimuth and different elevations 450-5, 450-6 and so on through 360 degrees.

Images may be aligned vertically and/or horizontally in relation to each other to create the panoramic image. During this post-processing phase, the C&C system may manually or automatically adjust image parameters such as the resolution, scale, tone, contrast, sharpness, dynamic range, noise, and gain of each individual image or video to achieve a smooth composite of the combined images in the creation of the panorama. This may be especially important when using thermal, infrared, or multispectral cameras, as most of these camera types provide an image displaying relative ranges of the lowest to highest temperatures within the image frame, not absolute temperatures. Once a panorama is displayed, users may click anywhere on the panorama to move a camera to that location or a user may simultaneously move and zoom a camera by holding down a modifier key such as the CTRL key, clicking and holding a mouse button at one corner of the desired location the user wants to view on the panorama, dragging the user's mouse to the opposing corner of the desired area to form a rectangle, then releasing the mouse button, the same task may also be performed using a mobile device and finger inputs. Such actions may cause the C&C system to simultaneously move and zoom the camera to display the desired location. Panoramic images may have timelapse functionality where a user may display a sequence of historical panoramic images over a given period of time. As another option the C&C system may utilize one or more cameras to provide up to a 360-degree live panoramic video. For example, four cameras, each with a 90-degree field of view, may simultaneously capture video and the C&C system may stitch the individual videos together to provide system users or the public with live 360-degree situational awareness from the camera site. These live videos may be immediately displayed within the C&C system or stored and displayed later upon user request at a user desired selectable playback speed. As another option a user may search for a location or click a location on a map to display panoramic images from multiple camera sites with the selected location centered within each panorama. Once the panoramas are displayed, the user may be able to move and zoom each camera by directly selecting and clicking on areas within the panoramas.

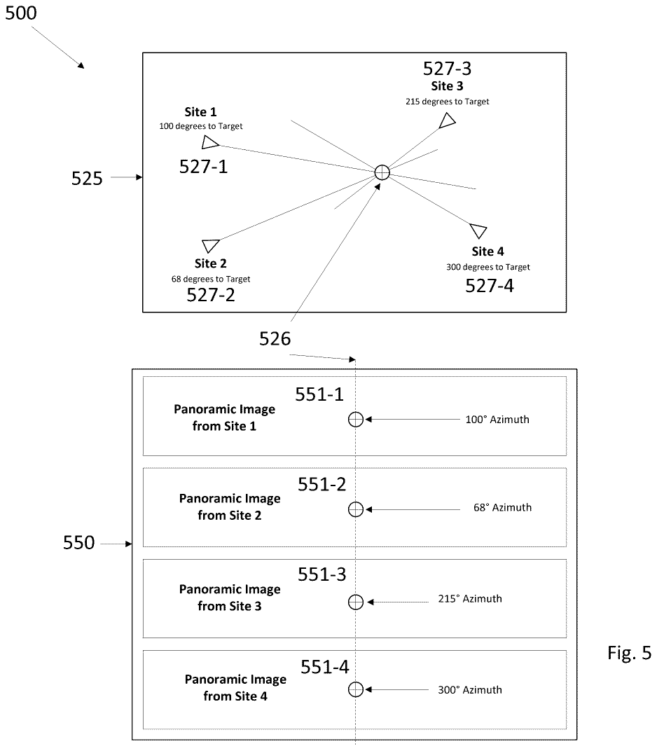

FIG. 5 shows how panoramic images from various sites may be aligned to a target location and displayed for users'rapid situational awareness according to the embodiments of the present invention. As shown, a system map 525 and user display 550 cooperate to achieve rapid situational awareness for users. Via the system map 525, a user can search a map or click on a desired target location 526. Once the target location 526 is selected or otherwise identified, cameras 527-1 through 527-4 are directed by the system on the target location 526 for purposes of generating panoramic images. The user display 550 may then display multiple generated panoramic images 551-1 through 551-4 based on pre-established parameters (on this instance, the azimuth angle).

### Panorama Combining 2 or More Cameras

The C&C system may generate a panorama by combining images from 2 or more cameras at the same location proximate to one another. This may be useful at certain locations where a single camera may have local obstructions preventing 360 views and one or more additional cameras is needed. For example, two or more cameras may need to be mounted to different sides of a fire lookout building to provide a full 360-degree viewshed. The two or more cameras may each capture one or more images or videos of certain azimuth ranges less than the full 360-degree range and then the C&C system may process, combine, and display the new 360-degree panorama. This may be useful to maximize situational awareness. AI and other detection techniques may utilize this method of combining images to ensure all areas are scanned for objects of interest, such as new fire starts.

### Panorama Patrol Mode

The C&C system may allow users to setup camera patrol mode patterns within the system. Patrol mode patterns allow one or more camera(s) to cycle between various user or system defined locations, returning one or more image(s) or video(s) from each location during each patrol cycle. Users may initiate patrol modes by clicking a button on a camera console page to enable patrol mode creation/modification or a user may hold down some sort of key modifier (such as the CTRL key) to enable the ability to select multiple points within a panorama and then click a button to use those points to build a camera patrol pattern. Users may have the ability to set patrol image or video capture rates, time delay between each capture location and the overall patrol cycle frequency.

### Camera Virtualization/Image Feeds

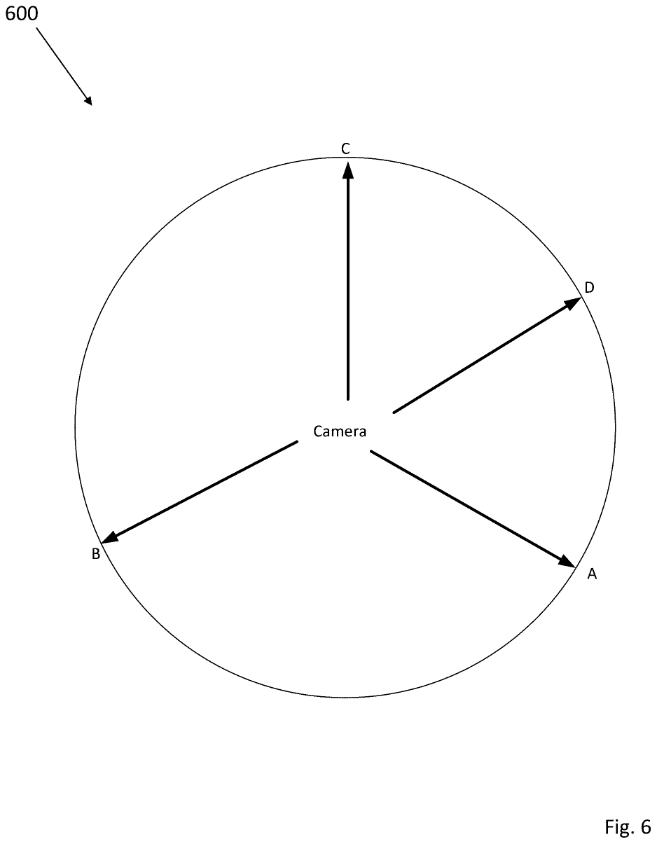

The C&C system may have the ability to virtualize camera operation, image collection and/or playback to create the appearance of more cameras at a location than are actually present. Virtualizing allows scheduled image or video acquisitions of different locations from a single camera and may return a unique image or video per virtual camera feed after a set or dynamic time interval based on the number of camera movement requests in the image acquisition scheduler. Virtual camera feeds may maximize camera functionality by simulating more cameras than are physically installed at a location and may be useful to prevent user contention. For example, when multiple users have conflicting needs to view different locations from the same camera, virtual camera feeds may provide each user imagery of their desired location without other users being impacted. The C&C system may accomplish this by commanding the camera to quickly cycle back and forth between the different user specified locations, capturing an image at each location and then returning the images to each user within a set time period (e.g., every few seconds). FIG. 6 shows a camera 600 moving through target locations in order A, B, C and D. Virtualized cameras within the C&C system may display virtual feed identifiers such as 1, 2, 3, 4 or A, B, C, D on a camera console page allowing users to quickly move back and forth between various virtual camera feeds or may just display the feed locations in a new or existing panel. As another option all virtual camera feeds may be displayed somewhere within a camera console page simultaneously including colored boxes that correspond to matching camera target lines on a map so a user can quickly view which image corresponds to which direction a camera is directed. A quilt of camera feeds may also be generated by clicking a button (including full screen and timelapse functionality) showing all desired areas from a given location simultaneously.

### Generate Image Quilts—Map/Search/Click Image

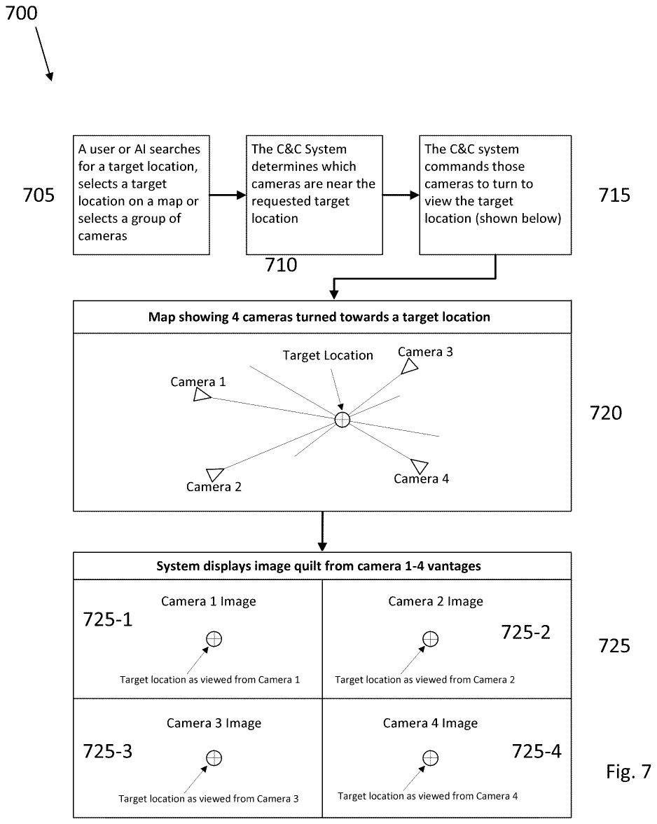

The C&C system may utilize user, system, or AI inputs to generate image quilts. Image quilts are system generated displays of images, camera feeds, panoramas, or videos captured from one or more cameras then arranged in some sort of horizontal and/or vertical image grid, where the image grid may be any number of horizontal images wide by any number of vertical images tall and combined into a single display interface. Image quilts may display one or more near real-time or historical images of one or more target locations from one or more cameras. Image quilts may be generated based on a user or system selected area. FIG. 7 shows a flow chart 700 detailing how a user may search for a target location or click on a map to cause cameras to turn to view the target location and generate an image quilt according to the embodiments of the present invention. At 705, a user or AI searches for a target location and selects a target location on a map or a group of cameras. At 710, the system determines which cameras are proximate the target location. At 715, the system commands the cameras identified at 715, to direct at the target location. At 720, four subject cameras are shown directed at the target location. At 725, the system displays each of the images 725-1 through 725-4 from the four cameras on the display in a quilt format.

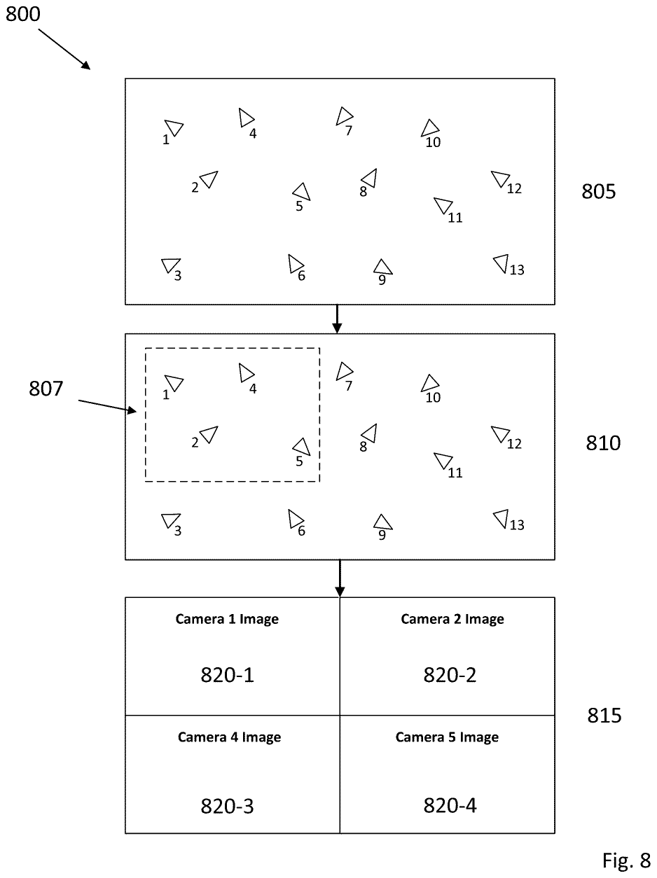

As an option, as shown in FIG. 8, a user may generate an image quilt using a map displaying camera locations, where the user may include or exclude various cameras as desired using some sort of perimeter drawing tool such as a rectangle, circle, or polygon to display whatever the camera is currently directed. FIG. 8 shows a flow chart 800 detailing how a user may select a group of cameras on a map and generate an image quilt according to the embodiments of the present invention. At 805, a user views a field of cameras on a system display. At 810, the user selects certain of the cameras - shown by box 807 setting a perimeter about cameras 1, 2, 4 and 5. At 815, the images 820-1 through 820-4 from each of cameras 1, 2, 4 and 5, respectively, are displayed in a quilt format.

As another option the user may include or exclude cameras by clicking on individual or groups of camera icons on the map, or the user may be able to select or deselect camera images by utilizing a search bar or clicking on camera images within a group of camera images or an image quilt. Once an image quilt is generated by the system or a user, the image quilt may be shareable with other system users or the public. The created image quilt may be displayed on the same webpage or browser tab or may be displayed on a new webpage or browser tab or an application on a users'mobile device. After an image quilt is generated, quilts may still be modified by the user whereas the user may continue to add or remove individual or groups of cameras using a map, search bar, or cameras may be removed by clicking on a camera image within the quilt, or by clicking some sort of button displayed on top of or near a camera image to be removed. The C&C system may automatically organize the image quilt display based on the quantity of images included in the quilt to maximize screen use. As another option, users may have the ability to increase or decrease the size of one or all images using an image sizing tool such as a slider bar. As another option users may be able to click a button to toggle between various image layout templates such as a layout with 2 large images and 8 smaller images, or the user may be able to select layout templates from a drop-down menu. Layouts may arrange images where some images may be much larger or smaller than other images to emphasize or de-emphasize certain images in the quilt. Users or the system may have the ability to select the image quilt's image sorting and display method to determine where images are displayed on the image grid such as displaying images in alphabetical order, distance from a user, distance from an object of interest's location, most camera views, most logged in users, most social media shares, or any other desired sorting method. Additionally, users may be able to custom sort their quilt images by clicking a button and/or clicking and dragging images around on the quilt display to the user's desired locations.

### Quilt Timelapse/Shareability/Customization

Once an image quilt has been generated, a user may click a button to initiate a historical playback of one, some, or all the images in the image quilt simultaneously. The user or system may select the desired image quilt time-lapse playback duration from a drop-down menu to view durations of time, such as: the last 5 minutes, 30minutes, 1 hour, 6 hours, or 12 hours. As another option, users may select more advanced time-lapse playback methods with the ability to view longer time durations, set start and/or stop dates and times, set the total duration of the playback, adjust the frame rate playback speed such as playing back frames at the same frame rate the frames were captured, or only displaying one frame for each historical period of time such as one frame per minute, hour, or day. Additionally, the frame delay rate may be set, which is the amount of time a historical image frame is displayed for a user before the system displays the next image frame. As another option, image filtering options may be available to filter what images are displayed by one or more camera(s) based on criteria chosen by the user, such as objects of interest or most recently moved cameras. Individual images within a quilt may be expanded to full screen or collapsed into the quilt at any time by clicking an image or button, including during time-lapse playback of the quilt. Camera images and image quilts may be shareable by copying and sharing the system generated URL or by clicking a share button to share the quilt with C&C system users or the public via any desired method including, but not limited to, email, text message and social media. The image quilt may be displayed within a web browser or application. Quilts may also be utilized during emergency situations such as a 911 call. For example, an emergency dispatcher may have the ability to click on a map location and cause the C&C system to immediately command all cameras within a certain distance of the clicked location to capture one or more images of the desired location and generate an image quilt displaying multiple angles of the target location of interest simultaneously.

### Camera Calibration Methods

The C&C system may provide a mechanism to calibrate cameras so the C&C system can accurately correlate each camera's location and orientation position with map displays, object of interest locations, panoramic image generation, viewsheds, digital elevation model overlays, AI, and general C&C system use. Camera calibration items include, but are not limited to, GPS location, elevation, height above ground level, horizontal azimuth clocking, and vertical axis levelness. Cameras may need calibration for a multitude of reasons including, but not limited to, poor GPS location accuracy, incorrect height above ground slightly off level or rapidly deployed. Cameras may be calibrated by users, the C&C system or AI. The C&C system may perform camera calibration through various methods including, but not limited to, a person physically mounting an orientation detection and calibration device to an installed camera and utilizing sensors within the device to detect and report the cameras orientation data to the C&C system, where the C&C system may then make any necessary offset adjustments within the C&C system. Another calibration method within the C&C system may allow a user to click on multiple points within a camera image or panorama and then click on the matching points on a map. Specific locations may include, but are not limited to, buildings, mountain peaks, roads, structures, the horizon, or other easily identifiable objects that appear in both the image and the map. Once locations are matched up between the camera image and the map, the C&C system may utilize an algorithm to determine the camera axis offset variances and then digitally adjust the variances to align the map to the camera orientation or vice versa.

### Camera Calibration and Pixel-to-GPS Mapping via Celestial

### And Terrain Models

The system enables precise calibration of PTZ or panoramic cameras by leveraging celestial body tracking and onboard gyroscopic sensors. Each camera's geographical location and altitude above ground level (AGL) are provided, and using high-precision ephemeris data published by NASA's Jet Propulsion Laboratory (JPL), the system computes accurate azimuth and elevation positions of the Sun and Moon at specific times, which are cross-referenced with visual detections in the camera imagery. Image processing determines if, and when, a celestial object appears in the frame, enabling a mapping between expected and observed positions, with the discrepancy quantified as azimuth and tilt correction offsets. When combined with real-time gyro data during a full 360-degree sweep, the system produces a tilt profile of the entire horizon, which allows determination of how level the camera is across its operational field of view and enables systematic corrections to be applied to any future positional queries that rely on the camera's orientation. Once calibrated, the system may accurately convert pixel-level detections (such as AI-identified smoke plumes) to Earth-based GPS coordinates. When an AI detection occurs, the system determines the pixel's corresponding azimuth and elevation angles based on the camera's orientation, correction profile, and known lens geometry. A simulation routine generates approximately 2000 virtual rays (azimuth/elevation vectors) extending from the camera into the terrain to form a virtual laser scan. Each ray is traced against a high-resolution (e.g., 5-meter) DEM until a collision point is found between a simulated ray and the terrain surface. Once a collision is detected, the system computes the corresponding geographic coordinates of the terrain impact point, thereby transforming the image-based detection into a precise GPS coordinate. This process enables real-time geolocation of objects seen in camera imagery, even when the camera is not perfectly level, and supports AI-based alerting, triangulation, and fire modeling workflows.

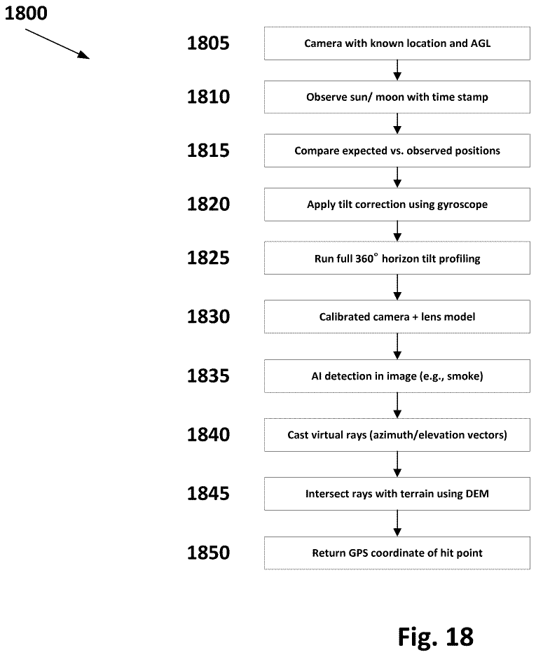

Referring now to FIG. 18, a block diagram illustrates the calibration and mapping pipeline described above. At block 1805, the process begins with a camera that has a known installation location and altitude above ground level. The system observes celestial bodies such as the Sun or Moon along with a precise timestamp 1810 and compares the expected versus observed positions to determine any alignment discrepancies 1815. These differences are corrected using gyroscopic measurements 1820, and a full 360-degree tilt profiling operation is conducted 1825 to produce a calibrated camera and lens model 1830. When an object is detected in the image, such as a smoke plume 1835, the system derives azimuth and elevation vectors and casts virtual rays into the surrounding terrain 1840. These rays are intersected with a high-resolution digital elevation model 1845, and the GPS coordinate of the first terrain collision is returned as the estimated ground location of the detected object 1850.

### Terrain-Based Initial Calibration and Baseline Image Creation

In one embodiment, the C&C system performs an initial calibration by aligning camera imagery with digital terrain models and basemaps to establish a precise ground-referenced orientation. The system retrieves ground elevation and map tile data across the anticipated view distance using a tile-based or rasterized terrain data retrieval mechanism, optionally performing viewshed analysis to exclude non-visible pixels. The retrieved elevation and map data are projected into a simulated panoramic scene representing the expected terrain view from the camera's location. A real panoramic image is then captured from the camera and compared to the simulated panorama using key point matching to align the two images. A user or AI model confirms the ground alignment fit, after which the corrected panorama is stored as a baseline reference. Metadata associated with the baseline reference may include azimuth offset, tilt correction, elevation adjustment, solar time, date and time, and average pixel values. This baseline reference image forms the anchor for subsequent image-to-image calibration cycles and removes the need to repeat terrain alignment for each calibration.

### AI-Assisted Ongoing Calibration with Field-of-View and Lens Tilt Analysis

During ongoing calibration, the system captures a new panoramic image from the camera and analyzes it to determine current field-of-view parameters and quantify lens tilt angle within the housing. This step detects physical changes such as camera movement, zoom adjustments, or housing displacement that could affect orientation. The new panorama is matched against the stored baseline reference using AI-assisted feature alignment models trained to detect terrain contours, edges, and spatial transitions across both images. Pixel-level comparisons may be applied to adjust for snow cover, seasonal vegetation changes, or lighting differences between day and night. Orientation offsets are updated based on the results of this matching process, and a transformation matrix is computed to produce revised calibration metadata, including azimuth offset, tilt correction, and elevation adjustment. These updates support downstream tasks such as pixel-to-GPS conversion and AI-based alert generation.

### Calibration Confidence Scoring and Network-Level Validation

The system may perform calibration confidence scoring to evaluate the quality of image alignment, factoring in the number and quality of matched key points, residual alignment error, and agreement with stored baseline parameters. Network-level validation may be conducted by comparing overlapping fields of view across multiple cameras to ensure consistency in terrain feature placement and geospatial alignment. Discrepancies may trigger an immediate return to the ongoing calibration process for corrective adjustment. This continuous validation loop enables the detection and correction of calibration drift over time without requiring manual intervention, maintaining long-term geolocation accuracy and ensuring that both initial and ongoing calibrations remain spatially reliable.

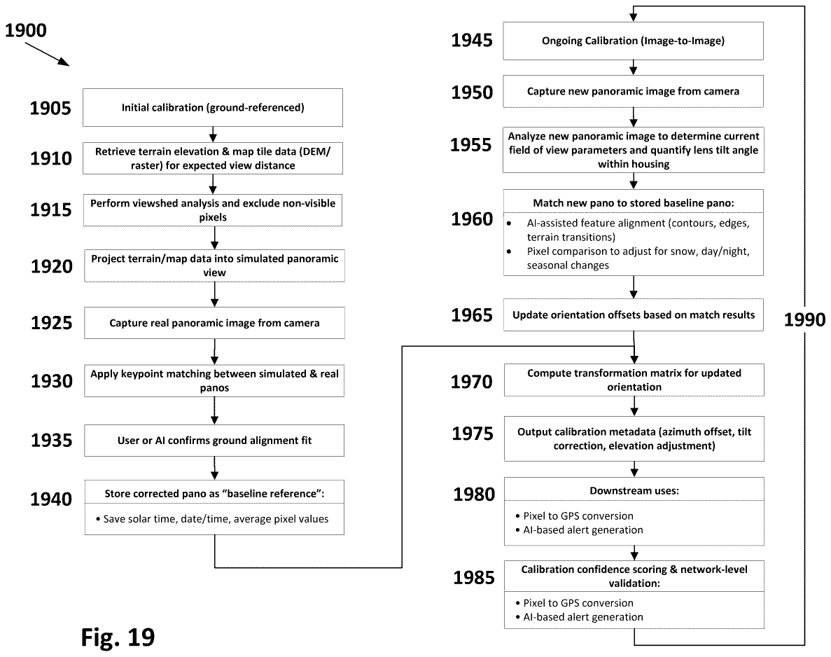

Referring now to FIG. 19, a block diagram illustrates a dual-branch workflow for camera calibration and validation. The left branch, steps 1905-1940, represents the initial ground-referenced calibration, in which the system retrieves terrain elevation and map tile data 1910, performs viewshed analysis to exclude non-visible pixels 1915, and projects terrain and map data into a simulated panoramic view 1920. A real panoramic image is then captured from the target camera 1925, and key point matching is applied between the simulated and real panoramas 1930. A user or AI confirms the ground alignment fit 1935, and the corrected panorama is stored as a “baseline reference” 1940 along with solar time, date/time, and average pixel values for future matching. The right branch, steps 1945-1985, handles ongoing image-to-image calibration. A new panoramic image is captured from the camera 1950, and the system analyzes the image to determine current field-of-view parameters and quantify the lens tilt angle within its housing 1955. The new image is then matched to the stored baseline panorama 1960 using AI-assisted feature alignment and pixel comparisons to account for lighting, snow, and seasonal changes. Orientation offsets are updated based on match results 1965, and a transformation matrix is computed for the updated orientation 1970. Updated calibration metadata, including azimuth offset, tilt correction, and elevation adjustment, is output 1975 for downstream uses such as pixel-to-GPS conversion and AI-based alert generation 1980. A calibration confidence scoring and network-level validation step 1985 evaluates alignment quality and can return the process to step 1945, as shown at 1990, for recalibration when needed.

### GPS—Quilts, Track Users/Equipment & User Upload Images

Another embodiment of the current invention may be to capture, store, track and display geographic location data of system users, field resources (such as firefighters, fire engines, bull dozers, water tenders and aircraft) and members of the public. Geographic location data may be imported manually or automatically by a user, a user's device, the C&C system, an external system, or AI. Geolocations may be captured through a user's IP address, global positioning system (GPS) receiver, LoRaWAN GPS tracker, a C&C system mobile application, a third-party application such as the Android Team Awareness Kit (ATAK) or a user's cell phone or tablet's location services.

### C&C System Mobile Application

The C&C system may include mobile and/or web applications for users capable of performing certain functions including, but not limited to, one or more of the following: logging into the C&C system, enabling or disabling GPS tracking, updating user account information, linking field resources to a C&C system user (such as equipment, or aircraft), communicating with other system users via text or voice chat (on a per camera, per company, per incident, or system wide basis), uploading imagery and/or videos from a user's location to the C&C system, controlling and moving cameras, generating panoramic images, generating/modifying/viewing image quilts (including the ability to display a quilt of camera images within close proximity to the user by the click of a button), sharing imagery and location data (with other C&C users within the system, or externally to the public via social media, text message, and email), marking an object of interest on a map within the C&C system (such as a fire), and requesting field resources to be sent to the users specific location such as aircraft, equipment or personnel. In addition to an application for C&C system users, a publicly accessible application may provide much of the same functionality and incorporate public cellphone locations and imagery into the C&C system maps as another layer to allow the rapid sharing of situational awareness data during emergencies. The application may also allow users to scan a QR code to automatically assign themselves to an object of interest, incident, team or a map layer. This may be useful during emergency events where resources arrive from different locations and need C&C system access but have not had a user created in the system.

### Displaying Field User Location Data and Imagery

Once the C&C system captures a user's mobile device location, the user's location may be displayed on a map with some sort of icon. Icon types may vary based on the type of user, or field resource. For example, a hand crew firefighter's location may display as a person with a shovel, a user in a fire truck may display as a firetruck icon, a user in a water tender may display as a water truck icon, a user in a bulldozer may display as a dozer icon and a user in an airplane may display as an airplane icon. The C&C system maps may allow users to toggle on and off different user type layers. For example, one C&C system user may only want to view airplanes and fire engines while another user may only want to see firefighters on hand crews. User locations may continuously update, or only update for a specified amount of time, or be manually updated by a user, or be updated by the system when necessary. C&C system users or the public may have the ability to upload images or videos into the C&C system with their mobile devices for other system users or the general public to view. Users may have the ability to determine each image's sharing level, for example a firefighter user may want to share an image of a car accident or house on fire only with other firefighters but want to share less explicit images with the public. Some field resources such as fire engines may be equipped with 3^{rd} party GPS sensors and those sensors may be able to be queried through an API and fed directly into the C&C system. Additionally, aircraft utilize Automatic Dependent Surveillance—Broadcast (ADS-B) to broadcast an aircraft's GPS position, altitude, callsign and other information to receivers on the ground and in other aircraft. This data may also be integrated into the C&C system through an API so emergency commanders as well as firefighters in the field can track firefighting aircraft on the map to see exactly where air resources are located at any given time. In addition to tracking an aircraft's location, whenever an aircraft is within a certain range of one or more camera(s), the one or more camera(s) may automatically initiate a new camera feed that follows the aircraft, taking pictures or video as the aircraft flies along to capture retardant drops and their effectiveness at suppressing the fire.

GPS Icons Map—User, field resource and/or public user location icons may be displayed on one or more maps within the C&C system. By clicking on an icon, a text and/or image box may pop up on the map displaying data such as username, some sort of alpha numeric identifier, company name, GPS location coordinates (that may be sharable with other users by clicking a button or link within the C&C system), and an image or video thumbnail including a timestamp showing when the image or video was captured. Clicking on the image or thumbnail within the pop up may expand the image or video to full screen. As another option, C&C system users may be able to click on a GPS trail button within the pop up and cause the C&C system to display the historical GPS trail locations of the user or field resource. Icons may be displayed along the user's GPS trail on the map showing time stamps for when the user or field resource's device reported their location into the C&C system or may show another icon type whenever the field user reported in any image or video. The image or video may be clickable and viewable. Additionally, a C&C user (such as emergency command personnel and resource dispatchers) may be able to toggle on an individual or group of field resources, (such as a group of bulldozer's) historical GPS trail(s) to show the progression of field resources (such as where bulldozer(s) have previously cut fire line) and then a C&C user may draw a new line or path on the map which may then be transmitted directly to a user assigned to a field resource (such as a bulldozer) operators'mobile device to show the operator the desired GPS route where to proceed next (such as where to cut new fire line). Text or audio communications with additional details may also be sent to the operators'mobile device along with the new GPS route through the C&C system.

User Images in C&C System Map

As another embodiment of the invention, user locations and user images may be displayed within the C&C system in manner similar to how the C&C system displays camera sites and camera site imagery. When a C&C system user or the public uploads an image into the C&C system, an icon representing the location of the person performing the upload may display on a map as well as a tile of the image. By clicking on a user's location or a user's image icon, a popup may be displayed that includes items such as a thumbnail of the user's image, the user's name, company, phone number or other important user data like the image timestamp, GPS coordinates, viewing azimuth and elevation of where the image or video was taken. One or more user location icons and images may be displayed on a map simultaneously. In addition to being displayed on a map, user image tiles may also be displayed on the display interface in some form of image grid. By hovering over an image with a cursor or by clicking on an image tile, the icon representing where the image was taken may change color, change size or the icon itself may change to show the viewer exactly where that image was taken. As another option, one or more user's locations may be overlaid on top of images or videos using digital elevation models and/or AI to help show where field resources are in relation to an object of interest. By uploading user or public images into the C&C system, this may provide unparalleled situational awareness for system users. As an example, public users may be able to use their mobile device to upload imagery into the C&C system for first responders to see, such as a fire in an area or a down tree on power lines.

### Aircraft Thermal Imagery Over Fire

As another embodiment of the current invention, aircraft may be deployed over an object of interest. For example, an aircraft may be deployed to a fire to visualize the size, location, perimeter, intensity, and fuel loads within the fire's perimeter and in the path of the fire. One or more aircraft may capture imagery from one or more optical and/or thermal camera(s) affixed to each aircraft. The captured visual data may be stored, analyzed, prioritized, and displayed within the C&C system as one or more layers. C&C system users or the public may be able to access this data based on their user permission levels. AI may be utilized to analyze the aircraft data to detect any changes in a size, intensity, any newly detected changes (such as fire hot spots) as well as to manipulate and overlay the data on a 2D or 3D map for users to view. Additionally, once captured, this data may be sent through the C&C system to field resources within or near the object of interest (such as a fire) to give the field resources near real-time situational awareness (such as a fires location and behavior).

### Aircraft Collecting Data & Relaying Internet

In addition to visual capture devices, the one or more aircraft may also be equipped with one or more wireless antenna(s) allowing the aircraft to relay voice, data, and location information from field personnel through the aircraft to one or more ground stations, then to the C&C system. Information may also travel in the reverse order where voice, data and location information may be sent from a C&C system user through the Internet to a ground station then relayed through an aircraft to the field personnel. Each ground station may utilize one or more antenna(s) capable of tracking one or more aircraft simultaneously. Ground stations may utilize some method to continuously align the ground station antenna(s) in relation to the aircraft(s) as they fly and/or utilize omni-directional antenna(s) or antenna array(s) on the ground station(s), aircraft(s) or both to maintain constant connectivity between the ground station and the aircraft while it is in the air. Aircraft ADS-B may be utilized by the ground stations to track the exact location of an aircraft at any given time, and the system may utilize this data to calculate the azimuth and elevation angles the ground station antenna(s) must be oriented to maintain data connectivity with the aircraft. Additionally, communication between a ground station and an aircraft and/or an aircraft and a ground station may be relayed through a satellite. Utilizing aircraft with the C&C system may be useful when relaying critical information between field resources and incident commanders, particularly in remote areas where traditional handheld radios and cellular devices have poor connectivity or dead spots. All types of aircraft may be utilized including manned and/or unmanned drones, fixed wing aircraft, and rotorcraft. The aircraft may also act as a UHF/VHF repeater for field personnel's handheld and vehicle mounted radio communications.

### Digital Elevation Models With Overlaid Maps and Images

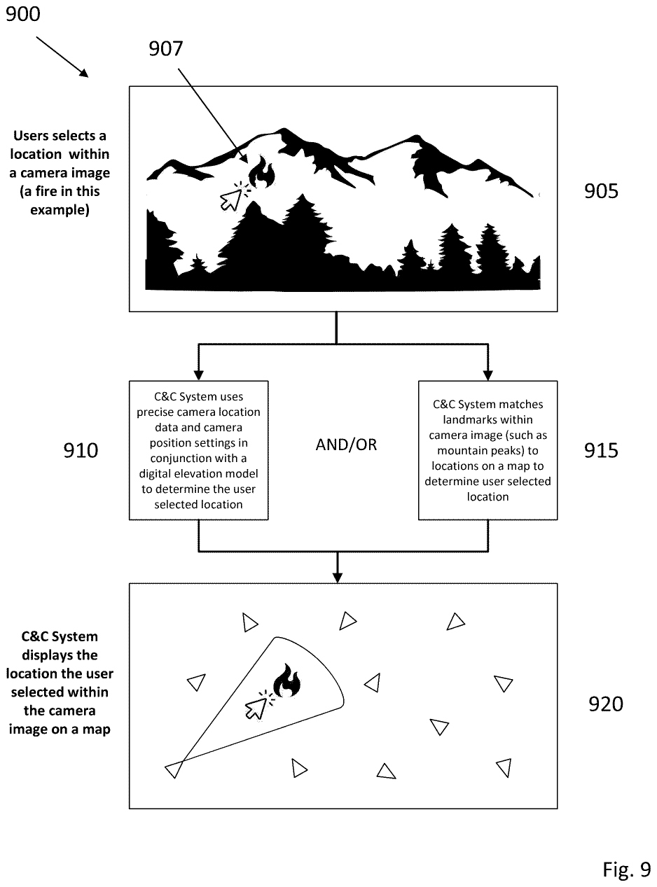

One or more image(s) and/or video(s) extracted from one or more camera(s) may be utilized with 3D digital terrain elevation models and map layers. Satellite imagery, topographic, road, state, county, forest service boundaries or any other desired type of map may be overlaid over a digital terrain elevation model, then one or more camera images and/or videos may be overlaid on top of the digital terrain elevation model and map layer. By projecting camera image(s) and/or video(s) onto digital elevation models and including various map overlays, users'situational awareness may be greatly improved by providing them with a 3D view of what the camera is viewing as if they were standing at the camera in real life. This 3D view may also have other data projected onto the digital terrain elevation models including, but not limited to, landmarks such as roads, towns, utility lines, gas lines, lakes, rivers, vegetation fuels or any other desired data via any 3^{rd} party systems or databases. LiDAR data may be used to give highly detailed digital elevation maps including displaying individual trees and other obstructions such as buildings. Digital terrain elevation models may also provide users with the ability to a click on a location in an image, video, digital elevation model or map, then display that location on the respective other types of maps or images. For example, if a user clicks on a location within an image or panorama, the C&C system may display that specific location on a 2D or 3D map as shown in FIG. 9 As another option, a user may be able to select a location on a map or digital elevation model and the C&C system may then display the selected location within an image or panorama.

FIG. 9 shows a flow chart 900 detailing how a user may identify a location on a map from a camera image according to the embodiments of the present invention. At 905, a user selects a location (fire 907 as shown) within a camera image. At 910, the system may use precise camera location data and camera position settings in conjunction with a digital elevation model to determine the user-selected location. Alternatively, or in addition, at 915, the system compares landmarks in the image to a stored map to determine the user-selected location. At 920, the system displays the location selected by the user.

### Pixel Matching for Fire and Smoke Geolocation

In one embodiment, the system may rely on various image-based techniques to estimate the real-world location of a detected fire or smoke plume. Pixel matching (also referred to as pixel-level analysis) refers to methods for correlating visual data from camera imagery to actual terrain locations. These techniques may include identifying the terrain collision point of a smoke plume or flame within an image frame; comparing sequential images to detect visual changes over time; overlaying camera imagery onto digital elevation models (DEMs) or satellite basemaps to align terrain features; extracting pixel regions associated with smoke, fire, or other visual anomalies; and triangulating object positions using camera metadata such as azimuth, tilt, zoom, and GPS coordinates. These methods may be applied independently or in combination to improve detection accuracy, refine geolocation, estimate fire perimeters, and support incident tracking. Pixel matching may be used in workflows involving a single camera or multiple cameras and may also serve as a foundational input to AI-based alerting, modeling, and consequence forecasting.

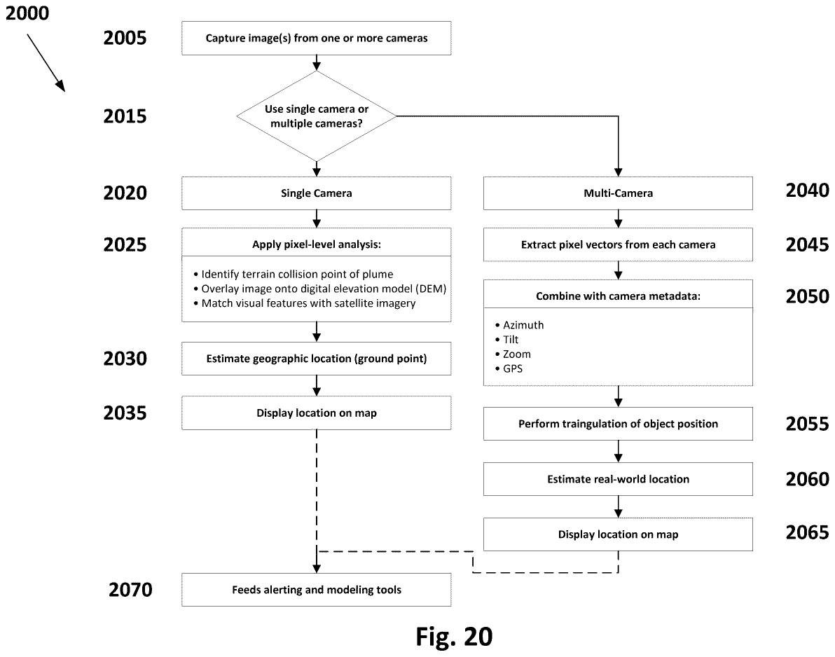

Referring now to FIG. 20, a flow diagram illustrates an image-based geolocation workflow that may utilize either a single camera or multiple cameras. The process begins by capturing one or more images from deployed cameras 2005, followed by determining whether single-camera or multi-camera analysis will be used 2015. In the single-camera path, the system applies pixel-level analysis 2025 to identify the terrain collision point of a smoke plume or other anomaly, overlay the imagery onto a DEM, and match visual features with satellite basemaps. The estimated geographic location is then calculated 2030 and displayed on the system map 2035. In the multi-camera path, pixel vectors are extracted from each camera 2045 and combined with associated metadata such as azimuth, tilt, zoom, and GPS position 2050. The system performs triangulation of the object's position 2055, estimates its real-world location 2060, and displays it on the map 2065. In both workflows, the resulting geolocation may be passed to downstream modules 2070 that support AI-based alerting, fire modeling, consequence forecasting, or incident tracking.

### Artificial Intelligence/machine Learning

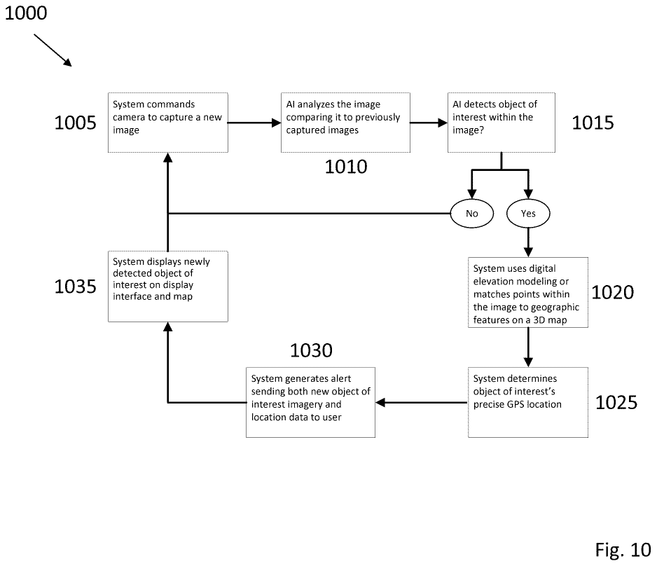

The C&C system may rely on AI and ML to automate and optimize various tasks within the system. This reliance includes, but is not limited to, controlling cameras, detection and tracking of objects of interest (such as fires) and extracting object of interest boundaries from images. AI and/or ML may also be utilized to identify, detect, measure, locate, sort, alert, and track objects of interest movements, changes in size as well as other notable changes (such as a fires temperature or smoke color over time). The C&C system may also use historical images previously taken and stored in an archive to train the AI, analyze and predict an object's future change in direction, position, and size. Images and/or panoramic images and/or video may be sent to one or more (ML) and/or AI models within the C&C system or to an external 3^{rd} party source (a Modeler or The Modeler). A Modeler may be trained to recognize specific objects of interest, such as fire, smoke, open areas, vegetation, roadways, bodies of water, utility lines, or any other landmark. The Modeler may also classify objects of interest. If objects of interest are detected within one or more camera image(s) and/or video(s), the Modeler or the C&C system may generate an alert and/or display one or more camera image(s) and/or video(s) on a user interface as shown in FIG. 10.

FIG. 10 shows a flow chart 1000 detailing how AI may be utilized to analyze images to detect, locate and alert users when a new object of interest is identified according to the embodiments of the present invention. At 1005, the system commands a camera or series of cameras to capture an image. The location of the image may be randomly selected, user selected, system selected or AI selected. At 1010, AI analyzes the image by comparing it to previous images of the same location. At 1015, it is determined by AI (or other system) if an object of interest has been identified. Objects of interest (e.g., fire, smoke, etc.) may be entered into a system database for reference by the AI or other system. If, at 1015, no object of interest has been identified, the system loops back to 1005 to capture a new image for analysis. If, at 1015, an object of interest has been identified, ay 1020, the system uses elevation modeling or landmarks to determine the location of the object of interest. At 1025, a GPS location of the object of interest is determined. At 1030, the system sends an alert to relevant personnel including imagery of the object of interest and its location. At 1035, the system displays the new object of interest on a display interface and adds it to a map.

The display of alerts and/or camera image(s) and/or video(s) may be specific to a location or geographic area defined by a user. The C&C system may utilize historical image(s) and/or video(s) taken prior to an event to link new objects of interest to an existing incident or send an alert that an object of interest has been discovered outside of a predefined or dynamically defined area. Example events could include the identification of an object of interest or the creation of an incident such as a new spot fire outside of a predetermined fire perimeter boundary, or the presence of smoke in a location where smoke is not normally present, or a vehicle in a location where one was not expected or should not be. The Modeler or user may provide the location of a recognized object to the C&C system, which may then instruct one or more camera(s) to turn towards the object of interest and begin recording images and/or videos. A Modeler may also provide the C&C system with object of interest movement data so one or more camera(s) may dynamically track the object of interest. Once the Modeler validates it has recognized an object of interest, the camera image(s) and/or video(s) of the object of interest may be sent back to a previous Modeler or forwarded to a different Modeler which may extract the edges of the object of interest and may store the data in a database. The Modeler may then match the image(s) and/or video(s) and edges of the object of interest to geographical locations, and then may store the location data in a database. The data may then be visualized using mapping software or on a webserver and may be used in conjunction with other components mentioned herein. The Modeler may gather data from multiple data sources, including, but not limited to, live and historical weather data gathered from weather stations, ground coverage data, fuel mapping, 3rd party models, and location data from other cameras to predict how a specific object of interest may change over time. The Modeler may also use the new prediction data to provide key events, such as the time when a fire is expected to reach a user specified point of interest (POI) (towns, buildings, roads, utility infrastructure, etc.). The previously gathered location data of a specified object of interest may then be used to derive analytics regarding a change over time. In the case of a fire, some examples of statistics that may be derived include the rate of spread, estimated acreage, and weather information.

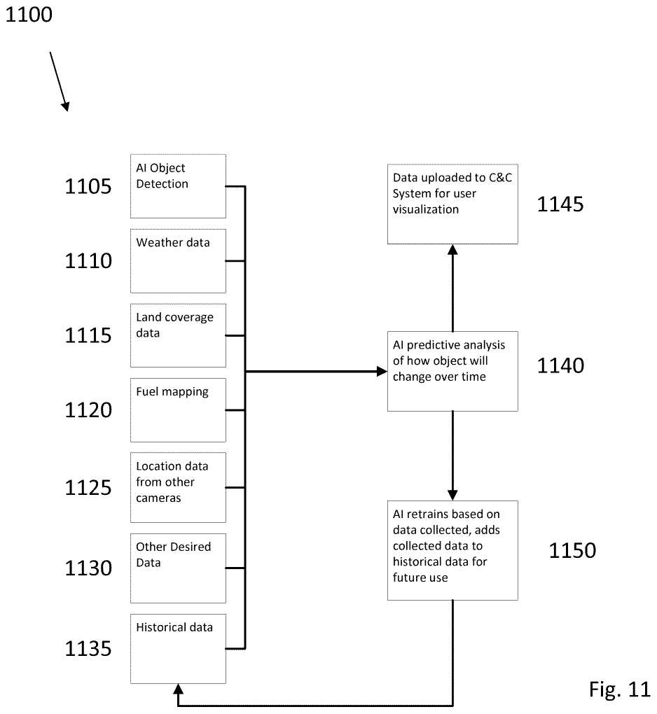

FIG. 11 shows a modeler schematic 1100 detailing how AI may be able to predict object of interest changes over time and become more accurate over time as more data is captured according to the embodiments of the present invention. Based on a detected object 1105 (e.g., AI detected object), the system may use weather data 1110, land coverage data 1115, fuel mapping 1120, data location from proximate cameras 1125, other data 1130 and historical data 1135 to trigger AI predictive analysis on the object 1140. The system may upload the predictive analysis 1145 and/or the AI may be retrained 1150.

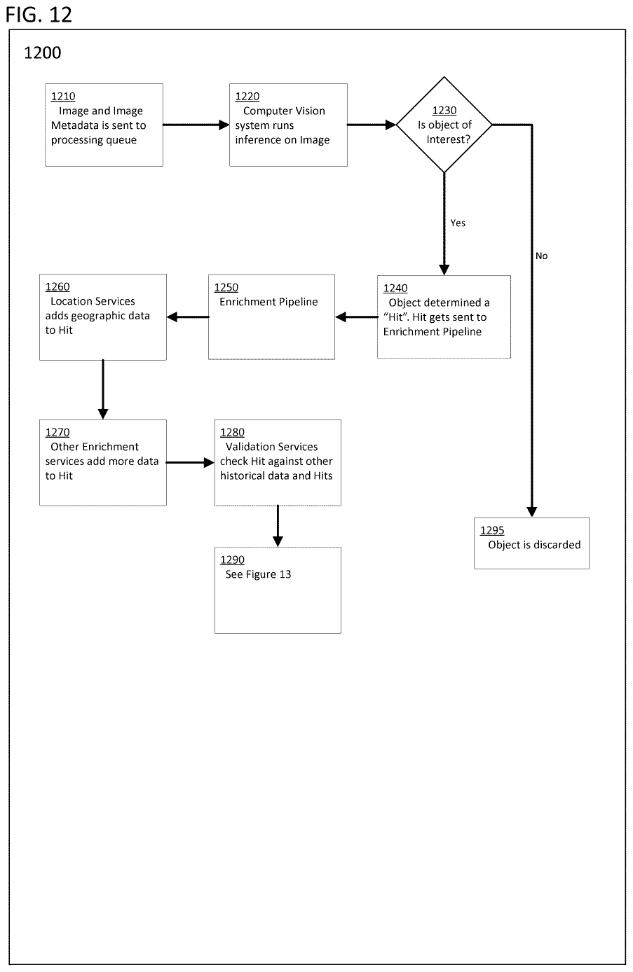

As shown in FIG. 12, the system may utilize a stream of data processed by the Computer Vision (CV) model to further confirm validity of an image as an object of interest, to enrich data, such as adding or updating associated geographic location data, inference of other process and unprocessed images and image metadata as shown in 1230 and 1280, or through backend processes designed to analyze multiple time-series events, including but not limited to a Recurrent Neural Network (RNN), AI applications, or other algorithms. The algorithms may also be utilized to enrich data output by the CV model, such as determining the geographical location of an Incident, identifying landmarks in the images, predicting various characteristics of the fire, predicting resource requirements, analyzing rate of spread of the Incident over time, or other enriching tasks. At 1210 images and image metadata enters the system for evaluation. At 1220 the CV model evaluates images for objects of interest. At 1230, trained AI searches for changes in images using existing Filters, images and/or other data (e.g., previous images, previous detections, geocoordinates, terrain elevations, maps) to identify possible objects of interest (e.g., column of smoke). If the object is determined to not be of interest, it is discarded as shown in 1295. If the object is determined to be a possible object of interest, at 1240 the object is classified as a “Hit” and enters the enrichment pipeline. At 1260 geographic data is added to the previously collected metadata and image. At 1270 any additional data identified as being relevant to the Hit is added to the Hit. At 1280, the Hit is validated against historical data and other Hits before being further processed. Pixel Matching techniques may also be applied as part of this enrichment and validation pipeline.

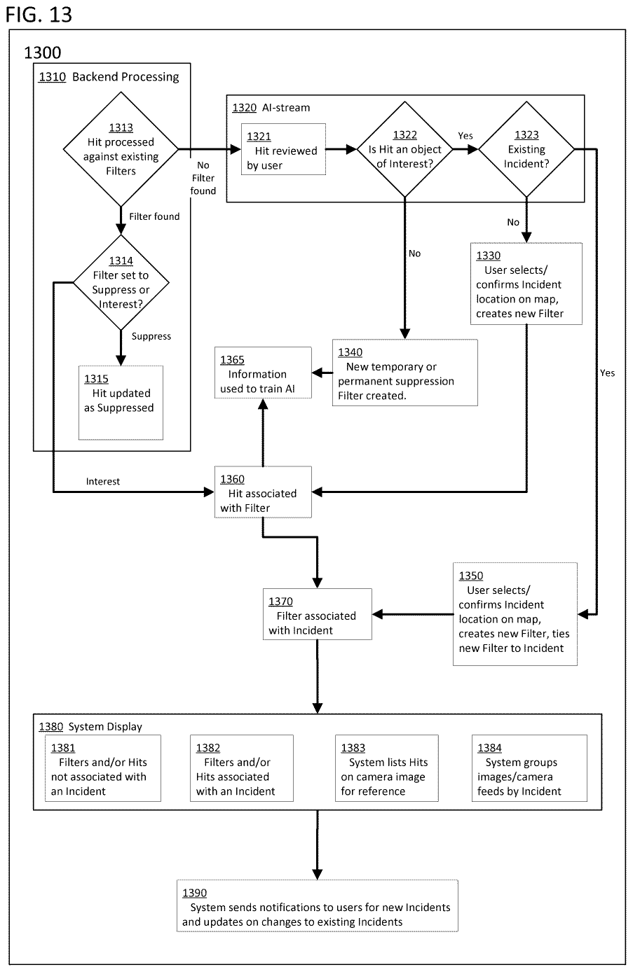

FIG. 13 shows a schematic flow chart 1300 detailing how AI assists with filtering out certain “Hits” from being identified as “Incidents.” In one embodiment, the system herein identifies each fire as an “Incident”. Filters are used to control which images or detections (deemed “Hits”) to include in an Incident. Hits include items like wood stoves, clouds or smokestacks that need to be filtered out. It is very labor intensive and/or impossible for one or more users to manually review every image with a Hit and identify the basis for the Hit. Consequently, as detailed herein, AI is trained to review previously created Filters to remove non-incident related Hits from the user's interface. In one embodiment, if a Hit has been tagged to be suppressed by an existing Filter rule, the system disregards it, and a user need not review it. Depending on the embodiment, Filters can be created to cover specific locations, large areas, colors of smoke, be active for certain times of the day, certain days, expire, not expire, etc. If a Hit has not been previously identified, the system draws a red box around the Hit (or otherwise highlights it) and displays it on a user's monitor. In one embodiment, trained AI generates a probability percentage of the Hit being an actual fire. For each red box that appears, a user must determine if the Hit is a fire or not. If it is, the user ties the Hit to an existing Incident (if one exists) or creates a new Incident that is reported to emergency personnel. For existing Incidents, the Hit is matched to an existing Filter (i.e., status updates or the Incident now being viewable from a different camera). These Hits are added to the images already available to users for monitoring the Incident. For new Incidents, new Filters are created so the AI can associate future Hits with the new Incidents, leaving users to focus energy elsewhere.

As shown in FIG. 13, at 1313, within the backend processing module 1310, the Hit is compared to previously identified images, data and/or instructions. The previous information is deemed a Filter. If the Hit matches an existing Filter, at 1314, the Filter is set to suppress or interest. At 1315, the Hit is marked as suppressed and no notifications are sent to users. If the Filter is set to interest, the chart 1314 advances the Hit to 1360 where the Hit is associated with a Filter. If, at 1313, the Hit does not match an existing Filter, the Hit is sent to an AI-stream user interface 1320 (comprising steps 1321-1323). At 1321, the Hit not matched to a Filter is displayed and reviewed. At 1322, it is determined if the Hit is an object of interest. At 1322, if the Hit is an object of interest, at 1323, it is determined if the Hit is related to an existing Incident. If so, at 1350, the user creates a new Filter, and ties or associates the new Filter with existing Incident. If, at 1323, the Hit is not related to an existing Incident, at 1330, a new Filter and Incident are created and, at 1360, the Hit is associated with the Filter. If the Hit is not an object of interest, at 1340, a new temporary or permanent suppression Filter is created. At 1365, the information from 130 is used to train the AI. After 1350 and 1360, at 1370, the Filter is associated with an existing or newly created Incident, at which point the system or user verifies Incident data, such as location, responsible parties, or other incident data. Upon Incident creation and/or verification or an update of associated data, such as location, at 1390, the system sends notifications to users with information such as location, image data, Incident ID, nearby cities, population impacted, rate of spread, expected burn path, weather data, or other relevant incident information via notification channels including but not limited to email, SMS, push notifications, automated voice calls, or other user-defined channels. Notifications may be delivered based on user defined periods of time and user defined areas. Periods of time may comprise, for example, one minute, one hour, one day, one week or indefinitely. Areas may include, but are not limited to, polygons drawn around areas and/or radiuses from communities or locations, counties, states or countries.

A system display module 1380 comprises the display of Filters and/or Hits not associated with an Incident 1381; the display of Filters and/or Hits associated with an Incident 1382; the display of Hits on a camera image or a set of images 1383; and the display of groups of images or camera views by Incident.

### Deduplication of Valid Fire Detections

In addition to suppressing non-actionable Hits, Filters also group repeated valid detections of the same fire into a single incident. This functionality is critical during fast-growing fire events, where many cameras may detect the same smoke plume from different angles or at staggered times. Without this grouping, operations center personnel may be overwhelmed by redundant alerts, and the AI stream interface and image processing queue may become saturated with repeat detections of the same event. This can delay review of new fires, strain computation resources, and in extreme cases, degrade system performance, delay real-time alerts, or even result in miss detections and alerts entirely. The filtering framework mitigates these risks by automatically associating duplicate Hits with the original Incident. This reduces operations personnel fatigue, preserves system responsiveness, and maintains operational clarity during high-volume events. Pixel Matching techniques may assist in identifying duplicate detections across different camera sources by comparing visual, temporal, and orientation metadata.

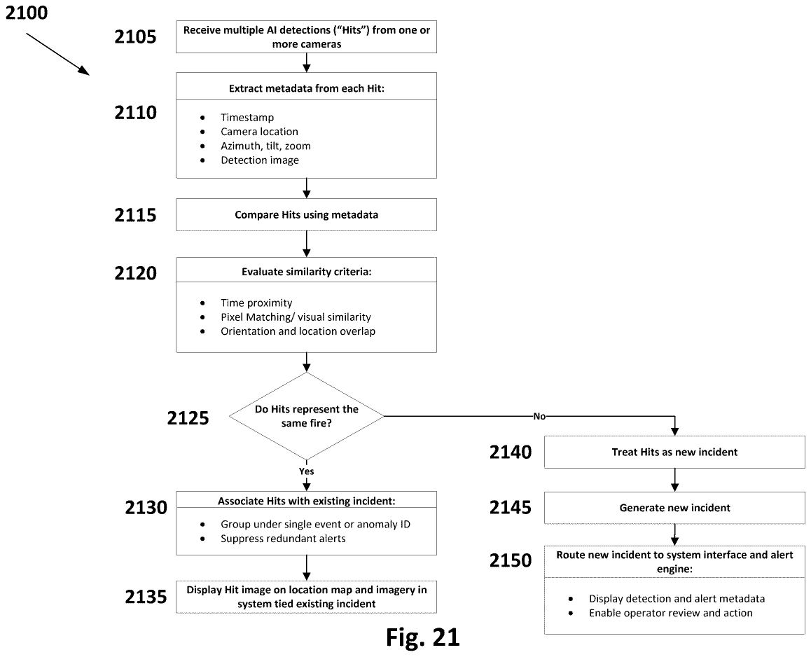

Referring now to FIG. 21, a flow diagram illustrates the system's deduplication process for evaluating whether multiple Hits correspond to the same fire or distinct incidents. The system first receives Hits from one or more cameras 2105 and extracts metadata including timestamp, camera location, azimuth, tilt, zoom, and detection imagery 2110. The Hits are then compared using metadata 2115, and the system evaluates similarity criteria such as time proximity, pixel-level visual similarity, and orientation or location overlap 2120. A decision step 2125 determines whether the Hits represent the same fire. If so, they are grouped with an existing incident 2130 under a shared anomaly ID to suppress redundant alerts, and the associated imagery is displayed in the user interface alongside the incident record 2135. If the Hits are determined to reflect a separate ignition, the system treats them as a new incident 2140, generates a new incident record 2145, and routes it to the system interface and alert engine 2150, where detection metadata is displayed and human operators may review, confirm, or escalate the alert. This deduplication workflow reduces alert fatigue, maintains interface clarity during high-volume periods, and ensures each detection is routed and visualized appropriately.

### Alternative AI Hit Display, Anomaly Creation and Alerting Method

In another embodiment of the present invention, the system may display all AI-verified fire Hits directly on the map interface without requiring an associated anomaly or incident classification. These Hits may appear as clickable geolocated markers with accompanying metadata, such as timestamp, camera source, detection image, and confidence score. The display location of each Hit may be determined using one or more methods, including Pixel Matching techniques, triangulation from multiple camera views; use of camera orientation metadata (including azimuth, tilt, zoom, and GPS coordinates) combined with digital elevation models; or AI-estimated bearing from single-camera detections. Pixel-level analysis may include identifying the terrain collision point of a smoke plume within a single image, overlaying camera imagery onto digital elevation models or satellite imagery to align visual and geographic features, or triangulating fire locations using multiple camera views and orientation metadata such as azimuth, tilt, and zoom. This overlay method enables location estimation by comparing the observed smoke position to known satellite features, improving geolocation accuracy when conventional triangulation is not possible. Additionally, the display location may correspond to the estimated ignition point derived from a fire propagation simulation that predicts significant modeled consequences. When multiple methods are available, the system may select the highest-confidence geolocation or display a probabilistic envelope of possible locations.

Rather than automatically generating alerts with each displayed Hit, the system may also allow operators to manually promote any displayed Hit to an active alert or incident based on visual confirmation, external intelligence, or operational judgment. To support this workflow, the system may include a notification mechanism that monitors AI Hit activity in real time and alerts the operations center when a verified AI Hit appears without a corresponding anomaly within a defined proximity radius. This enables operators to evaluate early-stage or low-signal events that have not yet triggered external detection sources. Notification thresholds may be configurable based on distance to anomalies, elapsed time since Hit appearance, AI confidence, or estimated fire consequence severity derived from integrated modeling layers.

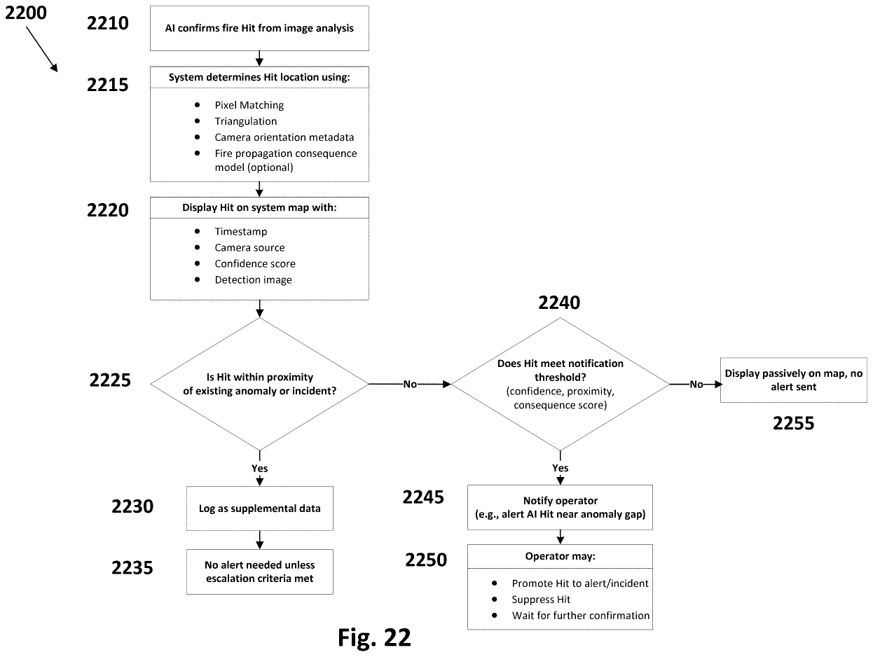

Referring now to FIG. 22, a flow diagram is shown illustrating an alternative method for displaying AI-verified fire Hits, evaluating their relevance, and optionally promoting them to alerts. The process begins when the system confirms a fire Hit from image analysis 2210 and determines its geolocation using one or more techniques including pixel matching, triangulation, camera orientation metadata, and optionally fire consequence modeling 2215. The resulting detection is displayed on the system's map interface along with metadata such as timestamp, source camera, confidence score, and detection image 2220. A proximity check is then performed 2225 to determine if the Hit is near a previously known anomaly or incident. If so, it is logged as supplemental information 2230 and requires no alert unless escalation criteria are met 2235. If not, the system evaluates whether the Hit meets a notification threshold 2240, which may be based on modeled fire consequence severity, confidence score, or distance to known activity. If the threshold is met, an alert is sent to the operator 2245, who may choose to promote the Hit to an alert or incident, suppress it, or wait for further confirmation 2250. If the threshold is not met, the Hit is displayed passively on the map for visibility without triggering an alert 2255. This flexible approach enables early awareness without overwhelming operators and supports manual promotion of AI detections when warranted.

### Manual Incident Creation and Plume Tagging

In some embodiments, the system may allow operators or verified users to manually create an incident within the C&C interface, independent of any AI-generated Hit. This feature is designed to support early incident reporting based on external intelligence, such as radio traffic, field observation, or social media reports. Users may draw a polygon on the map or select a camera view to tag a visible smoke plume or fire not yet detected by the system. Associated metadata, such as user notes, time of observation, and optional image snapshots, may be stored with the manually created incident. These manual inputs may be used to initialize AI processing workflows, assign Filters, or generate alerts to+ other users. This functionality supports operational flexibility in low-visibility, model-constrained, or emerging fire scenarios where proactive intervention may be required prior to AI confirmation.

### Multi Step Detection and Location Identification Method

In some embodiments, the system uses Pixel Matching techniques to determine the precise geographic origin of a detected fire. When smoke or fire is initially detected by a computer vision model operating on a wide-angle or zoomed-out image, the system may automatically trigger a zoomed-in capture from the same or additional cameras. Alternatively, a user in the operations center may have the ability to manually initiate the zoom within the C&C system based on visual confirmation or external sources such as radio traffic or field reports. In either case, the zoomed-in imagery enables Pixel Matching at higher resolution, which is essential for highly accurate geolocations of the detected fire.

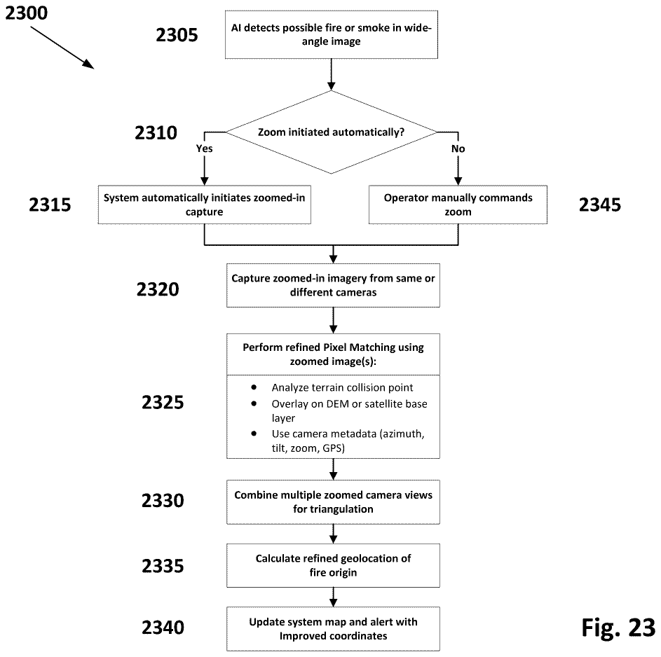

Referring now to FIG. 23, a flow diagram shows a multi-step process for refining the geolocation of a fire detection using high-resolution imagery and Pixel Matching techniques. When the system detects potential smoke or fire using AI applied to a wide-angle camera image 2305, it determines whether to initiate a zoom automatically or await manual operator input 2310. If the system determines the event warrants further investigation, it may trigger a zoom-in sequence automatically 2315, or alternatively, an operator may manually command the zoom based on visual review or external intelligence such as radio traffic 2345. Zoomed-in imagery is then captured from the same or different cameras 2320, enabling more detailed analysis. The system applies refined Pixel Matching to the zoomed imagery 2325, using methods such as identifying the terrain collision point of the plume, overlaying imagery onto digital elevation models (DEMs) or satellite base layers, and incorporating orientation metadata like azimuth, tilt, zoom, and GPS. If multiple zoomed camera views are available, they may be combined for triangulation 2330, and the system calculates a refined geolocation of the fire origin 2335. This updated location is then reflected on the map interface, and associated alerts may be revised with the improved coordinates 2340.

### Pixel Matching For Fire Origin Estimation

In an embodiment of the invention, the system applies Pixel Matching techniques to estimate the geographic location where the smoke column intersects the terrain—referred to as the ground collision point. When only a single camera is available, the system uses high-resolution imagery to perform matching based on terrain features, known camera metadata, and visual overlays. When multiple cameras detect the same event, pixel vectors and camera orientation data are combined to triangulate the fire's origin. As new imagery becomes available, the system may iteratively refine the fire's mapped position and update perimeters over time. Trained AI models may also distinguish between elevated smoke plumes and ground-level activity to improve spatial precision and reduce false positives. In terrain-obstructed conditions, a dedicated AI smoke model may infer perimeter shape based on observed smoke dynamics.

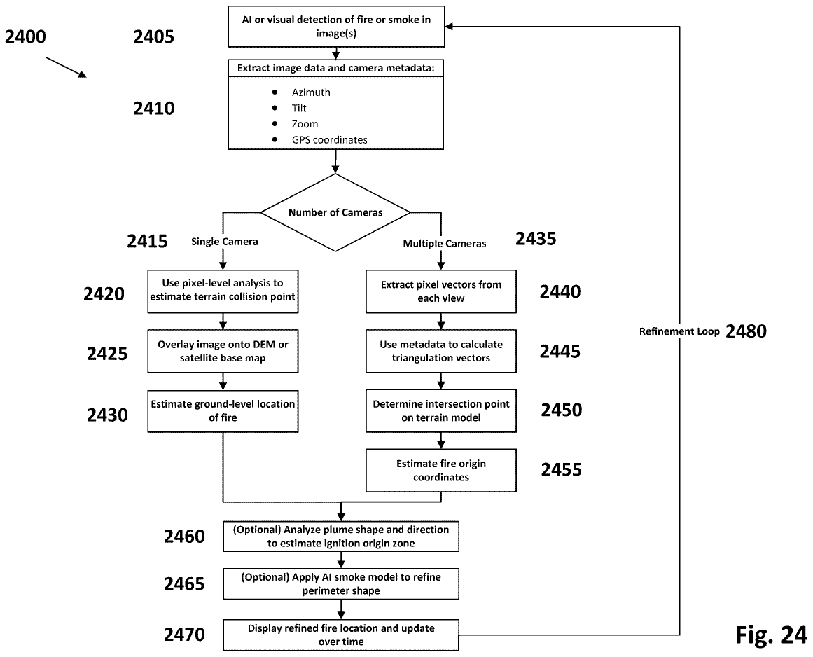

In one embodiment, the system estimates fire origin coordinates by applying pixel matching techniques to imagery from one or more cameras, as illustrated in FIG. 24. At block 2405, AI or human visual review confirms the presence of fire or smoke in one or more camera images. The system extracts relevant camera metadata such as azimuth, tilt, zoom, and GPS coordinates 2410, then determines the number of contributing cameras 2415. If only a single camera is available, the system estimates the terrain collision point of the smoke plume using pixel-level analysis 2420, overlays the image onto a DEM or satellite basemap 2425, and outputs a ground-level location of the fire origin 2430. If multiple cameras detect the event 2435, the system extracts pixel vectors from each view 2440, calculates triangulation vectors using orientation metadata 2445, and determines an intersection point over the terrain model to estimate fire coordinates 2450, 2455. Optional steps may include analyzing plume shape and direction to estimate the ignition origin zone 2460 or applying an AI smoke model to infer or refine the fire perimeter based on plume behavior 2465. The refined location is displayed and updated over time as additional imagery becomes available 2470, and the system may loop back via a refinement cycle 2480 to continuously improve geolocation accuracy as the fire evolves.

### Smoke Column Growth Tracking and Re-Alerting

In one embodiment, the system may use Pixel Matching to track the growth of smoke columns over time. By quantifying the number and spatial distribution of pixels containing smoke across consecutive images, the system calculates the rate and extent of plume expansion. If the smoke-affected pixel area exceeds a user-defined or system-calculated threshold, such as a percentage increase from a prior image or a fixed pixel count, the system may generate a re-alert or escalate the incident status. This ensures that growing or intensifying fires remain visible to system users, even if an earlier alert has already been acknowledged or cleared. This function is particularly useful in cases where a small initial smoke detection did not prompt immediate action, but rapid growth later indicates increased risk and operational urgency. In addition to tracking the pixel area of smoke plumes, the system may apply a trained smoke model to detect directional growth patterns or consistent dispersion trends that indicate fire expansion. These behavioral signals may trigger re-alerts even when direct flame visibility is unavailable.

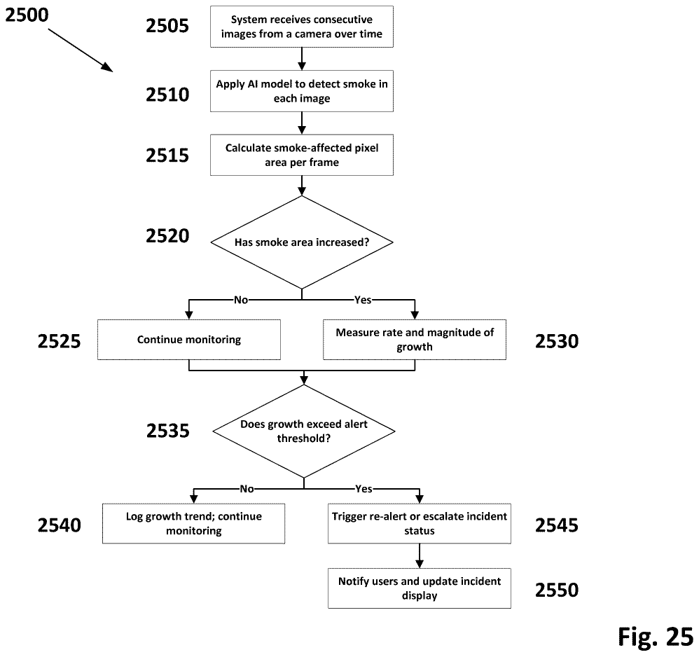

In one embodiment, the system tracks smoke plume growth to support dynamic alerting workflows, as shown in FIG. 25. At block 2505, the system receives a sequence of camera images over time. An AI model is applied to each frame to detect visible smoke signatures 2510, and the total smoke-affected pixel area is calculated for each image 2515. A comparison is made between frames to determine whether the smoke area has increased 2520. If no increase is observed, the system continues monitoring the trend 2525. If growth is detected, the system calculates the rate and magnitude of expansion 2530. At block 2535, a threshold evaluation determines whether the observed growth warrants escalation. If the threshold is not met, the system logs the trend and maintains monitoring 2540. If the smoke growth exceeds alert parameters, the system re-alerts or escalates the incident status 2545, and notifies users while updating the event display accordingly 2550. This process enables time-aware monitoring of emerging fire behavior and helps ensure that smoldering or low-visibility incidents are re-evaluated if conditions change significantly.

### User Configurable Weather Alerts

In one embodiment of the present invention, the C&C system includes a weather alerting feature that allows users to configure custom notifications based on forecasted environmental conditions. Users can define threshold values for critical wildfire-related variables such as wind speed, wind gusts, relative humidity, temperature, and precipitation. When forecast data—sourced from the National Weather Service, private weather providers, or integrated on-site weather stations—meets or exceeds these thresholds, the system automatically generates alerts.

### Integrated Fire-Weather Alert Generation

In one embodiment, the C&C system may evaluate multiple fire modeling and weather forecast inputs to trigger alerts for user-defined Locations of Interest. Alert conditions may be based on any combination of forecasted or modeled values including wind speed, relative humidity, temperature, fuel moisture content, vapor pressure deficit, fire potential index, and projected spread vectors. Users may configure compound thresholds such as wind speed exceeding a defined value while FMC is below a critical threshold and fire line arrival is projected within a set time window. Alerts may be routed through one or more notification channels and prioritized based on user-defined severity tiers, affected asset classes, or simulation confidence scores.

### User Provided False Positive Detection Locations & Annotation Layer

In one embodiment of the present invention, the C&C system includes a false positive feedback tool to reduce non-actionable alerts in AI-based detection systems. The tool includes an annotation layer that allows operations center personnel and end users to designate geographic zones commonly associated with false positives. Users may fill out a web form, draw polygons or import shapefiles directly onto the system map to identify known areas where alerts are routinely generated by non-fire sources, such as road dust, industrial stack emissions, chimney smoke, or agricultural activity. The system may also accept bulk inputs such as spreadsheets, structured datasets, or API submissions identifying known false-positive locations or recurring environmental patterns. These inputs can be used to populate or update the annotation layer at scale, streamlining suppression of alerts triggered in these areas under similar conditions.

The annotation layer may evolve over time based on input from both operations center technicians and system users, enabling continuous refinement of known false-positive zones. Each annotation may include contextual metadata such as seasonality, time of day, or typical environmental conditions to support more precise alert suppression. Users may also associate one or more reference images with each annotated zone, providing visual examples of known false detections such as road dust or chimney smoke. These reference images may be stored for future use in visual similarity checks or model refinement workflows. Annotations may be scoped at the individual, organizational, or system-wide level, allowing tailored control over alert behavior. The system may also maintain a change history or audit log of modifications to support transparency and operational accountability.

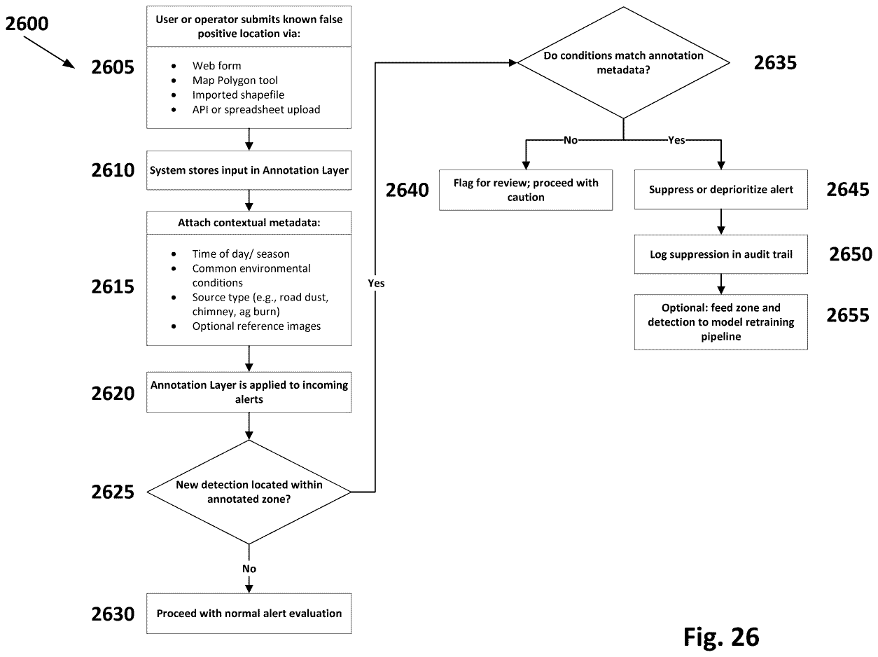

In one embodiment as illustrated in FIG. 26, the system incorporates a false positive feedback and annotation workflow to reduce non-actionable alerts from AI-based detections. At block 2605, users or operations personnel may submit known false positive locations through various input methods including web forms, drawn polygons, shapefiles, API submissions, or structured spreadsheets. These submissions are added to the system's annotation layer 2610, where contextual metadata such as seasonality, source type, time of day, or associated reference images may also be recorded 2615. When a new AI detection occurs, the system checks whether the detection location intersects with a known false positive zone 2620. If not, the alert proceeds through the normal evaluation and notification pipeline 2630. If the detection overlaps with an annotated zone, the system evaluates whether metadata conditions match suppression parameters 2635, such as expected timing or visual characteristics. If not matched, the alert may still be passed through with context attached 2640. If matched, the alert may be automatically deprioritized or suppressed 2645, and the event logged in the system's audit trail 2650. Reference images and suppression decisions may be routed to model refinement tools for future AI retraining 2655. This workflow enables tailored control over alert behavior and ongoing improvement in system precision.

### User Feedback Web Interface Tool

Separately, the system includes a user feedback interface for evaluating individual alerts. Users may indicate whether an alert was actionable, whether the system accurately identified the location, and whether the alert arrived prior to 911 dispatch or other official notifications. This feedback may be submitted through a web-based questionnaire and may include metadata such as time of day, environmental conditions, and camera perspective. The feedback is used to further refine model behavior, suppression rules, or alert prioritization, allowing the system to improve over time through operational learning. Such feedback may also be used to evaluate or improve location estimation techniques, including those that rely on Pixel Matching.

### Smoke Feature Analysis and Spread Rate Estimation from Camera Imagery

In one embodiment, the system uses AI to analyze smoke characteristics from visual imagery to support fire spread prediction. The model may evaluate individual features such as plume angle, column shape, smoke density, dispersion speed, and color variation. These characteristics are extracted from single images, sequences of frames from a single camera, or synchronized views from multiple cameras observing the same fire. For example, the angle and shape of the smoke column may indicate wind speed and direction, while motion speed and dispersion pattern reflect fire intensity and potential spread rate. Changes in smoke color may indicate variations in fuel type or combustion completeness. Dark, turbulent smoke may suggest intense burning of dry fuels, while lighter or whiter smoke may indicate lower fire intensity or wetter fuels. The AI system may process these features independently or in combination to infer expected fire behavior and direction of spread based on evolving smoke signals.

In another embodiment, building on the smoke feature extraction described above, the system uses AI to estimate a fire's rate of spread in real time by synthesizing the visual indicators into probabilistic predictions. The model outputs a dynamic estimate of spread speed and trajectory based on recognized smoke behavior, optionally incorporating additional inputs such as weather data or satellite-derived fuel moisture conditions. This estimation may be performed as a standalone calculation using camera imagery alone, or in conjunction with other data layers to improve confidence. The model may also integrate with the smoke perimeter module, which derives partial fire boundaries based on plume opacity and dispersion when ground-level flame edges are not visible. By combining visual analysis with supplementary environmental context, the system improves its ability to track spread patterns, especially in terrain-obstructed or rapidly evolving fire environments.

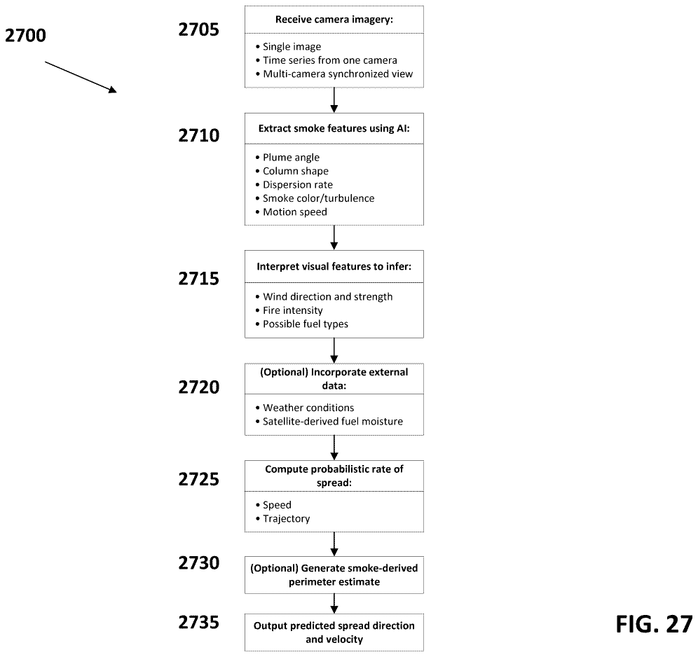

The workflow of FIG. 27 illustrates an embodiment of the smoke-based fire spread estimation process. At step 2705, the system receives camera imagery in the form of individual images, time series from a single viewpoint, or synchronized multi-camera views. Step 2710 involves extracting relevant smoke features using AI models, including plume angle, column shape, dispersion rate, smoke color, turbulence, and motion speed. These features are interpreted in step 2715 to infer fire-related indicators such as wind direction and strength, fire intensity, and likely fuel types. In step 2720, the system may optionally incorporate external data sources such as weather conditions or satellite-derived fuel moisture. Step 2725 the system computes a probabilistic spread rate based on the extracted visual and contextual indicators. In step 2730, the system may optionally generate a smoke-derived perimeter estimate to reflect the approximate fire boundary in the absence of ground flame visibility. Finally, at step 2735, the model outputs the predicted spread direction and velocity to inform downstream modeling and alerting functions.

### Integration Of Additional Data Layers

In one embodiment, the system enhances its AI-based fire spread predictions by incorporating a broad range of geospatial and temporal datasets alongside visual smoke features. These data layers enable more context-aware and accurate modeling of fire behavior across diverse environments. Inputs may include, but are not limited to: fire spread risk maps, detailed fuel type classifications, terrain slope and aspect data, vegetation cover and biomass density, historical fire perimeters, ignition frequency heatmaps, soil moisture content, drought indices, land surface temperature, population density, egress route availability, and proximity to critical assets such as utility infrastructure, emergency services, and communications towers. These layers are combined with real-time and forecasted weather conditions, including wind speed and direction, temperature, humidity, and atmospheric stability. The AI model dynamically fuses these inputs with visual smoke indicators to generate precise, location-specific forecasts of fire movement, spread speed, and impact zones. This multi-layered architecture allows the system to adjust predictions in real time based on changing environmental conditions, improving decision-making for suppression, evacuation, and infrastructure protection.

### Dynamic Risk Adjustment Based on Operational Context

In one embodiment, the system includes a dynamic risk adjustment module that modifies the modeled consequence severity of a fire incident based on real-time operational and environmental context inputs. The module ingests multi-source data including: (i) the number and severity of concurrent fire incidents within a defined geographic scope; (ii) real-time availability and location of suppression resources derived from operator input, CAD feeds, or integrated asset-tracking systems; (iii) geospatial visibility constraints based on current camera coverage and line-of-sight analysis; and (iv) presence of critical infrastructure, high-density population areas, or known blind spots. The system applies a weighted adjustment algorithm that modifies the initial risk score or consequence tier associated with a detected fire. For example, if a new incident occurs in a region with multiple active fires, sparse camera coverage, and no nearby suppression assets, the adjustment algorithm may elevate the risk tier to reflect compounded response limitations. Conversely, if the incident is detected within a high-visibility zone with suppression units already enroute or on scene, the adjusted output may reduce consequence projection accordingly. This context-aware risk adjustment ensures that fire modeling outputs are calibrated not only to the physical characteristics of the event, but also to the real-time operational readiness and observational fidelity of the system.

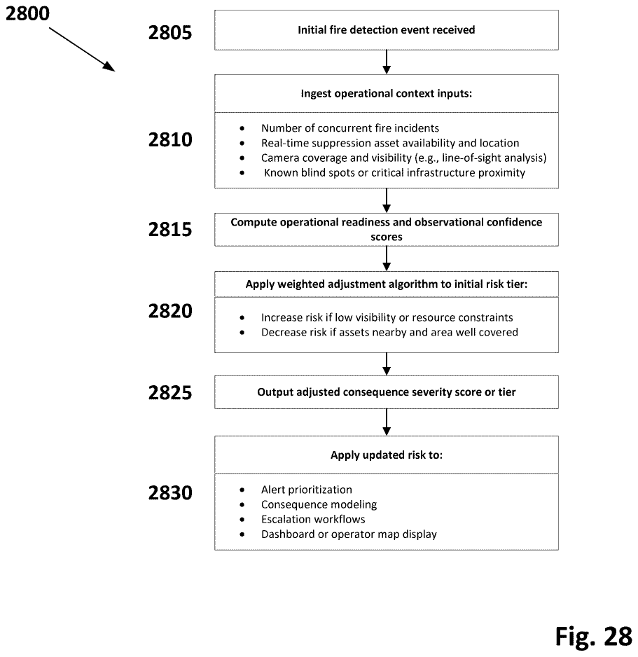

In one embodiment and as shown in FIG. 28, the system includes a dynamic risk adjustment module that activates upon receipt of an initial fire detection event 2805. The module ingests a range of operational context inputs 2810, such as the number of concurrent fire incidents, real-time suppression asset availability and location, current camera coverage and line-of-sight visibility, and proximity to blind spots or critical infrastructure. Based on these inputs, the system computes operational readiness and observational confidence scores 2815. A weighted adjustment algorithm is then applied to the initial risk tier 2820, increasing risk if conditions indicate limited visibility or constrained resources, or decreasing risk if assets are nearby and coverage is high. The adjusted consequence severity score or tier is output by the system 2825 and may be used to drive alert prioritization, consequence modeling, escalation workflows, and operator-facing dashboard or map displays 2830.

### Smoke-Derived Fire Perimeter Mapping Using AI Model

In one embodiment, the system includes a dedicated AI-based smoke perimeter module configured to estimate and spatially map the active perimeter of a wildfire based solely on visual analysis of smoke characteristics, without requiring persistent visibility of ground-level flames. The model operates on single images, frame sequences, or synchronized multi-camera feeds and uses computer vision techniques to identify, classify, and track spatial smoke signatures over time. Core features extracted from the imagery may include plume shape, boundary opacity gradients, turbulence contours, column dispersion vectors, and elevation-relative drift. These features are analyzed to infer likely fire line positions where continuous flame edges are not visible. The system may apply temporal coherence analysis to determine areas of consistent smoke generation, which it uses as proxy indicators of fire line progression. In multi-camera configurations, the system performs geometric alignment and spatial convergence analysis to identify overlapping smoke signal zones and assigns confidence values to derived perimeter segments based on cross-camera agreement, feature persistence, and historical growth vectors. The resulting output may be a dynamic, partial fire perimeter estimate composed of individually scored segments, which is rendered onto the system map for operator use. This perimeter product may be used in consequence modeling, asset impact estimation, and visual situational awareness, especially in terrain-obstructed regions or under heavy smoke conditions where conventional flame-line tracking fails.

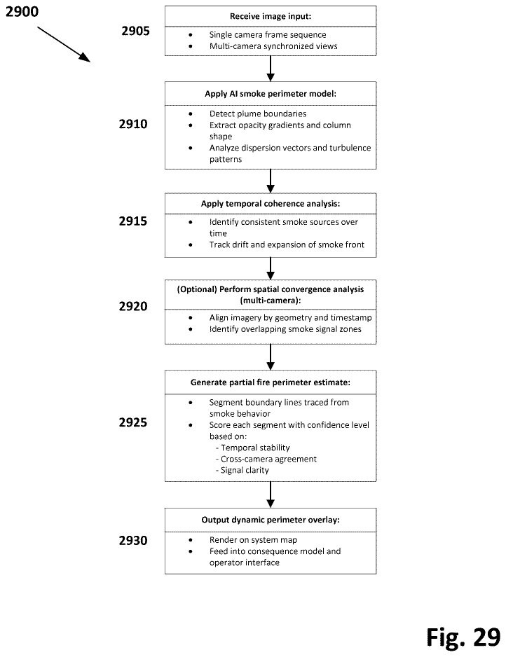

In the embodiment illustrated in FIG. 29, the system receives image input 2905 from either a single-camera frame sequence or synchronized multi-camera views, and applies an AI smoke perimeter model 2910 to analyze plume behavior. This model detects boundary features such as opacity gradients, dispersion vectors, and turbulence contours to infer likely fire line positions. Temporal coherence analysis 2915 is used to identify consistent smoke emission zones and track the spatial drift of the smoke front over time. In multi-camera configurations, spatial convergence analysis 2920 may be performed by aligning geometry and timestamps to identify overlapping smoke signal regions. Using these inputs, the system generates a partial fire perimeter estimate 2925 composed of segment boundaries traced from smoke behavior, each scored with a confidence value based on signal persistence, camera agreement, and clarity. The resulting perimeter overlay 2930 is dynamically rendered on the system map and may feed directly into consequence modeling modules or operator-facing situational awareness interfaces.

### Hybrid Two-phase Training of AI Fire Propagation Model

The AI fire propagation model, referenced throughout this disclosure as the core consequence modeling engine used for spread prediction, perimeter estimation, and risk scoring, is trained using a hybrid two-phase methodology. In the first phase, the model is pre-trained using a large corpus of synthetic wildfire spread data generated from a physics-based simulator implementing Rothermel fire behavior equations. This simulator produces thousands of progression scenarios under systematically varied environmental inputs, including topography, slope, aspect, vegetation types, fuel load and continuity, fuel moisture, ignition locations, and dynamic meteorological conditions such as wind vectors, temperature, and humidity. The resulting synthetic fire perimeters and spread trajectories provide the model with foundational learning on the physical relationships between environmental drivers and fire behavior. These scenarios simulate perimeter expansion over time, capturing realistic patterns such as wind-aligned runs, topographic channeling, flanking behavior, and barrier-driven suppression effects.

In the second phase, the model undergoes supervised fine-tuning using historical wildfire incident data containing recorded ignition points, time-stamped perimeter progression, and corresponding real-world environmental observations. This dataset includes weather logs, fuel moisture measurements, and suppression activity overlays such as aerial retardant drops, bulldozer line construction, and tactical backburn operations. The training process also integrates static and dynamic modifiers such as fuel breaks, containment boundaries, and weather anomalies, enabling the model to internalize the complex, nonlinear interactions introduced by operational interventions. Through this dual-phase approach, the model learns both idealized fire spread physics and real-world deviations caused by suppression and environmental variability, allowing it to produce probabilistic outputs that are physically grounded but operationally realistic.

The model architecture may include convolutional neural networks (CNNs) or vision transformers (ViTs) to process spatial map layers, combined with recurrent neural networks (RNNs), long short-term memory (LSTM) units, or temporal attention mechanisms to capture time-dependent progression patterns. Input data may be rasterized into aligned geospatial tiles and ingested alongside tabular weather and fuel inputs. Intermediate features from synthetic training are fused with real-world performance indicators to tune model weights and reduce overfitting. This multi-stage training pipeline enables the model to learn both theoretical spread mechanics and the practical behaviors observed during field operations, improving its ability to generate predictive simulations that are both accurate and operationally relevant.

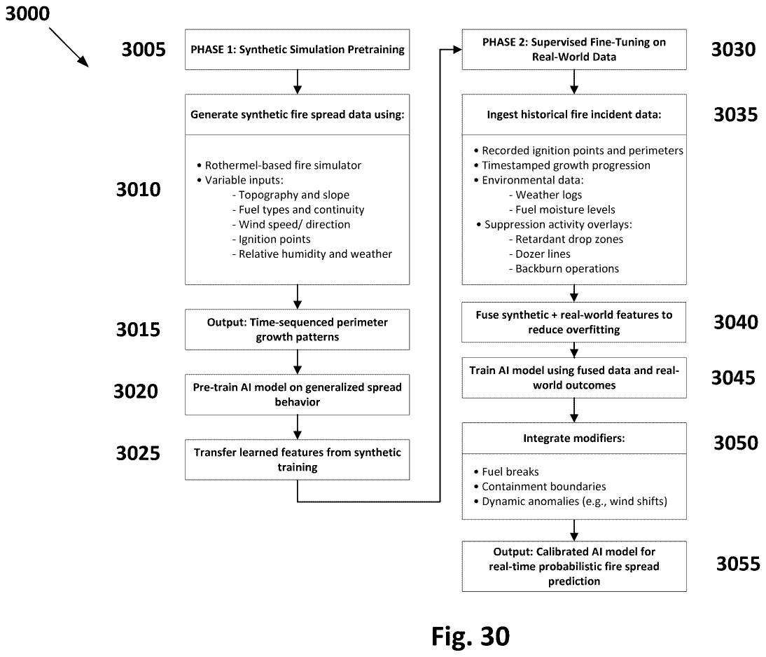

In one embodiment, the two-phase training process illustrated in FIG. 30 depicts how the AI fire propagation model is developed using both simulated and real-world data. In Phase 1 3005, a physics-based simulator generates synthetic fire spread scenarios 3010 using variable inputs such as topography, slope, fuel continuity, wind speed and direction, ignition points, and weather conditions. These simulations produce time-sequenced perimeter growth patterns 3015, which are used to pre-train the model on generalized fire spread behavior 3020. The learned features from synthetic training are then transferred 3025 into Phase 2, where the model is fine-tuned on historical fire incident data 3035. This includes ignition points, timestamped perimeters, environmental observations, and overlays of suppression activity. Synthetic and real-world features are fused to improve generalization and reduce overfitting 3040, after which the model is trained on actual fire outcomes and operational context 3045. Additional inputs such as fuel breaks, containment lines, and dynamic anomalies like wind shifts are incorporated 3050 to adjust predictions. The final product 3055 is a calibrated AI model capable of producing real-time, probabilistic fire spread forecasts that reflect both physical fire dynamics and operational realities.

The artificial intelligence detailed herein provides numerous systems with functionality intended to improve efficiency and accuracy. With respect to satellite data (SAR and Hyperspectral), AI and ML provides spatial information relative to terrain and vegetation which is then processed through a Convolution/ViT Encoder to extract spatial features. With respect to environmental data (e.g., wind, humidity, temperature, etc.), AI and ML captures atmospheric conditions impacting fire behavior which is processed through a Convolution/ViT Encoder for feature extraction. With respect to camera imagery, AI and ML supplies real-time visual data of fire activity and provides environmental data (e.g., fuel greenness) which is encoded via a Convolution/ViT Encoder to derive visual patterns. With respect to aircraft tracking, AI and ML track aircraft movement using ADS-B data near fire zones for dynamic response mapping of possible fire suppression efforts which is encoded using a Transformer-based Trajectory Encoder to incorporate spatial-temporal insights. With respect to tabular/contextual data (e.g., forum posts, radio transcriptions, etc.), AI and ML integrates non-spatial, textual data related to fire activity, resource allocation, and suppression efforts which is encoded through a pre-trained BERT Encoder for semantic understanding.

In one embodiment, the encoded features are combined using a fusion block that integrates spatial, temporal, and contextual data into a unified representation. This fused output may be refined using transformer and convolutional layers to capture relationships across modalities. A convolutional decoder may reconstruct spatial predictions, optionally using skip connections to preserve resolution and accuracy. The model may produce a multi-channel output that indicates where and when individual cells are expected to become active during fire progression. In some implementations, temporal behavior is learned from simulated datasets using a Generative Adversarial Network (GAN). A GAN comprises a generator model that produces synthetic outputs and a discriminator model that evaluates those outputs for realism. The discriminator may learn time-based patterns and provide feedback during training, ensuring the generator captures realistic temporal evolution while still conforming to real fire perimeters or spread behavior.

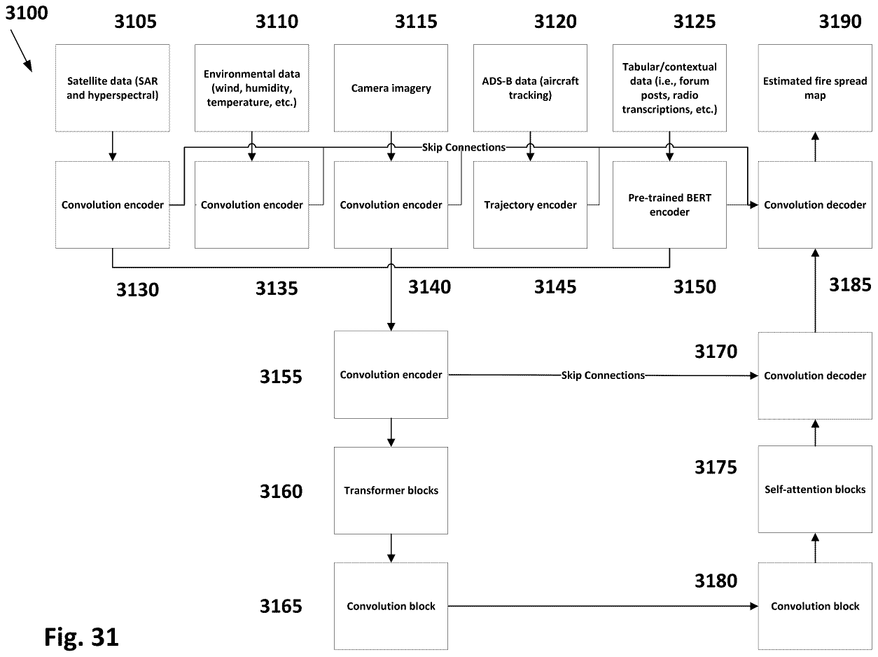

Referring to FIG. 31, a block diagram 3100 illustrates how artificial intelligence and machine learning components are integrated to generate a predictive fire spread map according to embodiments of the present invention. Satellite data 3105 (e.g., SAR and hyperspectral), environmental data 3110 (e.g., wind, humidity, temperature), camera imagery 3115, aircraft tracking data 3120 ADS-B, and tabular/contextual data 3125 (e.g., forum posts, radio transcriptions) are each processed through dedicated encoders. These include convolution encoders 3130, 3135, and 3140 for the satellite, environmental, and imagery inputs respectively; a trajectory encoder 3145 for ADS-B data; and a pre-trained BERT encoder 3150 for contextual text. The encoded outputs are fused and passed to an additional convolution encoder 3155, followed by transformer blocks 3160 and a convolution block 3165. The fused representation is decoded via convolution decoders 3170 and 3175, incorporating skip connections and self-attention layers. The resulting output is an estimated fire spread map 3180, which reflects the model's spatial-temporal forecast of fire progression.

### Fuel Moisture Content Mapping

In one embodiment, and as an extension of the predictive modeling architecture shown in FIG. 31, the system dynamically generates and integrates updated Fuel Moisture Content (FMC) maps as a primary input to the fire spread simulation engine. FMC baselines are derived using multispectral satellite imagery, including near-infrared (NIR) and shortwave infrared (SWIR) bands. While Sentinel-2 is commonly used, the system is compatible with other orbital platforms and third-party datasets that provide suitable spectral resolution. The system computes NDVI and NDII vegetation indices and applies a custom Vapor Pressure Deficit Stress Index (VPDsi) to adjust those indices in real time based on localized atmospheric drying and terrain relief. This flexible architecture supports the integration of evolving data sources and enables near real-time FMC updates, which directly influence ignition probability, spread behavior, and suppression modeling. The result is a more accurate and terrain-aware prediction of fire behavior across diverse fuel environments.

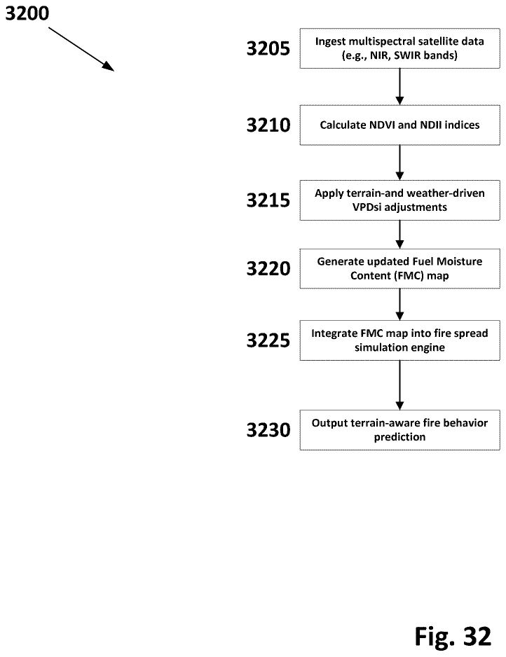

In one embodiment as illustrated in FIG. 32, the system dynamically generates and integrates updated Fuel Moisture Content maps as a core input to the fire behavior simulation engine. The process begins by ingesting multispectral satellite imagery from compatible platforms, extracting vegetation indices such as NDVI and NDII, and applying a custom Vapor Pressure Deficit Stress Index to account for localized drying and terrain variation steps 3205-3215. These inputs are used to produce a current Fuel Moisture Content map 3220, which is then integrated into the fire spread simulation engine 3225 to drive ignition modeling, rate of spread, and suppression dynamics. The result is a terrain-aware prediction of fire behavior across diverse environments 3230.

### Multispectral Satellite Data Integration for Fuel and Terrain Characterization

In one embodiment, the fire spread model integrates FMC outputs with topographic and weather datasets to assess environmental conditions and generate predictive fire behavior maps. Fuel moisture values derived from satellite-based FMC mapping are combined with terrain slope, aspect, and vegetation classification to estimate fire ignition potential and spread dynamics across the landscape. Live or forecasted weather layers, including wind, humidity, and temperature, are incorporated to further refine simulations. Model outputs may include raster-based maps showing projected spread speed or high-risk zones, which may be visualized through the dashboard to support mitigation planning, response staging, and operational prioritization.

### Fire Potential Rate of Spread Map Layer

In an embodiment of the present invention, the C&C system includes an advanced Rate of Spread (ROS) modeling tool that integrates terrain data, real-time and historical weather data, fuel classifications, FMC maps, and other third-party data sources to deliver accurate wildfire spread predictions. The ROS model uses artificial intelligence to interpret fuel moisture variability across the landscape, applying learned relationships between environmental conditions and fire behavior to forecast the speed and direction of fire spread under different scenarios. Model outputs may include spread probability maps, directional growth vectors, and estimated impact timelines that help users assess risk and prioritize response. The system displays these outputs on an interactive map using color-coded layers to indicate varying levels of projected fire severity across the region, based on both live and forecasted data inputs. This visualization supports operational planning, mitigation efforts, and situational awareness during emerging wildfire events.

### Fire Consequence Engine

In one embodiment, the C&C system includes a consequence analysis engine that evaluates projected fire spread outputs against geospatial datasets to determine potential impacts. As the fire propagation model simulates future burn perimeters, the engine intersects these outputs with infrastructure, population, and asset layers to calculate exposure and consequence metrics. Relevant datasets may include utility infrastructure such as substations, poles, transmission and distribution lines, and customer meters; public safety elements such as evacuation routes, hospitals, communication towers, and schools; and population layers such as census blocks or vulnerable community overlays. For each intersecting feature, the system may apply rule-based or weighted scoring logic to estimate operational and human consequences. Financial impact may be calculated using third-party valuation sources such as Zillow, Redfin, or assessor parcel data, along with estimated asset replacement costs and projected lost revenue. Human impact scoring may include population exposure, potential fatalities, evacuation complexity, or disruption of essential services. The resulting consequence outputs may include total assets impacted, people at risk, time to impact, and estimated financial loss, and may be used to inform alert escalation, dashboard visualization, or operational prioritization workflows.

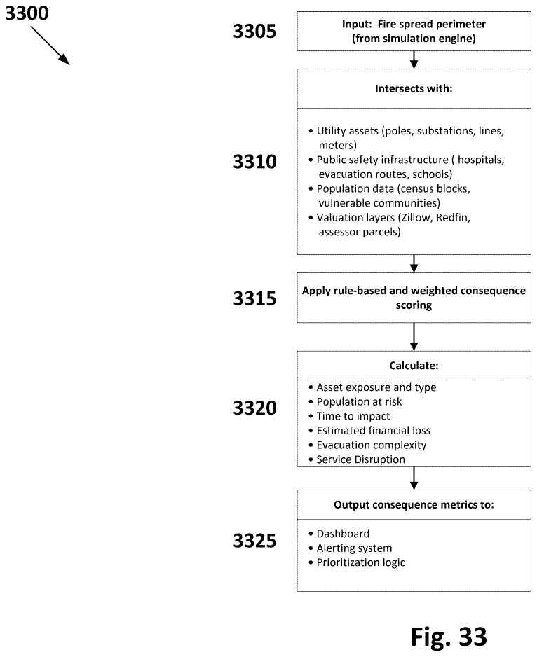

In one embodiment, the system includes a consequence analysis engine as shown in FIG. 33. As fire perimeters are produced by the simulation engine 3305, the system intersects the predicted burn area with infrastructure, population, and asset datasets 3310 to evaluate exposure. These datasets may include utility assets, public safety infrastructure, census-based population overlays, and parcel-level valuation layers. Once intersected, the system applies rule-based or weighted consequence scoring 3315 to estimate impacts such as asset exposure, population at risk, time to impact, estimated financial loss, evacuation complexity, and potential disruption of essential services 3320. The resulting metrics are then transmitted to the system dashboard, alerting interface, and prioritization workflows 3325, enabling risk-informed operational response.

### Wildfire Detection Alert Configuration Tool

In one embodiment of the present invention, the C&C system includes a configurable alerting tool that allows users to tailor notifications based on operational needs and risk tolerance. Users may suppress alerts for events that are already known, such as active IRWIN incidents, prescribed burns, or scheduled pile burn operations. The system also supports filtering based on modeled risk indicators, including predicted spread rate, suppression probability, and estimated consequences such as projected acres burned, structures impacted, or financial loss. Home value data may be incorporated from third-party sources such as Zillow, Redfin, parcel data, or assessor records. Alerts may additionally be filtered based on proximity to or projected impact on designated assets of interest, including utility infrastructure such as meters, substations, poles, and transmission lines, as well as critical sites such as telecommunications towers, emergency service facilities, schools, hospitals, or egress routes. The system can estimate the number of people, economic value, or operational significance associated with each asset to support priority-based alert delivery. This alert configuration framework improves situational awareness while reducing unnecessary distractions by aligning notifications with each organization's operational priorities.

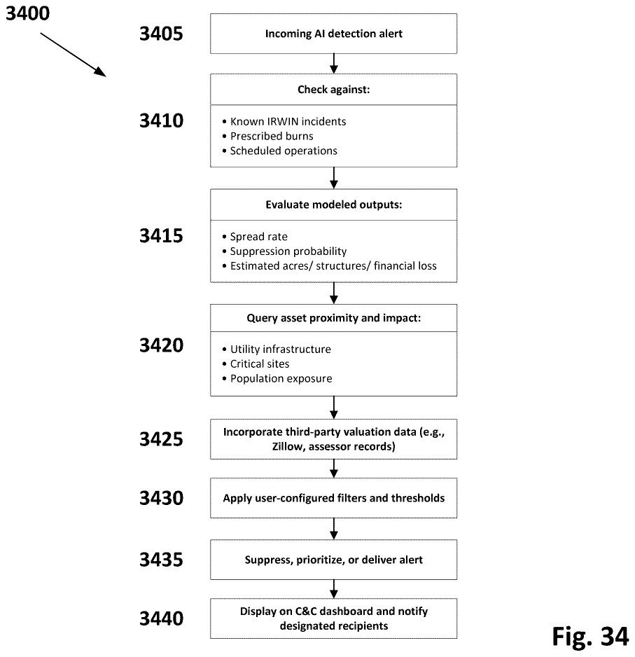

In one embodiment, the system includes a wildfire detection alert configuration tool as illustrated in FIG. 34. Upon receiving an AI-generated detection alert 3405, the system cross-references the event with known IRWIN incidents, prescribed burns, or scheduled field operations 3410. It then evaluates the modeled risk attributes including predicted spread rate, suppression probability, and estimated impact in terms of acreage, structures, and financial loss 3415. To assess operational consequence, the system queries the proximity of the detected event to key assets including utility infrastructure, critical sites, and exposed populations 3420, and incorporates third-party valuation data such as Zillow or assessor records 3425. Alerts are then filtered using user-configured thresholds 3430 and either suppressed, prioritized, or forwarded for delivery 3435. Final notifications are displayed within the C&C dashboard interface and distributed to designated recipients 3440, ensuring that alert delivery aligns with operational significance and risk tolerance.

### Fire Propagation Models in AI Detection Alerts

In an embodiment of the present invention, each time an AI-based fire detection alert is triggered, the C&C system automatically generates and attaches a fire propagation simulation from the system's modeling engine alongside the alert. Simulation outputs may include predicted burn area, directional spread, and estimated time of arrival for critical infrastructure or population centers. These outputs are packaged with the alert payload and may be encoded as structured geospatial layers for consumption by dashboards, downstream systems, or third-party interfaces. Formats may include raster overlays, vector perimeters, or compact binary tile sets depending on the target application. The data may be rendered directly within the alert interface, enabling visualization of projected fire growth over time using a time slider or stepped animation. Model metadata such as run timestamp, forecast horizon, and scenario ID may also be included to support versioning and traceability.

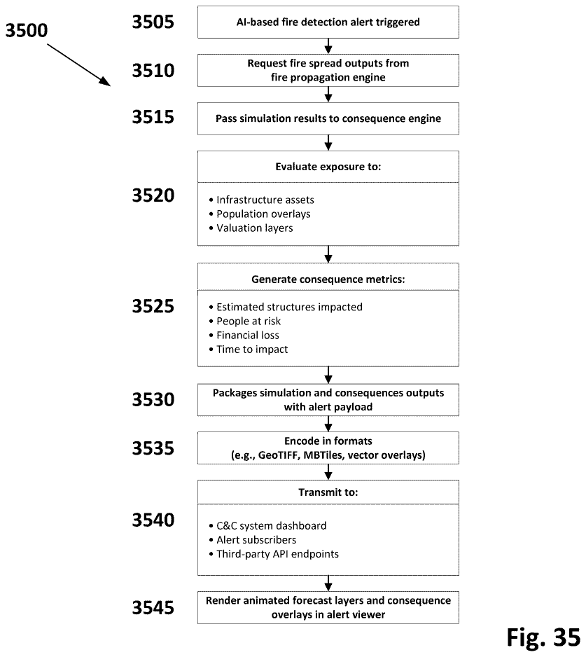

In one embodiment, as shown in FIG. 35, the system initiates a fire propagation modeling workflow each time an AI-based fire detection alert is triggered 3505. Upon alert, the C&C system requests predictive outputs from the fire spread simulation engine 3510 and passes the results to the consequence engine for downstream evaluation 3515. Exposure is then assessed across infrastructure assets, population overlays, and valuation datasets 3520, generating consequence metrics such as estimated structures impacted, number of people at risk, projected financial loss, and time to impact 3525. These simulation and consequence outputs are bundled with the alert payload 3530, encoded in geospatial formats such as GeoTIFF, MBTiles, or vector overlays 3535, and transmitted to relevant destinations including the C&C dashboard, subscriber endpoints, and third-party APIs 3540. The outputs are rendered as animated forecast layers and consequence overlays within the alert viewer to support decision-making 3545.

### User-Defined Rate of Spread Alerts

Users, including utilities and emergency responders, may configure customized alert thresholds to receive notifications when the AI-calculated rate of spread exceeds defined levels. These thresholds may be based on a variety of modeled outputs, such as simulated acres burned within the first 30, 60, or 90 minutes; the projected number of structures impacted within a defined time window; estimated smoke column height in feet or meters; or the fire's expected proximity to critical infrastructure or high-risk assets. This configurability allows users to focus on incidents with the greatest potential for rapid escalation or operational impact. The system may evaluate each fire's projected consequences and recommend the type and quantity of resources to deploy accordingly. When multiple fires are active, the system may rank them based on severity, exposure, and time-sensitive impact metrics, such as earliest expected asset impact or population exposure, to support prioritization of field resources and command attention.

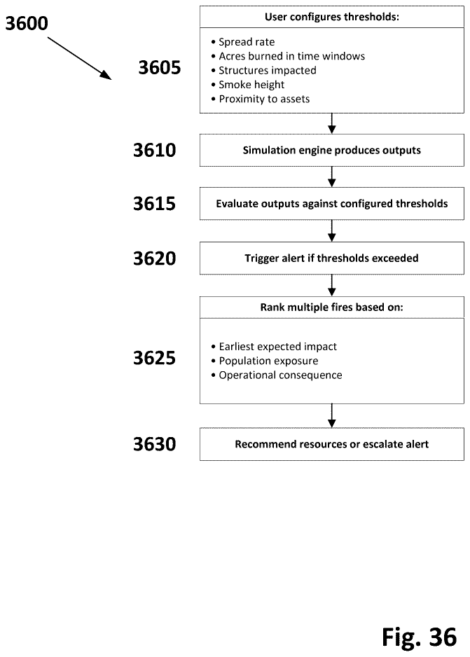

As shown in FIG. 36, the system allows users to configure custom alert thresholds based on model-derived parameters such as spread rate, acreage burned within specific time windows, projected structures impacted, smoke height, and proximity to critical assets 3605. Once an AI-based simulation is executed 3610, the system evaluates the outputs against the configured thresholds 3615. If any threshold is exceeded, an alert is triggered 3620. When multiple fires are detected, the system may rank them according to operational significance, including earliest expected impact, population exposure, and overall consequence 3625. Based on these rankings, the system can recommend escalation actions or resource deployments to support situational awareness and operational decision-making 3630.

### Multi-Source Fire Detection Alert Ingestion

In one embodiment, the C&C system supports ingestion of third-party fire detection alerts from a wide range of sources beyond its core AI camera network. These may include ground-based sensors, aerial reconnaissance platforms, satellite fire detection systems, lightning alert networks, weather intelligence feeds, utility fault monitoring platforms, and public alerting services. Alerts may originate from gas-based smoke sensors, chemical or particulate detectors, distributed thermal or heat-sensing networks, or lightning detection systems. Satellite-based detection systems may provide hotspot or thermal anomaly data through remote sensing platforms that support orbital imaging and atmospheric monitoring. Aerial fire reconnaissance assets may contribute perimeter traces, infrared imagery, or incident reports gathered from fixed-wing aircraft or drones. The system may also ingest alerts derived from electrical infrastructure monitoring tools that detect arcing, high-impedance faults, equipment failures, or other pre-fire anomalies. Additional sources may include weather-driven alert feeds based on high winds, low humidity, or vapor pressure deficit thresholds, as well as crowd-sourced fire reports from mobile applications, web submissions, or social platforms processed through natural language models.

All such alerts may be ingested through structured interfaces, including REST APIs, secure FTP, webhook callbacks, cloud-based data exchanges, or authenticated system-to-system integrations. Once received, third-party alerts are plotted geospatially within the C&C interface using distinct visual indicators that reflect detection type and source attributes. Metadata associated with each alert may include timestamp, confidence score, detection class, and geolocation coordinates. In response, the system may initiate one or more automated workflows. These may include directing nearby cameras to pan, tilt, or zoom toward the alert location; capturing high-resolution imagery for follow-up AI analysis; launching fire propagation simulations anchored to the reported coordinates; creating an incident record in the system; sending alerts to selected user groups; or generating a prioritized incident card for operator triage. The system may evaluate terrain visibility, camera orientation, and viewshed availability to select the optimal camera or group of cameras to task, while also providing manual override options for user-directed control. These workflows enable the system to incorporate non-visual detections into its operational stack for early confirmation, enhanced modeling, and proactive response coordination across all integrated sensor domains.

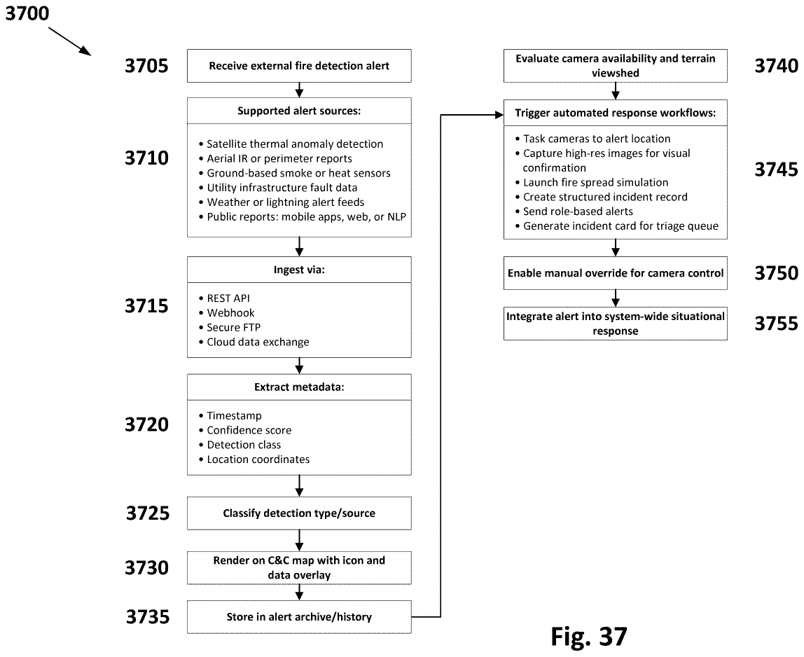

In one embodiment, as shown in FIG. 37, the system supports multi-source fire detection alert ingestion and response coordination. At step 3705, the system receives an external fire alert. Supported sources at 3710 include satellite thermal anomaly detection, aerial infrared or perimeter reports, ground-based smoke or heat sensors, utility fault data, weather or lightning alert feeds, and public reports submitted via mobile apps, web, or natural language processing tools. In step 3715, the system ingests data via REST API, webhook, secure FTP, or cloud exchange. At step 3720, it extracts metadata such as timestamp, confidence score, detection class, and coordinates. The system classifies the detection source at 3725 and renders it on the command and control map with icon and data overlay at 3730. It stores the alert in system history at 3735. The system then evaluates camera availability and terrain viewshed at 3740 and, at 3745, may trigger automated workflows such as tasking cameras, capturing imagery, launching fire spread simulations, creating incident records, sending role-specific alerts, or generating triage cards. Manual camera override is enabled at 3750, and full situational integration is completed at 3755.

### Resource Deployment Recommendation Engine

In one embodiment, the system includes a recommendation engine that analyzes forecasted fire spread and environmental variables to suggest optimal deployment locations for suppression resources. Based on the predicted fire growth vectors, intensity, and terrain accessibility, the system may identify tactical zones for aerial drops, hand crew deployment, engine access, water tender positioning, and dozer line construction. The engine may incorporate suppression effectiveness models, real-time resource availability from internal or 3^{rd} party systems via API, and dynamic prioritization to direct the right asset types to the most critical intervention points. These recommendations may be visualized as map-based overlays showing proposed routes, staging areas, and drop zones, and may update continuously as conditions evolve. This feature supports operational planning during active incidents and resource staging during high-risk conditions by maximizing suppression efficiency across limited firefighting assets.

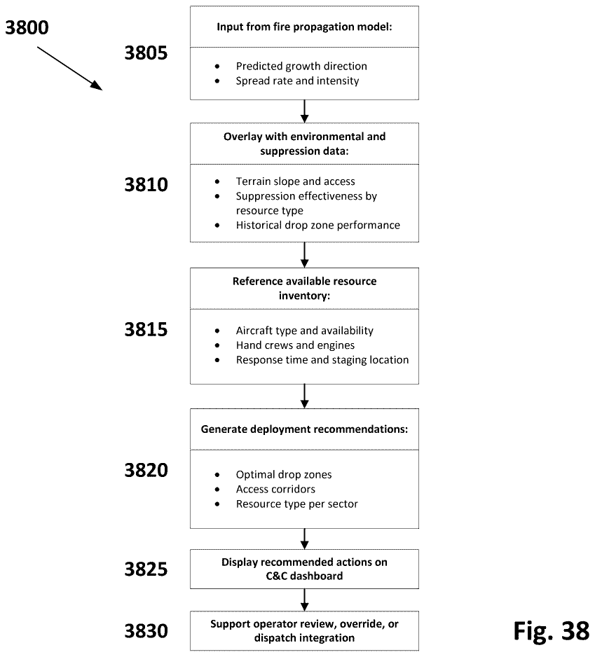

In one embodiment, as shown in FIG. 38, the system includes a resource deployment recommendation engine. At step 3805, the engine receives inputs from the fire propagation model, including predicted growth direction and spread intensity. Step 3810 overlays these forecasts with environmental and suppression performance data such as terrain slope, access constraints, resource effectiveness, and historical drop zone success. At step 3815, the system references the current resource inventory, including aircraft availability, hand crews, engines, and their staging locations or response times. Step 3820 uses these inputs to generate deployment recommendations, such as optimal drop zones, corridor access paths, and resource types for each fire sector. At step 3825, the recommendations are displayed on the C&C dashboard, and step 3830 allows operators to review, override, or integrate the suggestions into dispatch systems.

### Suppression Planning And Fire Behavior Impact Tool

In one embodiment, the system includes an interactive planning module that enables users to simulate the impact of proposed suppression activities on projected fire behavior. Users may draw anticipated containment lines, aerial retardant drop zones, dozer cuts, or defensible perimeters directly onto the map interface. These proposed interventions are ingested by the fire spread simulation engine, which recalculates the projected burn perimeter and associated consequences based on modified terrain, fuel, and suppression conditions. In addition to manual inputs, the system may automatically identify nearby preexisting features—such as previously constructed fuel breaks, burn scars from past fires, natural fire barriers, or areas of recent prescribed fire—that could serve as effective containment edges. The system may also locate accessible water sources, such as lakes, reservoirs, or dip tanks, to support helicopter bucket operations or aerial water drops. These elements may be visually identified within the interface and incorporated into the simulation to assess their value in helping corral or redirect fire movement. The updated simulation outputs include revised estimates of acres burned, infrastructure exposure, population impact, and financial loss, allowing decision-makers to compare the effectiveness of different suppression strategies before field execution. Outputs may be visualized, saved, shared, or exported for inclusion in planning briefs, coordination tools, or regulatory documentation.

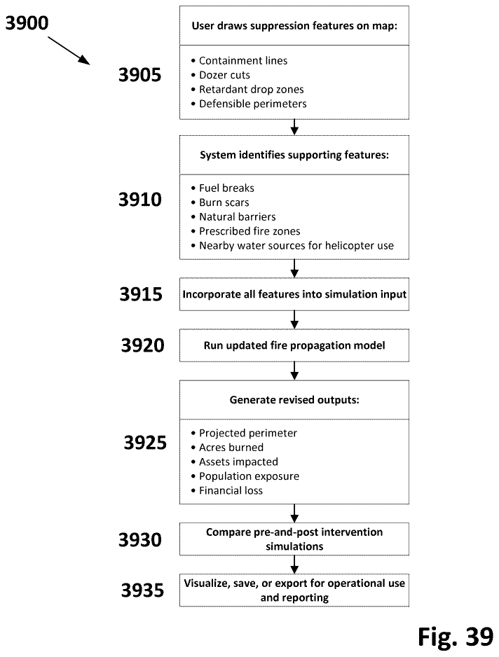

In one embodiment, the system includes a suppression planning tool that enables users to simulate the impact of proposed interventions on forecasted fire behavior. As shown in FIG. 39, users may draw features such as containment lines, dozer cuts, retardant drop zones, and defensible perimeters directly onto the map interface 3905. The system can also identify supporting features including fuel breaks, burn scars, natural barriers, prescribed fire zones, and accessible water sources for aerial suppression 3910. These manually drawn and automatically identified elements are incorporated into the fire simulation input 3915, and the updated fire propagation model is executed 3920. The resulting outputs include revised estimates of projected perimeter, acres burned, assets impacted, population exposure, and financial loss 3925. The system may display comparative scenarios of pre-and post-intervention simulations 3930 and provide options to visualize, save, or export the outputs for operational planning and coordination 3935.

### Strategic Resource Predeployment Recommendations

In one embodiment, the system generates recommended predeployment strategies for firefighting resources based on forecasted fire risk, derived from the AI-driven fire propagation modeling and consequence analysis engine. When the model identifies elevated risk zones due to forecasted weather, fuel conditions, terrain alignment, ignition likelihood, or infrastructure exposure, the system may generate suggested staging locations for key firefighting resources. These recommendations may include aircraft base positioning, hand crew mobilization points, equipment staging yards for dozers and engines, and water tender refill zones. The system factors in logistical constraints such as road access, water availability, travel time to projected ignition zones, and potential fire spread speed. Recommendations may be visualized on the map interface with time-based deployment windows and may include multiple prepositioning options based on evolving conditions.

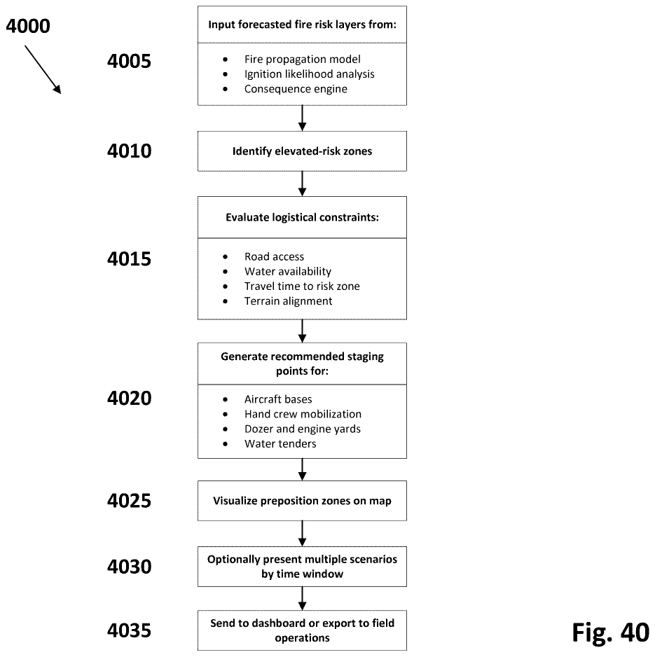

In one embodiment, the system generates strategic predeployment recommendations for firefighting resources based on forecasted fire risk layers, as shown in FIG. 40. These layers may originate from fire propagation modeling, ignition likelihood analysis, and consequence scoring 4005. The system identifies elevated-risk zones 4010 and evaluates logistical constraints such as road access, water availability, terrain alignment, and travel time to at-risk areas 4015. Based on this information, the system recommends optimal staging points for aircraft, hand crews, dozer and engine teams, and water tenders 4020. These recommended zones may be visualized on the map interface 4025, optionally presented across multiple time windows 4030, and exported to dashboards or field operations for rapid deployment coordination 4035.

### Automated Predeployment Dashboard and Resource Tiering

In one embodiment, the system includes a predeployment dashboard that continuously surfaces high-risk geographic zones based on forward-looking fire risk forecasts. The dashboard displays model outputs including ignition likelihood, projected burn area, and time-to-impact windows, layered over infrastructure maps and known suppression coverage. A prioritization engine ranks at-risk areas by consequence severity, exposure gaps, or asset density. The dashboard supports automated field notifications and role-based alert routing, recommending resource types and staging locations for each identified zone. The system applies tiered allocation logic: zones with moderate forecasted risk may be assigned reconnaissance drones, patrols, or quick-attack modules, while zones flagged as high risk may prompt full team staging with rotary and fixed-wing air support, hand crews, and ground equipment. In some embodiments, users may adjust tier logic parameters, define manual overrides, or integrate custom resource availability constraints. The dashboard may refresh on a rolling basis using new model outputs, and may incorporate historical suppression outcomes to inform future staging strategies.

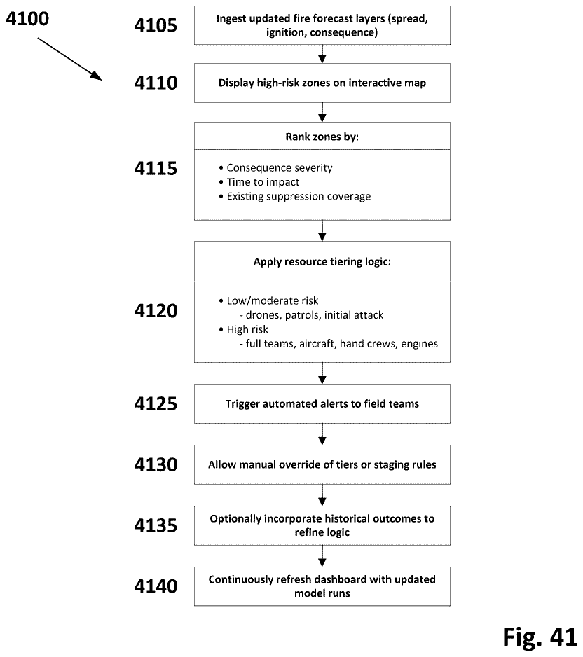

In one embodiment, the system includes a predeployment dashboard illustrated in FIG. 41. The dashboard ingests updated fire forecast layers including spread, ignition, and consequence inputs 4105 and displays high-risk zones on an interactive map 4110. These zones are ranked by consequence severity, time to impact, and suppression coverage 4115, and the system applies resource tiering logic 4120. Zones with low or moderate risk may be assigned drones, patrols, or initial attack units, while high-risk zones may prompt recommendations for full teams, aircraft, hand crews, and engines. The system triggers automated alerts to appropriate field teams 4125, and users can override tiering logic or staging rules as needed 4130. The system may optionally incorporate historical suppression outcomes to refine future tiering 4135, and the dashboard continuously refreshes with new model outputs 4140.

### Threat Based Alert Escalation Engine

In one embodiment, the system includes an alert escalation module that dynamically prioritizes alert delivery based on real-time fire risk outputs and incident attributes. The engine evaluates factors such as projected fire growth rate, modeled consequence severity, time to impact, and infrastructure exposure to determine urgency tiers for each alert. Each tier corresponds to configurable delivery pathways, including SMS, email, push notification, desktop interrupt, or automated voice call. Alert routing may be filtered by recipient role, region, or escalation path, and may be adjusted according to organizational policies or operating periods (e.g., business hours, after-hours duty rosters). The escalation engine may also throttle or suppress lower-tier notifications if a higher-severity incident occurs in the same region, thereby reducing information overload and preventing alert fatigue. Each alert record may be tagged with a severity score, escalation history, and delivery confirmation metadata to support audit trails, user feedback loops, and performance tuning of alert thresholds over time.

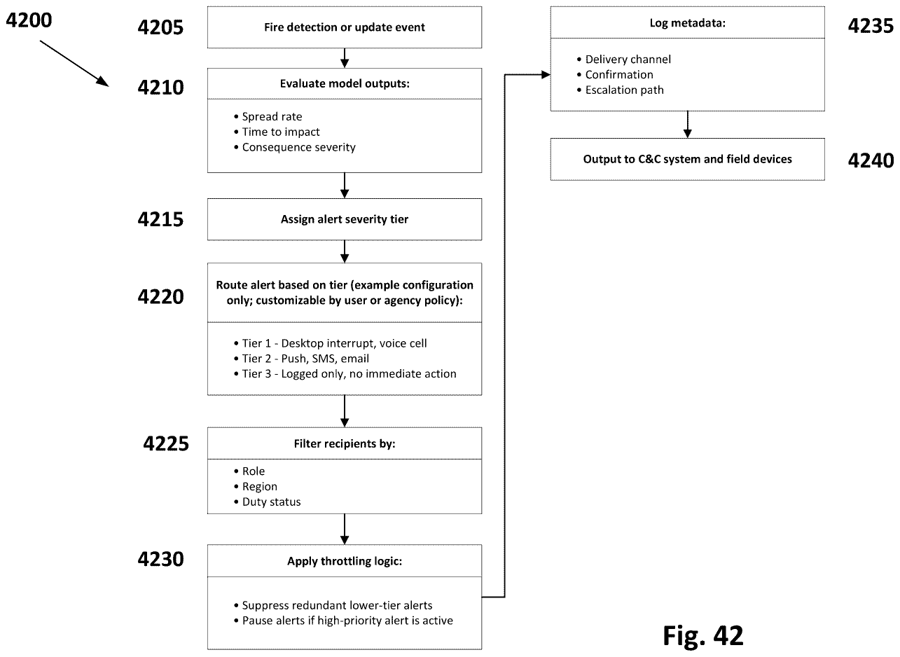

Referring now to FIG. 42, the alert escalation engine receives AI fire detection data at 4205 and evaluates projected growth rate, consequence severity, infrastructure exposure, and time to impact at 4210. Based on this analysis, alerts are assigned an urgency tier at 4215. Tier-based routing logic at 4220 selects delivery channels such as SMS, email, push notification, desktop interrupt, or voice call. At 4225, recipient filtering is applied based on role, geographic scope, or escalation policy. If a higher-severity incident is active in the same region, the system suppresses or defers lower-tier notifications at 4230. Alert records are tagged with severity scores, escalation paths, and delivery confirmations at 4235, and alerts are dispatched to field systems or operators at 4240.

### Dynamic Fire Propagation Modeling Tool

In one embodiment of the present invention, the C&C system includes an interactive fire propagation modeling tool that allows users to simulate wildfire spread and evaluate projected impacts directly from a map-based interface. Simulations may be initiated by clicking a location on the map, entering GPS coordinates, or specifying a custom ignition point. Users may configure environmental conditions by selecting from dropdown menus containing historical, live, or forecasted weather and fuel profiles for specific dates and times. Alternatively, users may input custom environmental variables or select from predefined scenarios such as 97th percentile fire weather conditions. Once configured, the tool launches a localized fire simulation using the system's AI-based fire propagation model defined elsewhere in this specification. The simulation returns projected fire growth and consequence outputs, including anticipated burn perimeters, acres burned, structures impacted, infrastructure exposure, and utility asset loss. For utility applications, the tool may estimate rebuilding costs based on infrastructure age, type, and location. Simulation results are rendered through animated fire spread overlays and tabular summaries within the interface, enabling real-time planning, consequence analysis, and scenario evaluation across both hypothetical and operational contexts.

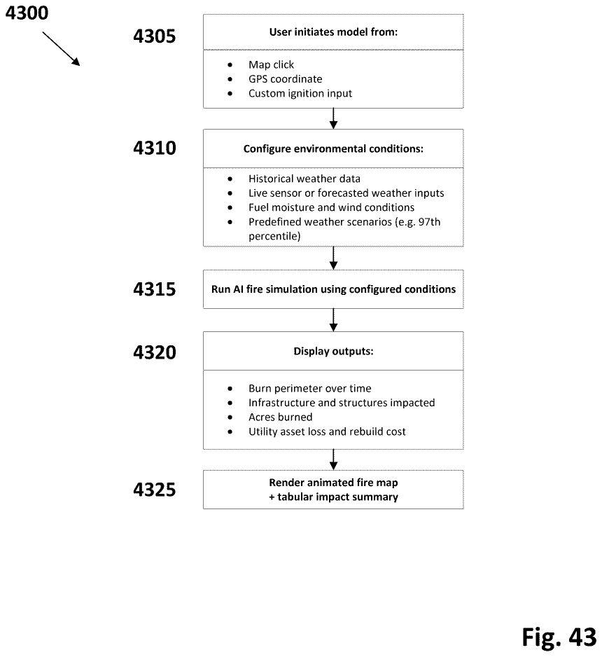

Now referring to FIG. 43, block 4305 allows a user to initiate a simulation using a map click, GPS coordinate, or custom ignition input. In block 4310, the user configures environmental conditions, including historical weather data, live or forecasted sensor inputs, fuel moisture, and wind conditions, or selects from predefined scenarios such as 97th percentile fire weather. The AI propagation model runs using these inputs in block 4315. Block 4320 displays simulation outputs, including projected burn perimeter, acres burned, infrastructure and structures impacted, and utility asset loss and rebuild cost. Block 4325 renders the results as an animated fire map and a tabular impact summary for decision-making and planning.

### Bulk Fire Propagation Simulation Engine

In one embodiment, the system includes a backend simulation engine designed for scalable modeling of wildfire spread from defined ignition points. This engine supports infrastructure exposure analysis, PSPS scenario planning, and regional wildfire risk assessment by executing large volumes of fire spread simulations across diverse environmental conditions. Ignition points may be manually defined by users, imported from historical incident datasets, or submitted via an external API. The API supports batch ingestion of ignition coordinates and may optionally associate each ignition with one or more asset IDs or Locations of Interest to streamline consequence analysis. For each input, the engine initializes the AI-based fire propagation model using terrain elevation, surface fuel classification, vegetation type, fuel moisture, and weather data derived from historical or forecasted profiles. Simulation outputs include directional spread vectors, probabilistic burn zones, time-to-impact estimates, and asset-specific consequence metrics. The engine may operate in batch mode or be invoked through real-time API calls, and supports logging, version control, and comparison of multiple runs. This infrastructure enables automated, high-throughput modeling of fire exposure to support utility mitigation planning, regulatory reporting, and operational preparedness across thousands or millions of potential ignition scenarios.

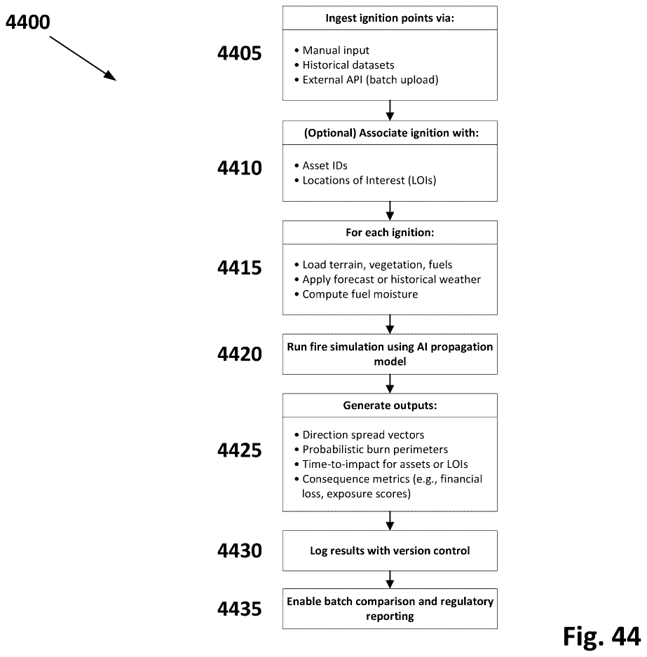

Now referring to FIG. 44, block 4405 illustrates ingestion of ignition points via manual input, historical datasets, or external APIs. Block 4410 optionally associates each ignition with asset identifiers or locations of interest to support consequence evaluation. Block 4415 processes each ignition point by loading relevant terrain, vegetation, and fuel data, applying weather conditions, and computing fuel moisture. In block 4420, the AI-based fire propagation model runs simulations based on those inputs. Block 4425 shows generation of outputs including spread vectors, probabilistic burn perimeters, time-to-impact estimates, and consequence scores. Blocks 4430 and 4435 support version-controlled logging of results and batch comparison across simulation runs for regulatory analysis and operational planning.

### Fire Propagation and Consequence Modeling Dashboard

In one embodiment, the system includes an interactive dashboard for visualizing wildfire spread simulations and consequence outputs across multiple scenarios. The dashboard may be embedded within the C&C interface or accessed as a standalone application. It may be automatically triggered by AI-based or user-confirmed detections, or manually launched for historical analysis, custom modeling, or forward-looking planning use cases. The dashboard displays outputs from the Fire Consequence Engine, including projected fire perimeters over time, estimated acres burned, infrastructure and asset exposure, population at risk, and financial loss estimates. Users may view results for different ignition points, environmental conditions, or time windows, with the ability to select predefined templates or load saved custom scenarios. For bulk asset simulation outputs, users may configure visual display settings such as icon size, shape, color, and radius to reflect key input or output variables including wind speed, wind direction, humidity, fuel moisture content (FMC), acres burned, structures impacted, or projected financial impact. Time-specific risk summaries may be generated for particular assets or regions, enabling targeted assessment under evolving fire conditions. Outputs may be visualized through dynamic map overlays, time sliders, and filterable tables by asset type, risk tier, region, or forecast window. Scenarios can be saved, versioned, duplicated, or exported in formats such as images, spreadsheets, or shareable links. The dashboard supports both real-time and planning workflows and is designed to facilitate consequence visualization, response prioritization, and communication of fire-related risk across agencies and operational teams.

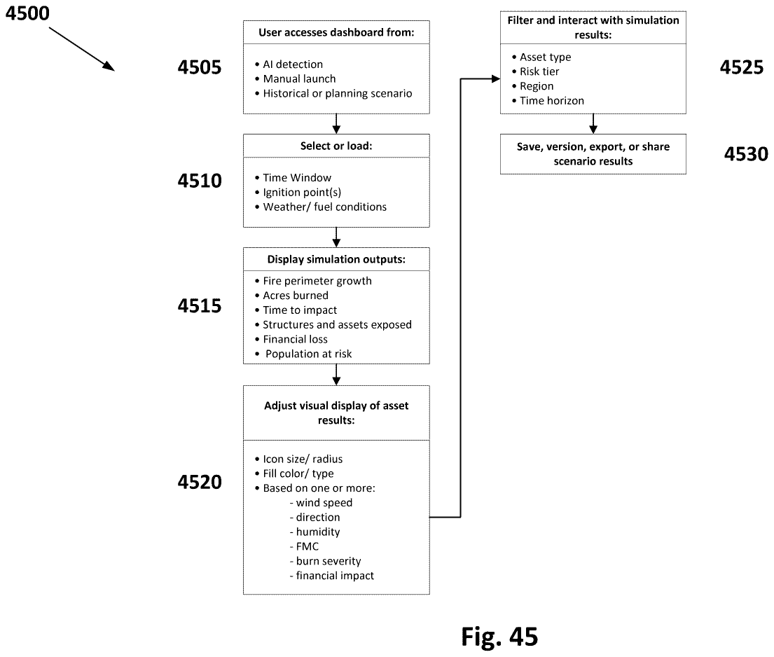

Now referring to FIG. 45, an embodiment of the wildfire modeling dashboard is shown. Users may access the dashboard from AI-triggered alerts, manual launches, or scenario planning workflows 4505. They may configure ignition inputs, environmental conditions, and time windows 4510, and then view simulation outputs such as fire growth, infrastructure and population exposure, and financial loss 4515. Visual attributes of assets may be styled based on impact metrics 4520. Users can further interact with simulation results by filtering based on asset type, region, or time horizon 4525, and may save or export scenario data for reporting or coordination use 4530.

### Temporal Visualization Controls for Propagation Simulations

In one embodiment, the fire propagation dashboard includes a temporal visualization module that renders simulation outputs across defined time steps using a programmable slider interface. This module synchronizes spatial fire progression layers with a timeline scrubber, enabling users to navigate bidirectionally across discrete forecast intervals (e.g., 15-minute, 30-minute, or 1-hour steps). Each time step corresponds to a computed perimeter state generated by the underlying propagation engine, and may include associated exposure layers such as impacted structures, critical infrastructure, and cumulative burn area. The interface supports configurable playback settings including speed control, interval resolution, and looping behavior. System-generated event markers (e.g., ignition timestamp, first asset contact, containment breach) may be embedded in the timeline to provide jump-to navigation. Time-indexed state transitions are rendered on the map interface via progressive layer transitions or animated perimeter outlines. The temporal control module integrates downstream alerting and reporting workflows, enabling users to extract consequence estimates at arbitrary simulation timestamps for further analysis or export.

### High-Frequency Model Outputs

In one embodiment, the system supports sub-minute output intervals for fire propagation and consequence modeling layers under select operating conditions. This capability is enabled by adaptive scheduling of the underlying simulation engine, which executes incremental time-step calculations for fire perimeter growth, asset exposure, and environmental progression at one-minute or finer granularity. The engine may ingest dynamic fuel moisture, forecasted wind vectors, and terrain-resolved fire spread coefficients to produce rolling updates for modeled outputs. These outputs may include rasterized fire arrival grids, per-asset impact timelines, and predicted values for affected structures, population, or financial loss. The high-frequency mode may be triggered automatically when forecast parameters exceed predefined thresholds (e.g., red flag criteria), or may be configured manually by authorized users. Outputs are versioned and time-stamped, allowing integration with streaming dashboards, alerting engines, or third-party response coordination systems.

### Time-Constrained Operational Response Planning

In one embodiment, the C&C system may compute operational time windows for completing predefined mitigation or response objectives based on the projected advance of the fire perimeter. For each user-defined feature such as a proposed dozer line segment, structure protection zone, or evacuation area, the system calculates estimated time-to-impact using dynamic spread models that account for topography, wind vectors, fuel moisture, and ignition growth rate. The system may incorporate linear feature geometry, suppression construction rates, and optional buffer time assumptions to determine whether a control objective can be completed before fire arrival. For evacuation scenarios, route clearance windows may be computed by integrating population datasets, transportation network capacity, and modeled fire progression toward egress routes. These computations are updated at each simulation timestep and may be visualized as countdown timers, risk flags, or time-encoded map layers within the dashboard interface or exported for field integration.

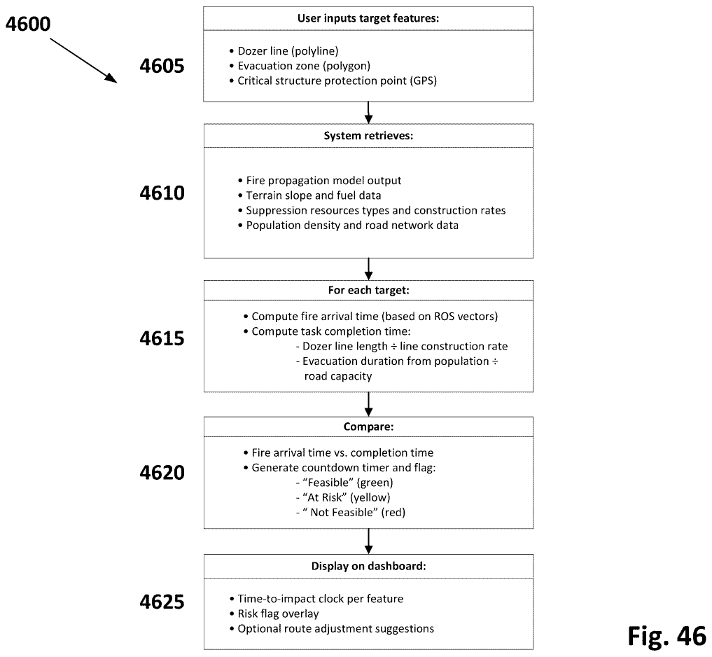

To support real-time suppression and evacuation planning, FIG. 46 illustrates a time-constrained operational response workflow 4600 in accordance with one embodiment of the present invention. As shown, the system receives user-defined target features 4605, such as dozer line segments, evacuation zones, or GPS-tagged structure protection areas. For each feature, the system retrieves relevant inputs 4610 including fire propagation model outputs, terrain slope, fuel characteristics, suppression resource types and rates, and population and road network data. Using this information, the system computes for each target 4615 a projected fire arrival time and compares it against task-specific completion time estimates, such as dozer line length divided by line construction rate, or evacuation duration derived from population size and road capacity. The system then compares these times 4620 and generates feasibility flags (e.g., “Feasible,” “At Risk,” or “Not Feasible”) along with countdown timers. These outputs are displayed on the dashboard 4625 as time-to-impact clocks, risk overlays, and optional route adjustment guidance to support time-sensitive planning and mitigation decision-making.

### Simulation Outputs, Sharing, and Asset Management

In one embodiment, the system may support multiple formats and delivery options for outputs generated by the fire propagation and consequence modeling engine. These outputs may include geospatial files (such as shapefiles, KMZ, or GeoJSON), time-series reports (in CSV or Excel format), downloadable images, or API-accessible data feeds. Users may export these outputs for use in third-party dashboards, GIS systems, or emergency management platforms. Simulation results may also be delivered through secure URLs, email attachments, or system-integrated workflows within agency or utility environments. To support collaborative use, the system may allow users to save, duplicate, and share scenarios with varying access permissions. Role-based access controls may be applied to restrict editing, deletion, or visibility, and scenarios may be designated as private, organization-visible, or publicly viewable depending on operational needs. Scenario metadata may include creator identity, creation timestamp, scenario description, and links to related detections or events. The system may also support audit logging and version tracking to preserve data integrity and enable transparency across multi-user environments.

### Flexible Ignition Sources and Realistic Spread Control

The system supports multiple ignition source types for initiating fire spread simulations, including AI-verified fire detections from camera imagery, utility-planned ignition points such as those used in PSPS risk assessments, and custom user-defined hypothetical scenarios. These ignition sources may be used independently or in parallel, allowing users to simulate a wide range of real-world and planning-based fire events. By combining these flexible ignition inputs with dynamic fuel moisture maps, the system improves model realism and prevents overestimation of fire spread into areas unlikely to ignite due to high moisture content.

### Multi-Scenario Simulations and Prioritization

The system allows users to configure and execute fire spread simulations at scale, including the ability to simulate ignitions from every individual asset, such as utility poles, substations, or line segments, across a utility's entire service area. This may result in the generation of millions of distinct fire scenarios at a time, each with its own ignition point, environmental inputs, and consequence outcomes. Users can also run comparative simulations using different weather profiles, suppression assumptions, or fuel moisture conditions. The system automatically executes these simulations in parallel, indexes the results, and applies prioritization logic to rank scenarios based on configurable criteria such as acres burned structures or population at risk, time to first asset impact, critical infrastructure exposure, and financial consequences. High-impact scenarios may be flagged in the dashboard for operational review, planning, or resource staging. Results may be visualized geospatially, filtered by asset class or risk threshold, or exported in bulk for further analysis, integration, or regulatory reporting.

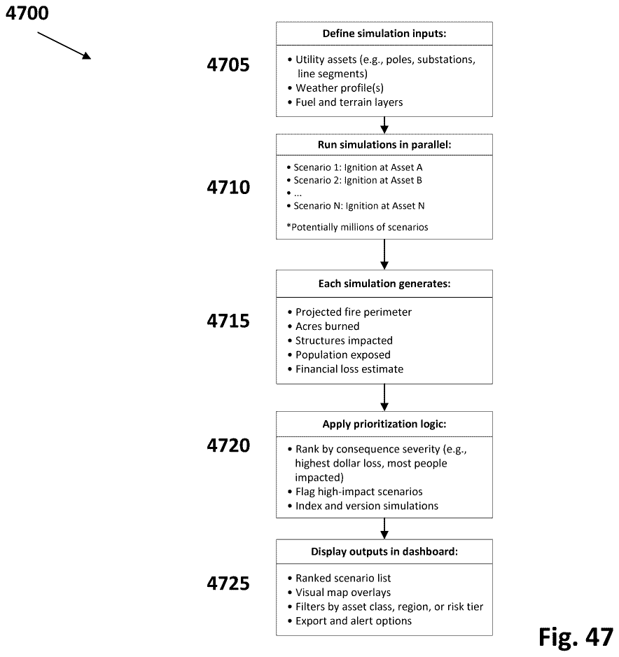

Referring now to FIG. 47, a simulation architecture 4700 is shown for large-scale fire spread modeling and consequence-based prioritization. In this embodiment, the system enables users to define simulation inputs 4705 including ignition points at utility assets, weather profiles, and fuel or terrain data. Simulations are then run in parallel 4710 across each ignition point, enabling execution of thousands or millions of fire scenarios simultaneously. For each scenario, the system generates outputs 4715 such as projected fire perimeter, acres burned, population exposure, and estimated financial loss. The engine applies prioritization logic 4720 to rank scenarios by consequence severity, highlight high-impact cases, and index the simulations for version control. Outputs are displayed in the dashboard 4725 as a ranked scenario list with geospatial overlays, filterable by asset type, region, or risk tier, and may be exported or used for alerting, mitigation planning, or regulatory reporting.

### Campaign Fire Modeling Engine and Impact Alerting

In one embodiment, the C&C system includes a campaign fire modeling engine that supports long-horizon wildfire simulations and automated alert generation for extended-duration incidents. In addition to simulating fire spread from ignition points, the system may reinitialize the propagation model from observed fire perimeters derived from aircraft infrared flights, satellite detections, or manually digitized outlines. This perimeter-anchored approach enables forward modeling based on the current shape and size of the fire, improving forecast accuracy during multi-day events. As new perimeter data becomes available, the system updates input conditions such as weather forecasts, fuel moisture, and suppression activity to refine future spread and consequence estimates. When these projected perimeters are forecast to intersect user-defined Locations of Interest within a configurable lead time (such as 6, 12, or 24 hours) the system generates alerts indicating potential impact. Users may configure filters based on consequence severity, asset type, or ensemble forecast agreement. Alerts include metadata such as perimeter origin, simulation timestamp, severity scoring, and modeled impact timing, and may be delivered through email, SMS, API, or dashboard visualization to support proactive decision-making and resource allocation throughout the duration of a campaign fire.

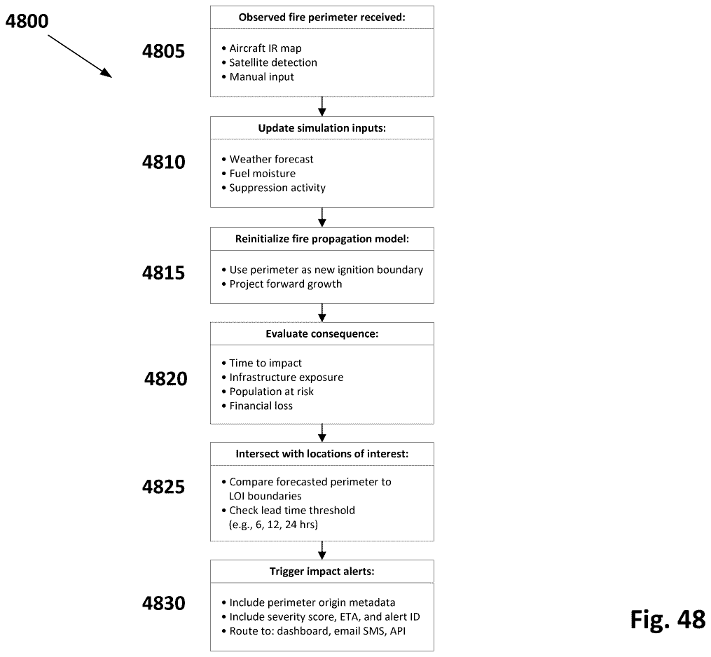

Referring now to FIG. 48, a campaign fire modeling and alerting workflow 4800 is depicted. In this embodiment, the system receives observed fire perimeter data 4805 from aerial infrared maps, satellite sources, or manual inputs. The simulation engine then updates key input parameters 4810 such as weather forecasts, fuel moisture, and suppression activity, and reinitializes the fire propagation model 4815 using the observed perimeter as a new ignition boundary. Consequence evaluation logic 4820 projects forward fire spread and estimates time to impact, infrastructure exposure, population at risk, and potential financial loss. These projections are intersected with user-defined Locations of Interest (LOIs) 4825, comparing predicted fire perimeter encroachment against LOI boundaries and user-defined lead times (e.g., 6, 12, or 24 hours). If thresholds are met, the system generates impact alerts 4830 containing origin metadata, severity scoring, and estimated time of arrival (ETA), which may be routed via dashboard, email, SMS, or API. This architecture enables long-duration fire tracking, real-time consequence forecasting, and proactive alerting throughout campaign incidents.

### User Dashboard for Temporal Risk Analysis

In one embodiment, a system dashboard displays real-time risk levels for each asset, forecasted risk levels, and historical risk level data on risk tier frequency, helping users identify assets with consistently elevated risk. A color-coded map further highlights asset risk levels, allowing users to quickly identify areas of concern. Forecasted risk tiers offer insights into upcoming conditions, enabling proactive actions such as dispatching crews to inspect or prepare assets in advance of high-risk events. The system also allows users to configure alerts for assets projected to exceed designated risk thresholds, which can be tailored to specific asset types. For instance, a manager responsible for a particular set of transmission lines would receive alerts only when those specific lines are forecasted to exceed set risk levels. Alerts may be sent out via text, email, phone call, or via API into other tools and dashboards.

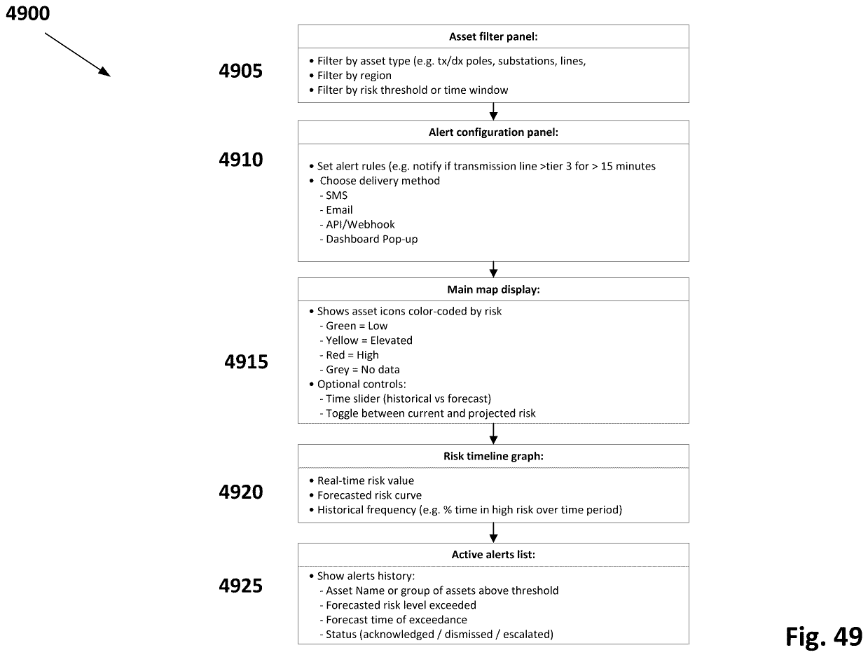

Referring now to FIG. 49, an embodiment of the system includes a user-facing dashboard 4900 for temporal risk analysis of assets such as utility poles, substations, or transmission lines. An asset filter panel 4905 allows users to select assets by type, region, risk tier, or forecast time window. An alert configuration panel 4910 enables threshold-based alert rule creation and allows users to choose delivery methods including SMS, email, API/webhook, or dashboard pop-up. The main map display 4915 presents color-coded asset icons according to current and forecasted risk levels (e.g., green for low risk, yellow for elevated, red for high, and grey for no data), with optional controls such as time sliders or toggles between forecast and real-time views. When an asset is selected, a risk timeline graph 4920 shows real-time values, forecasted curves, and historical frequency of high-risk tier conditions. An active alerts list 4925 displays previously triggered alerts with metadata including asset name, threshold exceedance timing, and alert status (acknowledged, dismissed, or escalated). This layout supports rapid interpretation of emerging threats, long-term asset risk profiling, and tailored alert delivery.

### User-Defined Locations of Interest for Risk Monitoring

In one embodiment, the system allows users to define and persistently track specific geographic coordinates or polygonal zones, referred to as Locations of Interest (LOIs), for ongoing fire and weather risk monitoring. LOIs may include critical assets such as homes, substations, utility poles, or community centers. Each LOI may be assigned one or more risk monitoring profiles that include configurable alerting thresholds, risk tolerance parameters, and visibility options. LOIs are evaluated continuously or at periodic intervals using model outputs from fire spread simulations, FPI scores, weather forecasts, and consequence overlays. Users may search for, edit, or delete LOIs through the system interface and may optionally subscribe to daily, hourly, or event-driven notifications based on dynamic risk conditions.

### Per-Asset Risk Score Overlays

In one embodiment, the C&C system may render dynamically updated fire risk scores as geospatial overlays on individual map features corresponding to ingested asset geometries. Each asset record, such as a utility pole, substation, structure parcel, or critical facility, may be assigned a unique identifier and spatial geometry imported via shapefile, GeoJSON, API, or manual input. Risk scores are computed based on intersection with model-generated fire perimeters and are derived from ignition likelihood, directional spread velocity, expected flame intensity, ember exposure probability, and time-to-impact. The system may display these scores using tiered icons, numeric values, or color-coded severity gradients, with visual styling controlled through user or role-based configuration. Asset overlays may refresh at each simulation time step and support filtering by infrastructure class, consequence threshold, or modeled forecast horizon. Risk scores may also be exported in tabular format for use in regulatory reporting, planning briefs, or downstream integration with field management tools.

### Retrospective Asset-Level Consequence Analysis

The system may conduct retrospective lookback studies by inputting historical satellite imagery, archived weather datasets, and calculated FMC values into fire spread and consequence models. These simulations may include every day in a historical archive or may focus selectively on high-risk weather conditions, such as red flag warnings, high wind periods, or drought-aligned events. The system may operate in multiple retrospective analysis modes to identify utility assets with consistently high consequence exposure across time. In one mode, the system may simulate hypothetical ignition events originating from each utility asset under recorded historical conditions. In another, the system may aggregate thousands of hypothetical ignition points across the landscape to determine which assets are most frequently exposed or burned. These retrospective consequence analyses may be used to support planning for grid hardening, vegetation management, resource staging, and capital investment prioritization. The results may also be visualized in the dashboard and used to validate risk models against known fire outcomes.

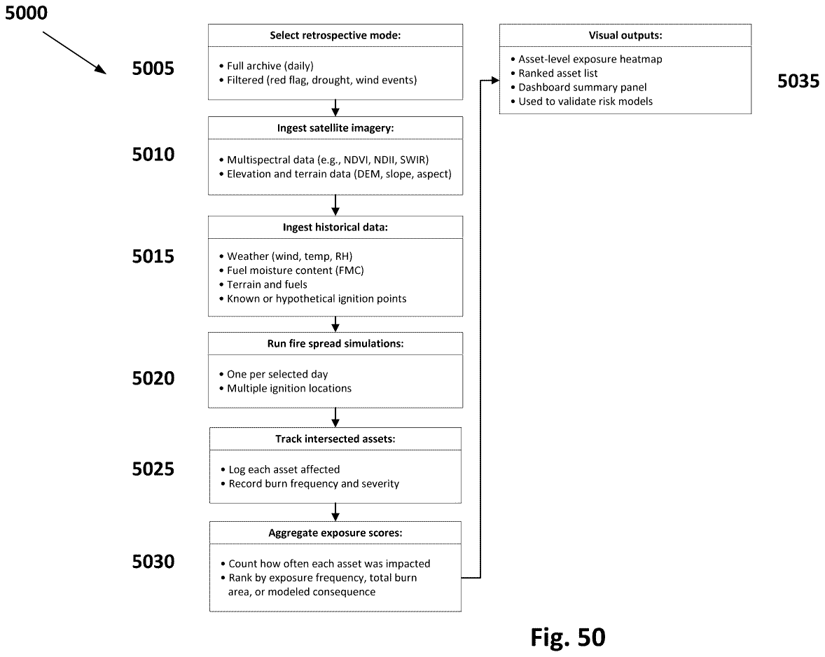

Referring to FIG. 50, the system includes a retrospective consequence analysis module 5000 that enables lookback studies using historical environmental conditions. Users may begin by selecting a retrospective mode 5005, such as full daily archive or filtered events based on red flag warnings, drought periods, or wind-driven conditions. The system then ingests satellite-derived multispectral imagery 5010 and historical elevation and terrain data. Weather and fuel variables (e.g., wind, temperature, humidity, and FMC) are incorporated from archived sources 5015, along with known or hypothetical ignition points. Fire spread simulations 5020 are run for each selected day and ignition location. Intersections between simulated fire perimeters and utility assets are logged 5025, including burn frequency and severity. Exposure scores are aggregated per asset 5030, ranking by how often each was impacted, total burn area, or modeled consequence severity. The outputs 5035 may be visualized as heatmaps, ranked asset lists, or dashboard panels to support grid hardening, vegetation management, or capital investment strategies.

### Synchronized Incident Replay Module

In one embodiment, the system includes a synchronized incident replay module that aggregates camera imagery, detection metadata, fire propagation outputs, and SDR audio streams on a unified temporal axis. A time-of-day slider may be used to navigate through the incident timeline, synchronizing visual and auditory data to the selected timestamp. The interface may render camera feeds from all units within a defined spatial boundary, overlay model outputs and map layers, and align SDR playback to corresponding operational events. This module may be used for live incident monitoring, incident review, and training workflows. Configuration parameters may include incident identifiers, geographic bounds, sensor inclusion criteria, and retention windows.

### Historical Ignition Scenario Modeling

In one retrospective mode, the system may simulate fire ignitions originating from utility assets across a historical archive of weather, terrain, and FMC conditions. For each ignition, the system may model fire spread based on recorded wind, temperature, humidity, and slope data, and generate projected consequences such as acres burned, population exposure, number of structures impacted, time-to-impact, or estimated financial loss. The system may rank each asset based on the frequency and severity of consequence outcomes it would have caused if an ignition occurred at that location. Operators may filter by voltage class, asset type, or region to identify high-consequence ignition candidates. This analysis may inform and support targeted investments in risk mitigation, such as conductor shielding, pole replacement, or installation of monitoring infrastructure. Results may be visualized as color-coded overlays on the map interface and incorporated into the dashboard's planning layer.

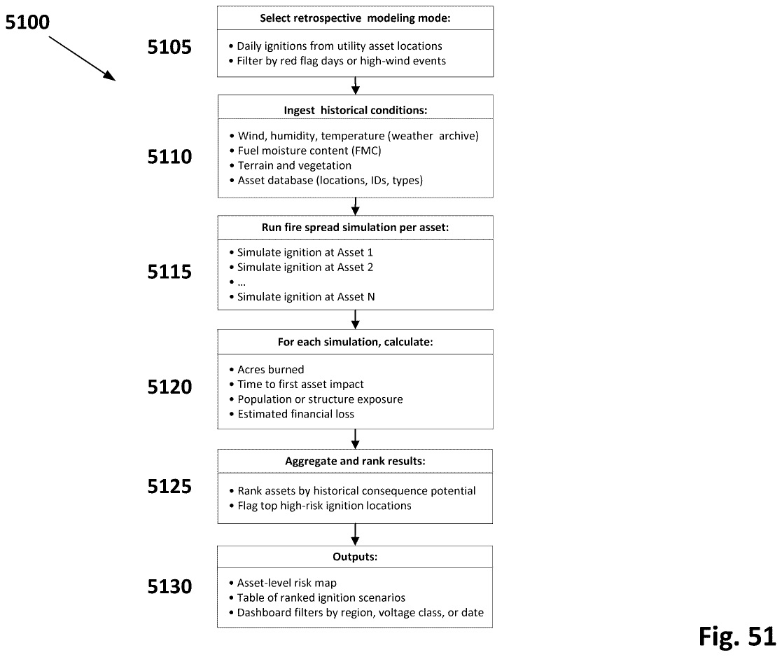

Referring to FIG. 51, the system includes a historical ignition scenario modeling module 5100 that operates by simulating fire ignitions at utility asset locations under archived environmental conditions. A retrospective modeling mode selector 5105 allows the user to initiate daily ignition scenarios from asset locations or filter by high-risk periods such as red flag or high-wind days. The system ingests historical data 5110 including weather archives (wind, humidity, temperature), fuel moisture content (FMC), terrain, slope, vegetation, and asset metadata. Fire spread simulations 5115 are conducted per asset, modeling ignitions at each location. For each simulation, the system calculates projected consequences 5120, including acres burned, time to first asset impact, estimated population or structure exposure, and potential financial loss. Results are aggregated and ranked 5125 to identify assets with high consequence potential and flag historically dangerous ignition locations. The system outputs 5130 may include asset-level risk maps, ranked scenario tables, and dashboard filtering tools based on region, voltage class, or asset type. These outputs may be used to inform mitigation planning and investment prioritization.

### Repeated Fire Exposure and Hardening Prioritization

In a second retrospective mode, the system may simulate large-scale ignition sweeps across historical weather periods to determine which utility assets are most frequently exposed to fire, regardless of ignition origin. For each simulated fire, the model tracks the spread perimeter and identifies which infrastructure assets are intersected over time. Exposure tallies may be aggregated per asset, allowing the system to score infrastructure based on how often it is impacted by fire in historical simulations. Assets that experience repeated exposure may be flagged for hardening actions such as steel pole upgrades, undergrounding, vegetation clearance expansion, or microgrid prioritization. The system may generate exposure density maps and asset heat rankings to help planners allocate capital to the most at-risk areas. This retrospective exposure dataset may also be used to validate ignition risk models or to compare with real-world incident reports.

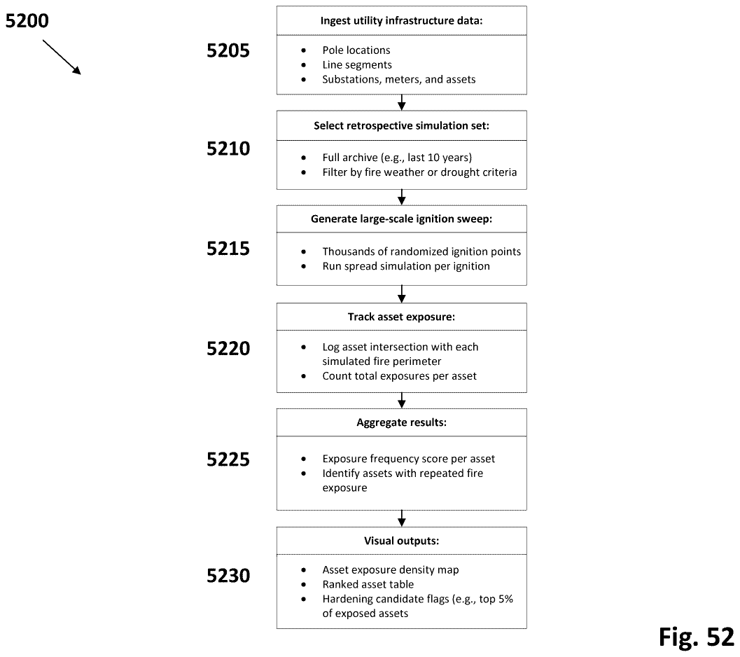

Referring to FIG. 52, the system includes a retrospective exposure analysis module 5200 that simulates large-scale ignition sweeps to identify utility assets with repeated fire exposure. The module begins by ingesting utility infrastructure data 5205, including poles, line segments, substations, and other fielded assets. A retrospective simulation selector 5210 allows users to run scenarios across full historical archives or filter by drought or fire weather criteria. The system generates thousands of randomized ignition points 5215 and simulates fire spread for each, regardless of proximity to utility infrastructure. As each fire perimeter evolves, the system tracks exposure events 5220, logging asset intersections and counting cumulative exposures per asset. Results are aggregated 5225 to produce exposure frequency scores and to identify assets most often affected across the retrospective dataset. Visual outputs 5230 may include asset exposure maps, ranked asset tables, and hardening candidate flags highlighting the most frequently exposed infrastructure, supporting prioritization for steel pole conversion, undergrounding, vegetation clearance, or microgrid development.

### Model Validation Against Archived Forecasts

The system may compare its simulated outputs to archived forecast products or observed fire behavior to validate and calibrate the modeling pipeline. For each retrospective ignition, the system may compare its predicted fire spread and consequence outputs with those that would have been forecasted using data available at the time. Deviations between the archived forecast, modeled outputs, and actual fire outcomes may be used to adjust model coefficients, improve consequence scoring logic, or evaluate prediction confidence intervals. Users may generate comparison overlays that show side-by-side forecast versus simulation performance, including differences in acreage, arrival time, and consequence magnitude. This comparison mode supports system transparency, regulatory defensibility, and continuous improvement of the model.

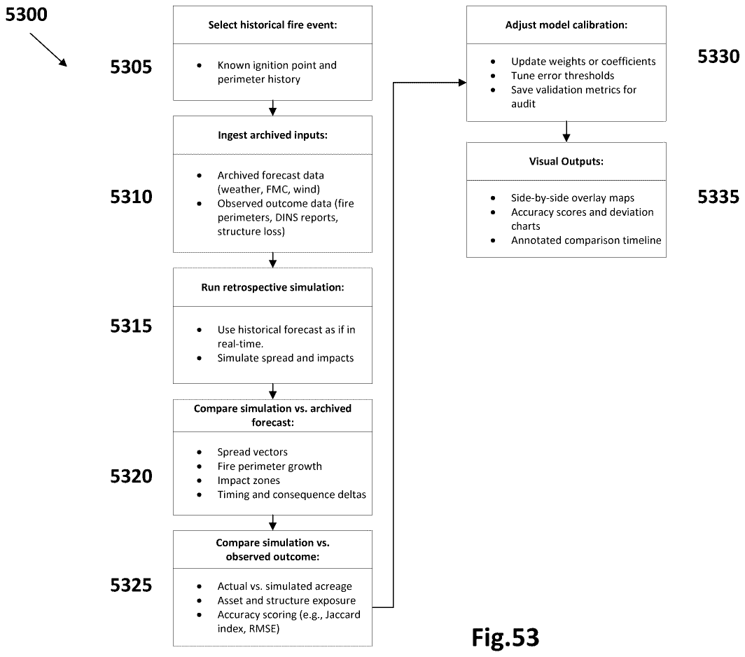

Referring now to FIG. 53, the system includes a model validation module 5300 that enables comparison of simulated fire behavior with archived forecasts and observed fire outcomes. A known historical fire event 5305 is selected using ignition coordinates and recorded perimeter progression. Archived inputs 5310, including historical forecasts of weather, fuel moisture content (FMC), and wind, are ingested alongside observed outcome datasets such as incident reports, fire perimeters, and structure loss. The system runs a retrospective simulation 5315 using only the data that would have been available at the time, replicating a real-time forecast scenario. The simulated outputs are compared to the archived forecast 5320 to evaluate differences in spread vectors, fire perimeter evolution, impact zones, and timing. A separate comparison to actual outcomes 5325 evaluates simulated versus observed acreage, infrastructure exposure, and calculates accuracy metrics such as RMSE or Jaccard index. Deviations between forecast, simulation, and outcome are used to adjust model parameters 5330, update calibration weights, and store validation metrics. Visual outputs 5335 include overlay maps, deviation charts, and annotated timelines to support model transparency, auditing, and iterative improvement.

### Forecasted High-Consequence Asset Identification

Ahead of forecasted red flag warnings, extreme heat events, or dry lightning episodes, the system may identify which utility assets are projected to experience the highest consequence if impacted by fire. Forecast inputs may include wind speed and direction, temperature, humidity, FMC values, fuel type, terrain, and population data. The model may compute consequence scores for each asset using forecasted fire spread overlays and intersected infrastructure layers. Results may include predicted time-to-impact, total exposure duration, financial risk estimates, and structure or customer counts. Assets with the highest projected consequence may be prioritized for field inspection, patrol routing, camera tasking, vegetation clearance, or equipment staging. The dashboard may present a sorted list of at-risk assets and allow operators to drill into each one to view underlying exposure drivers.

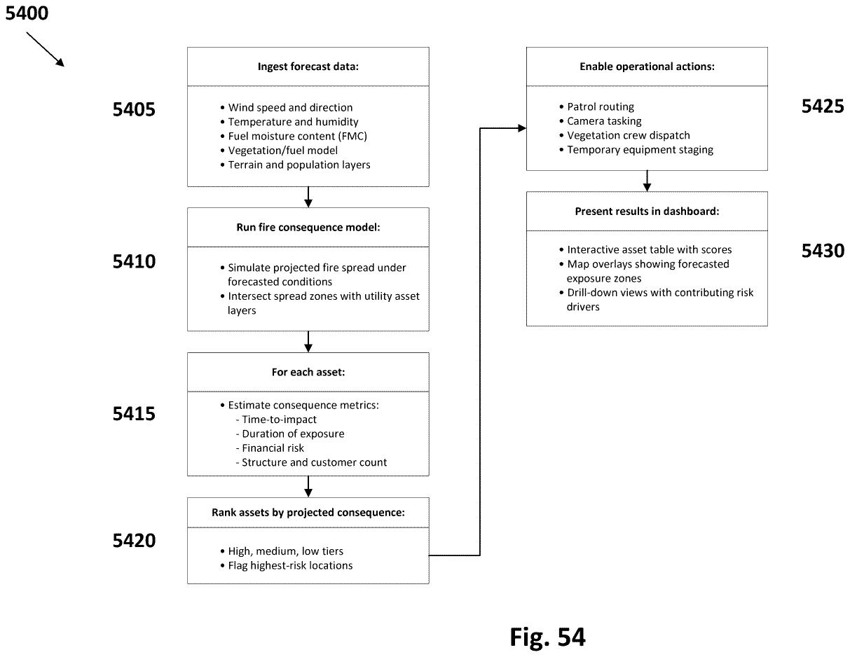

Referring to FIG. 54, the system includes a forecast-based asset consequence module 5400 that identifies high-risk utility assets ahead of extreme fire weather conditions. Forecast data inputs 5405 include wind speed and direction, temperature, humidity, fuel moisture content (FMC), vegetation or fuel type, terrain, and population distribution. The system runs a forward-looking fire consequence model 5410 to simulate fire spread under these conditions and intersects the projected fire zones with utility infrastructure layers. For each impacted asset 5415, the system estimates consequence metrics such as predicted time-to-impact, duration of exposure, financial risk, and the number of structures or customers affected. Assets are ranked 5420 into high, medium, or low consequence tiers, with the highest-risk locations flagged for action. The system may support operational deployments 5425 such as patrol routing, vegetation crew dispatch, camera tasking, or equipment staging. Results are presented in the dashboard 5430 through an interactive asset score table, fire spread overlays, and drill-down views that highlight contributing risk drivers for each prioritized location.

### Risk Summary Panel and Time-Series Visualization

The risk dashboard may present a summary panel that displays aggregate consequence metrics for the upcoming forecast period, including total acres forecasted to burn, number of structures at risk, financial exposure, and number of assets with projected fire impact. These metrics may be broken down by hour, region, asset class, or scenario type. In some embodiments, the dashboard may include an interactive time-series graph that shows how risk values evolve throughout the forecast period. Risk peaks may be highlighted and linked to specific weather drivers or ignition alignments. Operators may click on any time segment to view associated at-risk assets, and toggle between different forecast scenarios to test consequence sensitivity. The time-series and summary panel views provide real-time situational awareness as well as forward-looking prioritization.

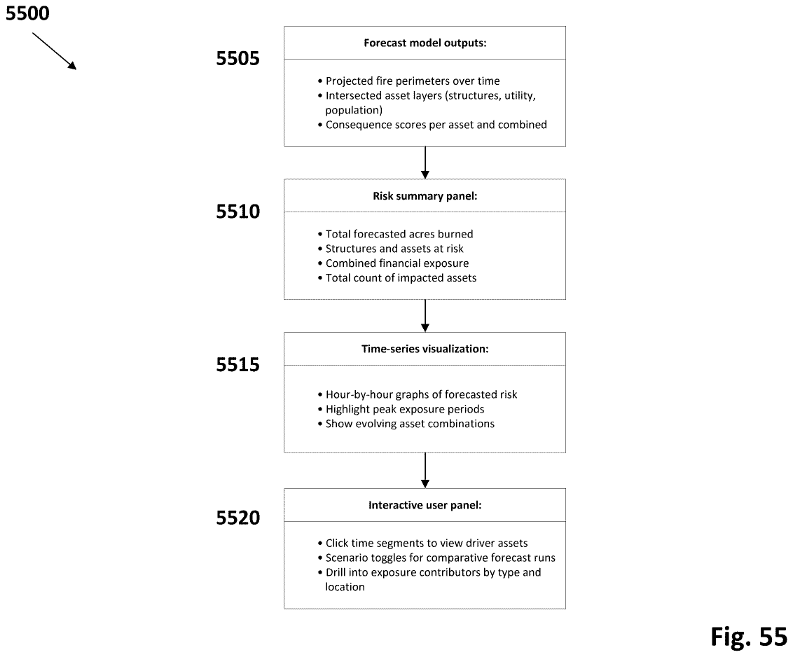

Referring now to FIG. 55, the system includes a risk dashboard module 5500 that presents forecast-driven consequence summaries and interactive visualizations to support situational awareness. Forecast model outputs 5505 include projected fire perimeters, intersected infrastructure and population layers, and consequence scores per asset and aggregate. These are summarized in a risk panel 5510, which displays total forecasted acres burned, number of structures and utility assets at risk, combined financial exposure, and total impacted asset count. A time-series visualization panel 5515 presents hour-by-hour graphs of forecasted risk, highlights peak exposure windows, and shows evolving asset combinations over time. An interactive user panel 5520 enables operators to click on individual time segments to view contributing driver assets, toggle between forecast scenarios for comparative runs, and drill down into exposure sources by type and location. This interface supports both real-time decision-making and forecast-based prioritization.

### Configurable Risk Budgets and Alert Thresholds

The system may allow users to define configurable risk budgets that cap allowable consequence exposure for a given region, voltage class, or operational zone. Risk budgets may be based on financial loss, number of customers or structures impacted, number of impacted assets, or total acreage burned. The system may continuously monitor forecasted risk levels against these thresholds and issue alerts when a budget is exceeded. Each alert may include a ranked list of contributing assets, a forecasted time window of concern, and recommended mitigation actions. Operators may override alerts, adjust thresholds, or initiate mitigation workflows directly from the dashboard, such as flagging circuits for preemptive de-energization or generating operational response plans based on the adjusted risk level. Risk budgets may be saved as reusable profiles and tailored to regulatory requirements, operational tolerance limits, or seasonal fire risk conditions.

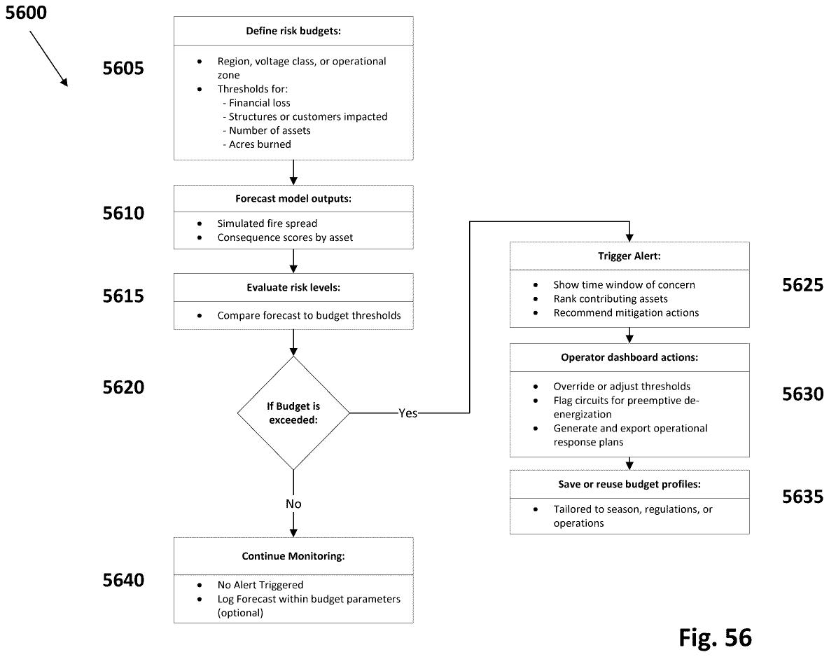

Referring now to FIG. 56, the system includes a configurable risk budget and alerting module 5600 that enables operators to define consequence exposure thresholds for specific regions, voltage classes, or operational zones. Users may define risk budgets 5605 based on parameters such as financial loss, number of impacted customers or structures, number of affected utility assets, or total forecasted acres burned. The system ingests forecast model outputs 5610, including simulated fire spread and asset-level consequence scores, and evaluates projected risk levels 5615 against the defined budget thresholds. If a budget is exceeded 5620, the system triggers an alert 5625 indicating the forecasted time window of concern, a ranked list of contributing assets, and recommended mitigation actions. Operators may respond through the dashboard 5630, where they can override or adjust thresholds, flag circuits for preemptive de-energization, or generate operational response plans. Risk budget configurations may be saved or reused as profiles 5635, tailored to seasonal conditions, regulatory requirements, or operational policies. If no budget is exceeded, the system continues monitoring 5640 without triggering an alert and may optionally log that the forecast remained within tolerance for auditing or documentation purposes.

### Interactive Asset Table and Map Filtering

The dashboard may include a sortable and filterable asset table that displays risk and consequence metrics per infrastructure element. Columns may include asset ID, asset type, region, forecasted consequence score, ignition risk level, exposure frequency, inspection status, mitigation flag, and last update timestamp. Users may sort and filter by any column and select assets to visualize on the map interface. In some embodiments, users may simulate different mitigation scenarios by toggling asset inclusion, changing hardening assumptions, or adjusting forecast models. The system may update aggregate consequence metrics in real time based on user selections, allowing operators to simulate the effect of different intervention strategies. The table may also include export functions for reporting or integration into enterprise systems.

### Historical Fire Replay and Custom Scenario Builder

The system may support historical replay functionality to visualize how past fires evolved under the recorded environmental conditions and how those events impacted infrastructure and consequence metrics. Users may view fire progression animations, time-stamped consequence overlays, and post-event asset impact summaries. In addition, the dashboard may include a custom scenario builder that allows operators to define hypothetical ignition points and input customized forecast parameters such as wind direction, speed, humidity, and FMC. The system may simulate the fire spread from the ignition and calculate the expected consequences using the same risk scoring logic as live or forecasted scenarios. These simulations may support pre-season planning, tabletop exercises, regulatory reviews, or public agency coordination workflows.

### PSPS Impact Reconstruction and Counterfactual Comparison

The system may include a retrospective modeling tool that allows utilities to evaluate the consequences of historical PSPS decisions by comparing observed outcomes with counterfactual scenarios. For each date, the system may identify energized assets that were not de-energized and simulate hypothetical ignitions under the actual historical weather and FMC conditions. The modeled fire spread and associated consequences may then be compared to actual PSPS boundaries and the consequences that did or did not occur. This analysis helps quantify avoided risk, missed opportunities, and unintended impacts.

### Alternative De-Energization Plan Analysis

The system may support comparative modeling of multiple PSPS configurations, including: (i) actual energization status, (ii) full no-shutoff baseline, and (iii) custom de-energization plans uploaded by the user. For each configuration, the system may simulate fire behavior and produce side-by-side visualizations of consequence outcomes. Metrics may include total avoided damage, missed risk, and overall effectiveness of different PSPS strategies. These outputs support defensible planning, regulatory submissions, and internal audits of PSPS decisions.

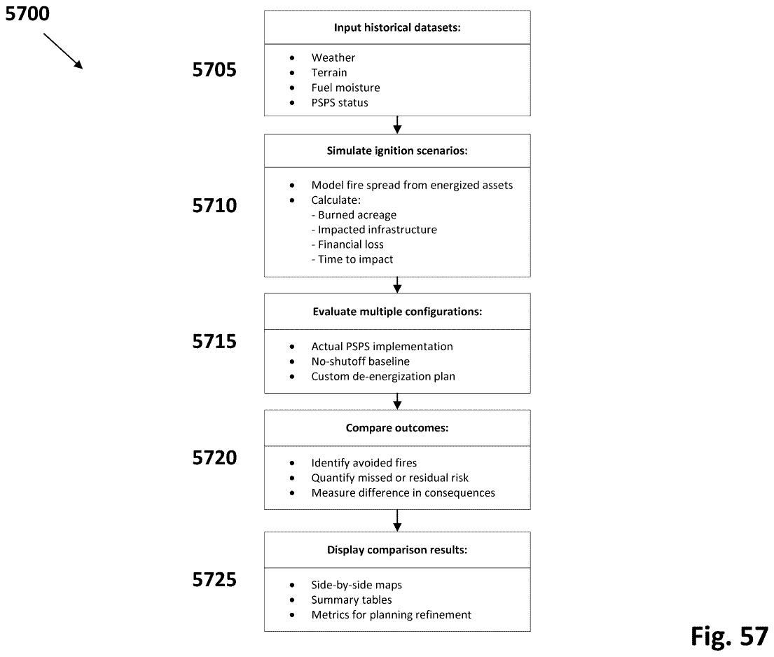

Now referring to FIG. 57, the system includes a PSPS impact analysis and counterfactual modeling module 5700 that supports evaluation of historical and alternative de-energization decisions. The system ingests historical environmental datasets 5705, including weather, terrain, fuel moisture content, and PSPS status records. It simulates ignition scenarios 5710 from energized utility assets to estimate consequences such as burned acreage, infrastructure impact, financial loss, and time-to-impact. Multiple de-energization configurations may be evaluated 5715, including the actual PSPS implementation, a full no-shutoff baseline, and custom user-defined de-energization plans. The system compares outcomes 5720 across these configurations to identify avoided fires, quantify residual or missed risk, and assess the relative effectiveness of each strategy. Results may be displayed 5725 as side-by-side consequence maps, summary tables, and planning metrics. These outputs support defensible PSPS planning, internal audits, and regulatory reporting by quantifying both realized and averted impacts across multiple de-energization scenarios.

### Audit Trail, Version Control, and Suppression Overlays

The system may automatically record and version all simulation runs, storing metadata such as input parameters, simulation timestamps, forecast sources, and user modifications. Each simulation may be assigned a cryptographic hash for audit integrity. Simulation records may be linked to policy documents, operational actions, or regulatory events. In some embodiments, suppression overlays may be added to the fire model to account for expected containment efforts based on historical or modeled response patterns. This allows the system to produce conservative, realistic, or worst-case consequence envelopes to guide both retrospective review and forward-looking planning.

### User Dataset Integration for Customized Consequence Modeling

The C&C system allows users to integrate external datasets to customize consequence modeling outputs and tailor outputs to their operational context. Users may upload data directly via shapefile, GeoJSON, KML, CSV, or spreadsheet import, or connect via API to internal enterprise systems and third-party databases. These datasets may include customer infrastructure, utility asset inventories, critical infrastructure maps, census data, or evacuation planning files. The system supports authenticated API tokens and secure upload portals for validated ingestion of sensitive or private datasets. Once ingested, the system automatically validates, indexes, and geospatially aligns the imported layers for use in simulations, dashboards, and alert workflows.

### Rule-Based Scoring for Infrastructure, Population, and Customer Impact

Once external datasets are integrated, users may assign consequence scoring logic specific to each dataset. For example, a utility may calculate potential outage costs based on customer class, average monthly bill per meter, and estimated service restoration timelines, while a fire agency may assess evacuation impact using population density and vulnerability data by census block. The system enables users to configure rule-based or weighted consequence models for each layer, such as assigning different financial weights to commercial versus residential structures, or defining severity tiers based on proximity to hospitals or traffic congestion along key egress routes. During a simulation, the consequence engine dynamically intersects the projected fire perimeter with each dataset and applies the corresponding scoring logic to generate impact summaries per layer. These outputs may be displayed individually or aggregated across datasets, enabling flexible, data-driven prioritization aligned with each organization's operational risk framework.

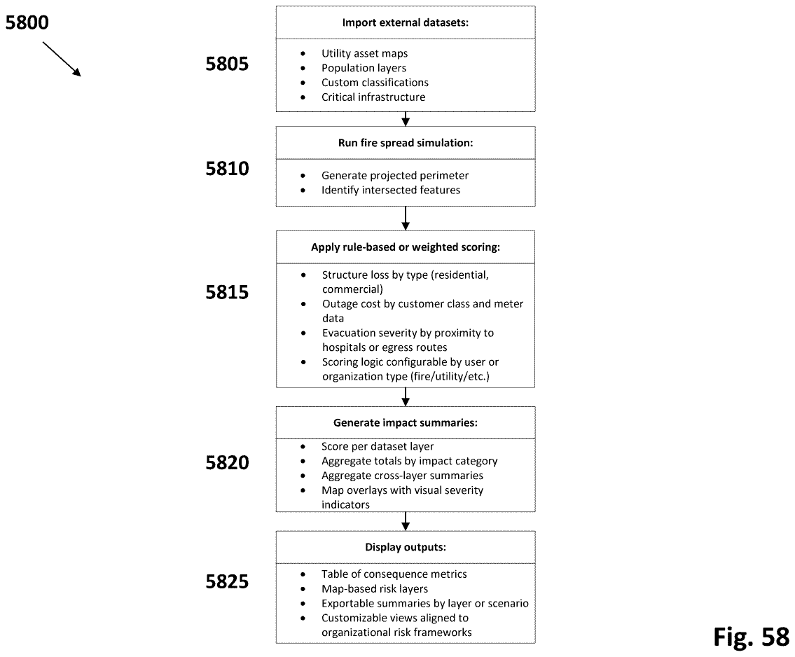

Now referring to FIG. 58, the system includes a consequence scoring module 5800 that allows users to configure rule-based or weighted impact models for integrated external datasets. The system begins by importing data layers 5805 such as utility asset maps, population density grids, critical infrastructure locations, and custom classifications. A fire spread simulation engine 5810 generates projected perimeters and identifies which features are intersected. For each dataset, the system applies user-defined scoring logic 5815, allowing organizations to tailor consequence calculations to their operational context. For example, structure loss may be weighted differently for residential versus commercial buildings, outage costs may be calculated based on customer class and billing data, and evacuation severity may be determined by proximity to hospitals or constrained egress routes. Scoring logic may vary by organization type, such as utility vs. fire agency. The system generates impact summaries 5820 per dataset layer and supports aggregation across layers to produce comprehensive consequence assessments. These summaries may include map overlays with visual severity indicators and totals by impact category. Final outputs 5825 may be displayed as consequence tables, risk layers, or exportable reports, and can be customized to align with each organization's operational risk framework or prioritization strategy.

### Spatially-Gridded Fire Risk Modeling Framework

In one embodiment of the present invention, the C&C system includes a wildfire risk assessment tool that models ignition potential, spread behavior, and consequence severity across a spatial grid. This gridded approach operates independently of mapped infrastructure or asset locations and is designed for large-scale geographic coverage, including utilization at the state and national levels. The spatial resolution of the grid may vary depending on the use case. For example, a 10-meter grid may be used for high-precision modeling, while coarser grids may be applied for broader planning scenarios or to reduce computational and storage costs.

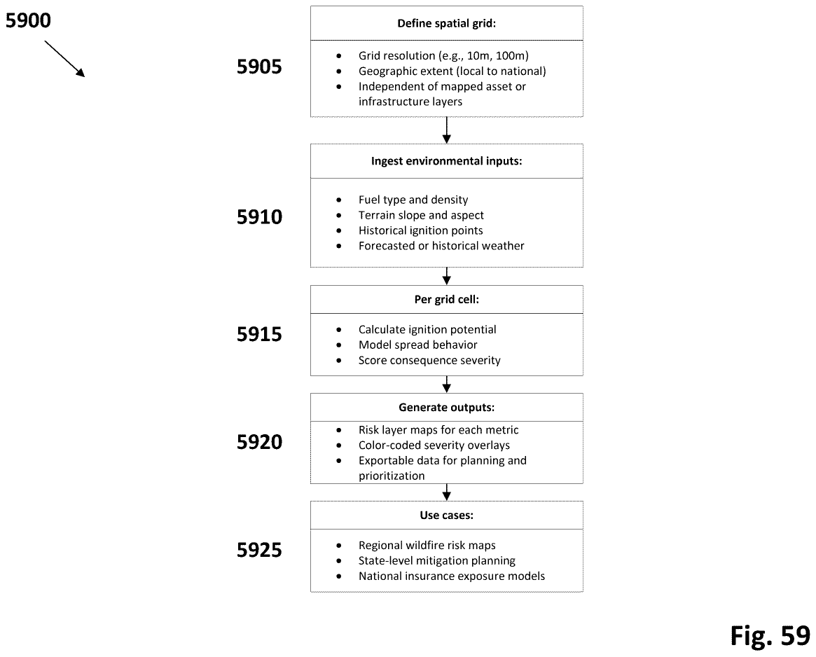

Referring now to FIG. 59, the system includes a spatially-gridded wildfire risk modeling framework 5900 designed to calculate ignition potential, fire spread behavior, and consequence severity across a configurable geographic grid. A spatial grid definition module 5905 allows users to specify resolution (e.g., 10 m or 100 m) and geographic scope (local to national), and operates independently of mapped asset or infrastructure layers. Environmental inputs 5910, including fuel type and density, terrain slope and aspect, historical ignition points, and weather data (forecasted or historical), are ingested for each grid cell. The system calculates per-cell risk values 5915 by evaluating ignition likelihood, spread modeling, and consequence severity. These results are used to generate outputs 5920 such as risk layer maps, severity overlays, and exportable datasets for downstream prioritization or planning. Use cases 5925 include regional and state-level wildfire mitigation efforts, national insurance exposure modeling, and broader spatial risk visualization not tied to specific utility assets.

### AI-Driven Fire Risk Modeling in Data-Limited Regions

The system uses AI models instead of traditional physics-based fire simulators to reduce computational time and resource demands. This enables rapid modeling of fire risk across wide regions using standardized environmental inputs such as fuel, terrain, and current or forecasted weather conditions, without requiring customer-specific data customization. By eliminating the need to ingest, clean, and integrate infrastructure inventories before use, this method allows new customers in unserved areas to immediately begin using the system without delay. The model can operate effectively even in the absence of detailed local asset data or geospatial system integrations.

### Grid Cell Scoring for Ignition Potential, Spread, and Consequence

Each grid cell is dynamically scored based on environmental factors including wind speed and direction, relative humidity, temperature, terrain slope and aspect, vegetation characteristics, and historical ignition patterns. Model outputs may include ignition probability, projected spread rate, and consequence severity, displayed as map-based overlays or exported for integration into external tools and workflows. This framework supports real-time and forecasted wildfire risk assessment at local, regional, or national scales, allowing public agencies, utilities, insurers, and emergency managers to prioritize planning, patrol, and response actions using consistent, high-resolution intelligence.

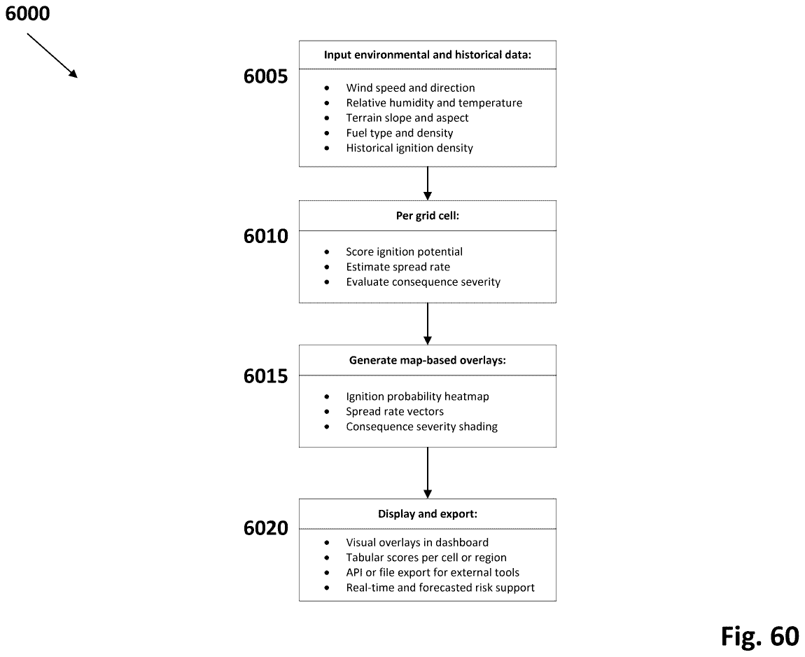

Referring to FIG. 60, the system includes a grid-based wildfire scoring module 6000 that dynamically evaluates ignition potential, fire spread rate, and consequence severity at the level of individual grid cells. Environmental and historical datasets 6005 are ingested, including wind speed and direction, relative humidity, temperature, terrain slope and aspect, fuel type and density, and historical ignition density. For each grid cell 6010, the system calculates ignition probability, estimates spread behavior, and scores potential consequences. These results are used to generate map-based overlays 6015, such as ignition probability heatmaps, fire spread vectors, and consequence severity shading. The outputs may be displayed and exported 6020 through visual dashboards, tabular summaries by cell or region, and API or file-based formats for use in external tools.

### Deduplicated Consequence Modeling for a Single Utility Line

In one embodiment, the system simulates fire ignitions from each individual asset along a given utility line and calculates projected fire spread and its consequences. These may include the total burned area in acres, the number of structures impacted, the extent of critical infrastructure exposure, and financial loss estimates. When multiple asset-based simulations along the same line produce overlapping consequence zones, the system removes duplicated geographic areas to create a unified footprint. The resulting consequence metrics reflect only the unique impacts along that line and may be used to prioritize grid hardening, PSPS planning, or operational response for that specific segment.

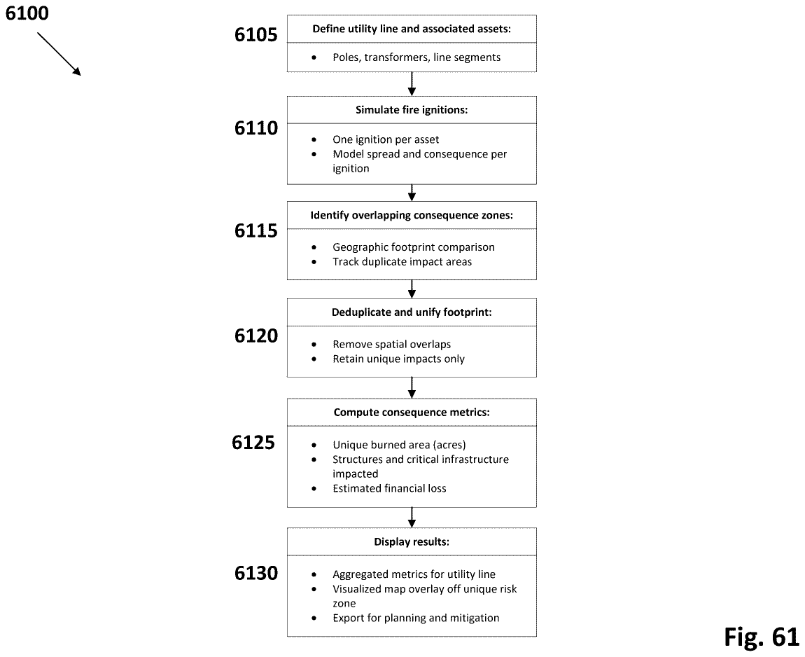

Referring to FIG. 61, the system includes a deduplicated consequence modeling module 6100 designed to evaluate unique wildfire impacts along a specific utility line. The system first defines the utility line and its associated assets 6105, such as poles, transformers, and line segments. For each asset, a simulated fire ignition is generated 6110, and the system models projected fire spread and resulting consequences. The system then identifies overlapping consequence zones 6115 based on geographic footprint comparison and tracks duplicate impact areas across multiple simulations. A deduplication step 6120 removes spatial overlaps and retains only the unique impacts. Consequence metrics 6125 are computed based on the unified impact zone and may include total burned area in acres, number of impacted structures, exposure of critical infrastructure, and estimated financial loss. The final results 6130 provide an aggregated view of risk across the utility line and may be displayed as visual overlays, exported for planning use, or applied to grid hardening and mitigation decisions such as PSPS planning or asset upgrades.

### Deduplicated Consequence Modeling Across Multiple Utility Lines

In geographic regions where two or more utility lines traverse overlapping terrain, the system simulates fire ignitions from each line independently and evaluates their projected fire spread and consequences. These include total burned area in acres, structure exposure, infrastructure impact, and financial loss estimates. When simulated consequence zones from multiple lines intersect, the system removes overlapping portions to prevent overcounting. The dashboard reports only the unique, non-redundant impacts across all lines. For example, if one line's simulated footprint is fully contained within another's, removing it would not reduce the overall consequence metrics. However, if a line extends into a region not covered by others, removing it would reduce total impact. This logic ensures that reported risk reflects the true system-wide exposure across all utility lines in the modeled area.

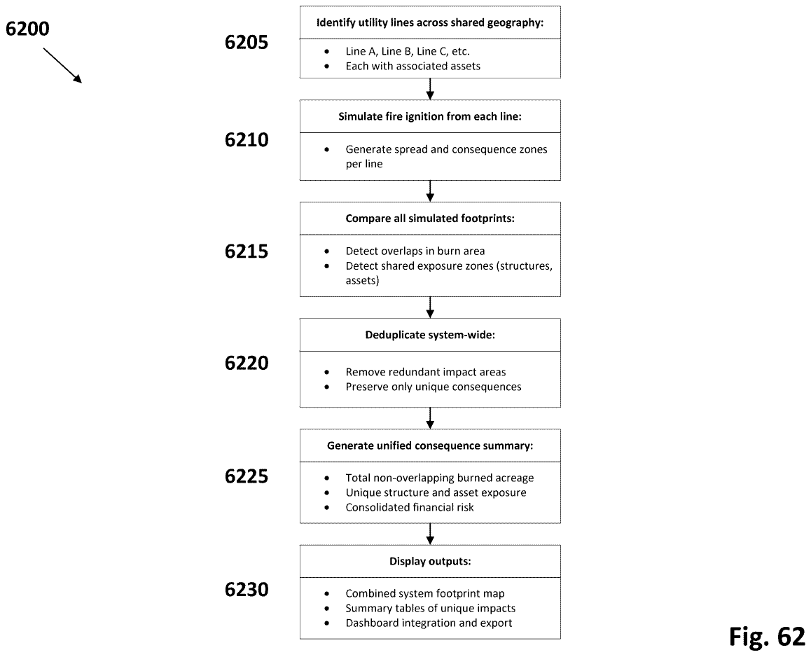

Referring to FIG. 62, the system includes a deduplicated consequence modeling framework 6200 for multiple utility lines traversing shared geography. The system first identifies utility lines and their associated assets 6205 within a common region. Fire ignitions are simulated for each line independently 6210, and the projected spread and consequence zones are computed. The system compares all simulated consequence footprints 6215 to identify overlapping burn areas and shared infrastructure or structure exposure. A system-wide deduplication step 6220 removes redundant geographic and impact zones, preserving only the unique consequence contributions from each line. The unified consequence summary 6225 includes the total non-overlapping burned acreage, number of uniquely exposed structures or assets, and consolidated financial risk. These results are presented 6230 through a combined system footprint map, summary tables of non-redundant impacts, and dashboard tools for planning or reporting. This approach ensures that the reported risk reflects true system-wide exposure without inflating consequence metrics through double counting.

### Tiered Consequence-Based Alerting Framework

The system supports tiered alerting logic, allowing users to define escalating notification actions as conditions become more severe. For example, a moderate-risk forecast may trigger an email alert, while a high-risk threshold may escalate to a mobile push notification, automated phone call, or integration with dispatch and field systems. Alerts can be customized by region, time window, weather variable, or proximity to critical assets, enabling precise, proactive decision-making as weather conditions evolve.

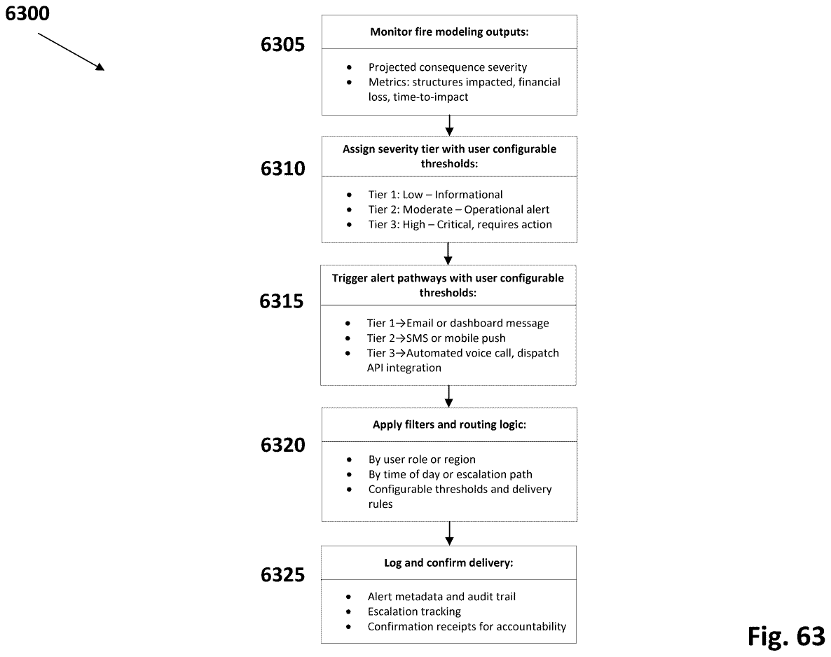

Now referring to FIG. 63, the system includes a tiered consequence-based alerting framework 6300 that monitors projected consequence severity from fire modeling outputs 6305. Based on configurable thresholds, each event is assigned a severity tier 6310, such as Tier 1 for informational alerts, Tier 2 for operational warnings, and Tier 3 for critical risk requiring immediate action. Corresponding notification pathways 6315 are triggered based on tier, ranging from email or dashboard alerts to mobile push notifications, automated voice calls, or integration with dispatch systems via API. The system applies routing logic 6320 based on user role, region, time of day, or escalation rules, allowing tailored delivery. Alerts are logged and confirmed 6325 with metadata, audit trails, and confirmation receipts to support traceability and operational accountability.

### Alerting for Assets Near Projected or Actual Fire Perimeters

The system may trigger alerts when either detected or simulated fire perimeters approach within a defined buffer distance of designated critical infrastructure or high-priority assets. Users may configure proximity thresholds based on asset class, such as substations, transmission corridors, underground vaults, telecommunications hubs, hospitals, schools, or high-density residential zones. Asset classes may be selected from existing layers or uploaded by the user and may include metadata such as operational tier, criticality level, or customer impact. In some embodiments, users may input a custom asset layer and define a buffer distance that establishes a standoff perimeter around each asset. The system may then automatically generate a corresponding buffer layer and render both the asset layer and its buffer on an interactive map. Users may adjust the buffer geometry using integrated geospatial tools, including a polygon drawing tool to define new boundaries, a reshaping tool to edit existing ones, and a polygon elimination tool to remove interior or low-risk areas from consideration within larger composite shapes. Once configured, the system monitors proximity breaches as either live or forecasted fire perimeters are ingested or generated. If a fire perimeter enters a defined buffer zone, the system triggers an alert, which may include the name and type of the at-risk asset, the measured distance from the fire, estimated time to impact if modeled, and recommended actions. Users may configure escalating tiers of proximity (e.g., 5-mile, 2-mile, 0.5-mile) to trigger graduated alert severity levels, enabling earlier situational awareness followed by operational response as fire lines move closer. These proximity-based alerts enable proactive planning and targeted action when essential infrastructure or vulnerable populations are threatened by advancing wildfire activity.

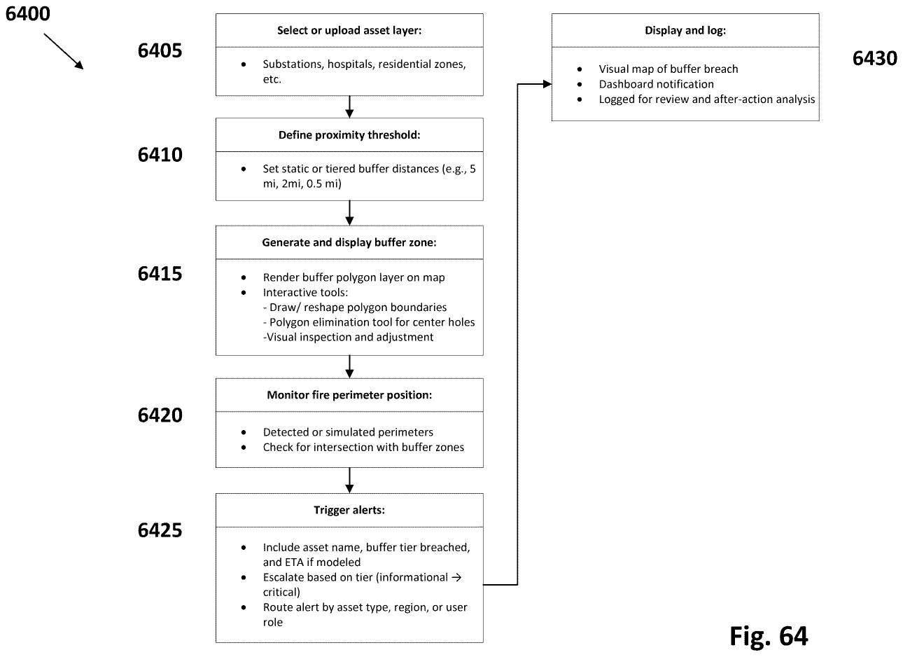

Referring to FIG. 64, the system may include a proximity-based alerting module 6400 that monitors fire perimeter positions relative to critical infrastructure or user-specified assets. Users may select or upload an asset layer 6405, such as substations, hospitals, or residential zones. A proximity threshold is then configured 6410, which may include static or tiered buffer distances. The system may generate and display buffer zones 6415 on an interactive map with geospatial tools for polygon drawing, reshaping, and elimination of low-risk interior areas. As detected or simulated fire perimeters are processed 6420, the system may check for intersections with buffer zones and triggers alerts 6425 when breaches occur. Alerts may include asset name, tier breached, estimated time to impact, and may escalate in severity based on predefined distance tiers. Alerts are routed based on asset type, user role, or geographic region. The system logs and displays each alert 6430 within the dashboard and provides visual overlays for after-action review and operational planning.

### Simulation-Based Risk Alerts

In use cases where utilities execute large-scale ignition scenario modeling—such as PSPS planning or risk mapping—the system may automatically flag and generate alerts for simulations that exceed predefined consequence thresholds. These may include projected structure loss, financial impact, critical infrastructure exposure, or time-to-impact metrics. Alert content may include metadata such as the ignition asset, modeled burn perimeter, severity score, and expected timing of consequence. These simulation-based alerts may be visualized in the dashboard or exported for operational and regulatory use. They may also trigger events such as standing up an Emergency Operations Team to monitor a potential upcoming PSPS event.

### Unified Alert Delivery and API Access

The system supports multiple channels for alert delivery, including email, SMS, mobile push notification, automated voice calls, and secure API endpoints. Users may configure which channels apply to each alert type or severity level. API integrations allow alert data to be consumed by external platforms such as utility outage management systems, emergency dispatch platforms, or real-time dashboards.

### Parcel-Specific Fire Risk Modeling for Insurance And Mitigation Uses

In another embodiment of the present invention, the system supports use cases within the insurance industry by adapting the AI-driven fire propagation and consequence modeling tools to evaluate fire risk at the individual property level. Rather than initiating simulations from known or assumed ignition sources (e.g., utility infrastructure), this approach reverses the analysis: the system models hypothetical fire starts throughout the surrounding area to assess their potential impact on a specific structure, parcel, or community. By simulating thousands, or millions of potential ignition scenarios, randomized or constrained by historical ignition patterns, and projecting fire behavior under varied weather and fuel conditions, the system calculates an exposure profile unique to each home, building or other asset types including utility poles.

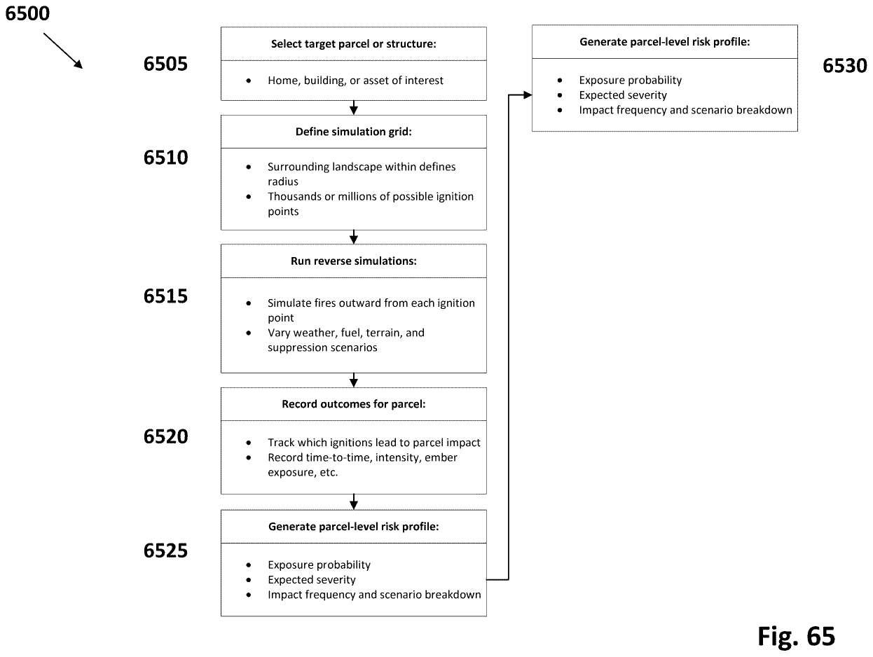

Now referring to FIG. 65, the system includes a parcel-specific fire risk modeling module 6500 designed to support insurance, mitigation, and localized risk planning. A user selects a target parcel, structure, or asset 6505, and the system defines a simulation grid 6510 over the surrounding landscape, including thousands or millions of possible ignition points. The system then runs reverse fire simulations 6515, projecting fire spread outward from each ignition point under varying weather, terrain, fuel, and suppression scenarios. As simulations progress, the system records which ignition scenarios result in parcel impact 6520, along with associated factors such as intensity, time-to-impact, and ember exposure. These records are aggregated into a parcel-level risk profile 6525, summarizing exposure probability, expected severity, and scenario frequency. Results 6530 may be used to support insurance underwriting, mitigation prioritization, or structure-specific planning decisions.

### Parcel-level Consequence Scoring and Exposure Analytics

For each simulated fire that intersects a given property or asset, the system records data such as time-to-impact, estimated flame intensity, ember exposure probability, nearest suppression resources, and suppression difficulty based on terrain and access constraints. These results are aggregated into a property-level risk score, which can be used by insurance underwriters to inform pricing, coverage decisions, and eligibility determinations. Additional scoring logic may incorporate proximity to flammable vegetation, road access for emergency response, roof and siding materials (when available via parcel or satellite imagery databases), and historical fire encroachment patterns. These home-level simulations may be executed in batch across entire neighborhoods, counties, or at the state or portfolio levels to support actuarial modeling and risk-based portfolio segmentation.

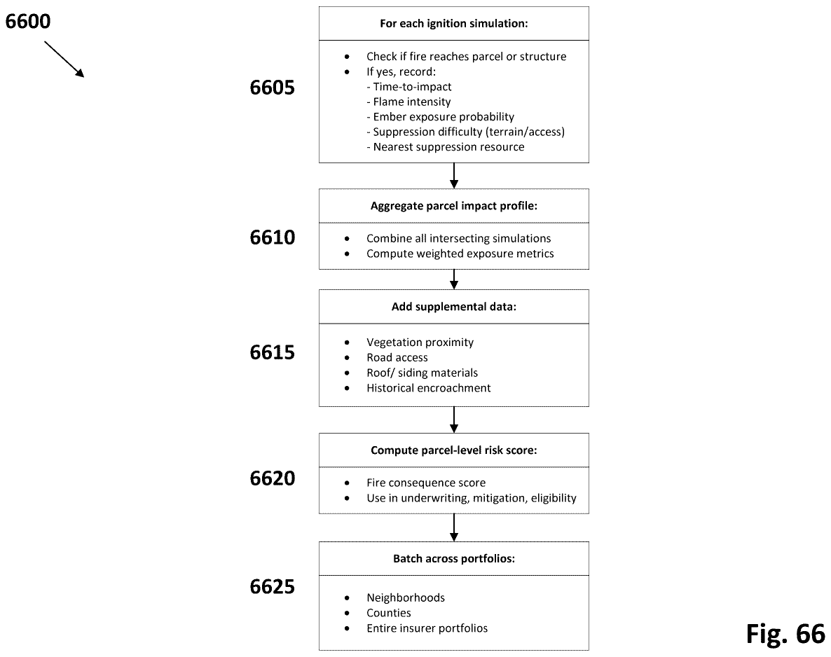

Referring now to FIG. 66, the system includes a parcel-level consequence scoring and exposure analytics framework 6600 for evaluating risk across individual structures or properties. For each ignition simulation that intersects a parcel 6605, the system records metrics such as time-to-impact, flame intensity, ember exposure probability, suppression difficulty, and proximity to suppression resources. These outcomes are aggregated 6610 to compute weighted exposure values across all contributing fire scenarios. Supplemental property-specific data 6615 such as vegetation proximity, access roads, roof and siding material, and historical fire encroachment are integrated to refine the score. The system calculates a fire consequence score 6620 for each parcel, which may be used by insurance carriers for underwriting, pricing, eligibility, and mitigation planning. The module supports batch processing 6625 across entire neighborhoods, counties, or full insurer portfolios to enable risk-based segmentation, portfolio modeling, and large-scale actuarial assessments.

### Outward Ignition Envelope Modeling for Parcel-Level Impact Estimation

Users may integrate parcel boundaries, assessor records, and construction metadata into the consequence engine via the system's data ingestion tools. Each parcel may be treated as a fixed asset of interest, and the system executes outward-spreading ignition scenarios from surrounding grid points under multiple weather profiles. The AI engine scores each parcel based on the cumulative consequences of all ignition scenarios that would lead to fire impact, allowing insurers to pre-screen properties and identify those at disproportionately high wildfire risk. This methodology provides a transparent, spatially-aware risk framework grounded in physical fire behavior and environmental data.

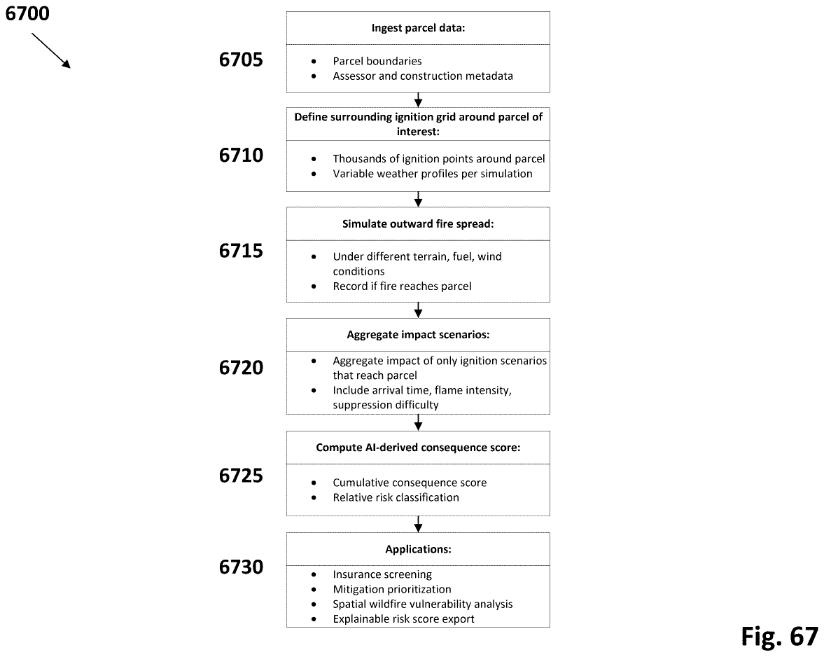

Now referring to FIG. 67, the system implements an outward ignition envelope modeling module 6700 for parcel-level risk estimation. The process begins by ingesting parcel boundaries and assessor or construction metadata 6705. The system defines an ignition grid 6710 around each parcel of interest, consisting of thousands of potential fire start locations with varied weather conditions per simulation. It then simulates fire spread outward from these points 6715 and records whether each run reaches the parcel. For all impacting ignition scenarios, the system aggregates relevant fire characteristics 6720 such as arrival time, flame intensity, suppression difficulty, and exposure probability. These are used to compute an AI-derived consequence score 6725, which provides a cumulative risk rating and relative classification. Final outputs 6730 support use cases such as insurance screening, mitigation prioritization, spatial wildfire vulnerability analysis, and explainable risk score exports.

### Batch Modeling and Underwriting at Scale

In one embodiment, the system supports batch simulation workflows that allow insurers to model fire risk across thousands or millions of parcels simultaneously. These batch jobs may be executed on regional or national portfolios using consistent environmental inputs such as terrain, vegetation, and forecasted weather. Risk scores, projected losses, and exposure indices may be output per parcel and summarized at the neighborhood, ZIP code, or county level. This capability enables insurers to classify portfolios by wildfire exposure, quantify capital-at-risk, and optimize reinsurance purchasing and policy pricing.

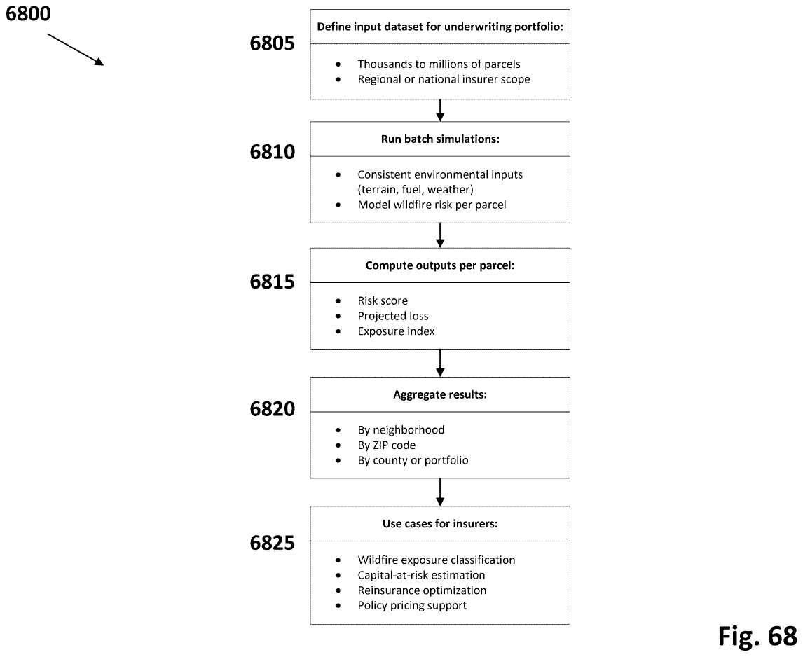

Referring to FIG. 68, the system implements a batch modeling and underwriting module 6800 that allows insurers to simulate wildfire risk across large-scale portfolios. The process begins by defining a dataset 6805 composed of thousands to millions of parcels at regional or national scale. Using consistent environmental inputs such as terrain, vegetation, and weather conditions, the system runs batch simulations 6810 to model wildfire exposure for each parcel individually. For every parcel, the system computes risk scores, projected losses, and exposure indices 6815. These outputs are then aggregated 6820 across spatial groupings such as neighborhoods, ZIP codes, or counties. Final results 6825 support use cases including wildfire exposure classification, capital-at-risk estimation, reinsurance optimization, and policy pricing. This scalable approach enables insurers to quantify and manage wildfire risk across their full property portfolio.

### Insurance Platform Interfaces and Output Formats

System outputs may be consumed through web-based dashboards, APIs, or flat file exports depending on insurer preference. Dashboards may visualize property-level risk scores, projected fire footprints, and model assumptions in map or table views. API integrations allow real-time exposure data to be embedded in underwriting workflows or third-party insurance platforms. Outputs may include structure-specific indicators such as expected loss, time-to-impact, and suppression complexity, as well as portfolio summaries for rate filings, regulatory submissions, and capital modeling.

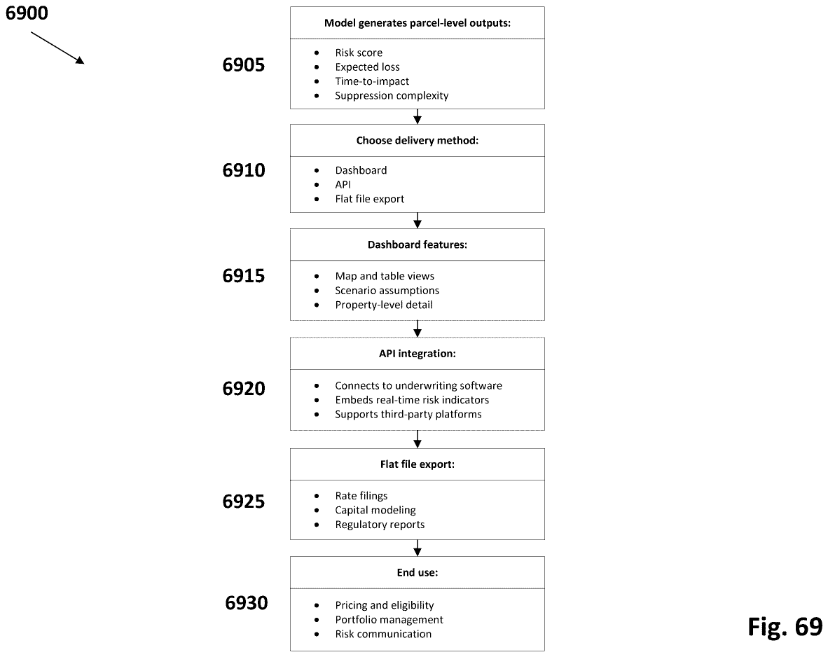

Now referring to FIG. 69, the system provides multiple interface options 6900 for delivering parcel-level fire risk outputs to insurance stakeholders. After generating outputs such as risk score, expected loss, time-to-impact, and suppression complexity 6905, the system allows users to select a preferred delivery method 6910, including web-based dashboards, API integrations, or flat file exports. Dashboards 6915 may support map and table views, show scenario assumptions, and present detailed property-level metrics. API endpoints 6920 may integrate directly into underwriting systems, embed real-time risk indicators, and support interoperability with third-party insurance platforms. Flat file exports 6925 may be used for regulatory filings, capital modeling, and internal rate reviews. Final outputs 6930 support use cases such as pricing and eligibility assessments, portfolio-level risk management, and insurer-to-regulator or customer-facing risk communication.

### Parcel-Specific Fire Behavior Modeling Framework

In one embodiment, the system tailors fire propagation modeling to individual parcel characteristics by adjusting resolution, terrain fidelity, and fuel continuity in proximity to each target structure. Fine-scale simulations may incorporate 1-5 meter resolution terrain and vegetation data around the structure, including lidar-based canopy height, surface fuel models, and vegetation density derived from high-resolution satellite or aerial imagery. Localized wind field modeling may also be incorporated using terrain-aware downscaling of mesoscale weather forecasts. These precision enhancements enable accurate prediction of flame front arrival, ember lofting paths, and defensive barrier effectiveness at the individual parcel level, improving model reliability for built environments.

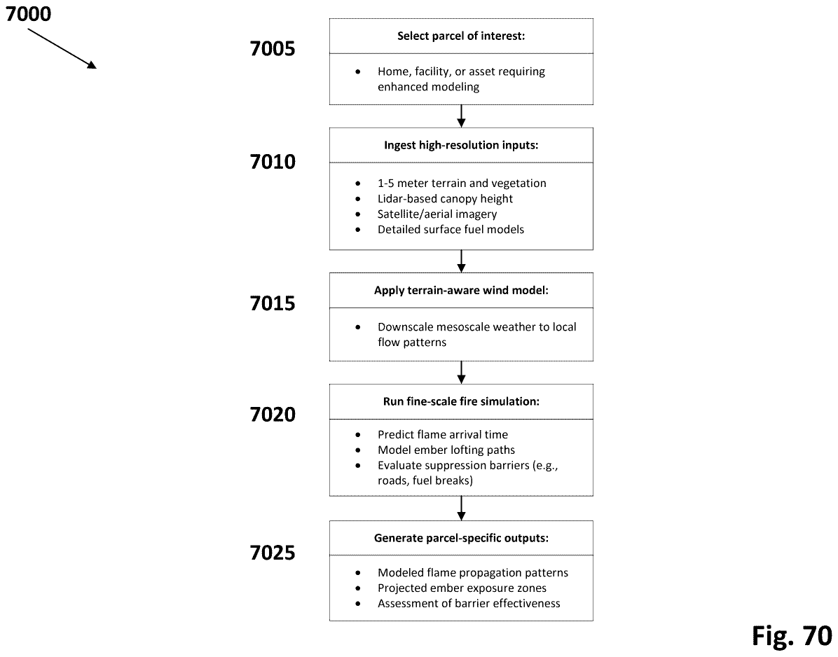

Referring now to FIG. 70, a parcel-specific fire behavior modeling framework 7000 is shown that enables enhanced simulation accuracy for high-priority structures or assets. A user may select a parcel of interest 7005, such as a home or facility requiring detailed risk analysis. The system ingests high-resolution data inputs 7010, including 1-5 meter terrain and vegetation, lidar-based canopy height, satellite or aerial imagery, and surface fuel models. A terrain-aware wind model 7015 may downscale mesoscale forecasts to reflect local flow patterns. Using these inputs, the system performs fine-scale fire simulations 7020 to predict flame propagation, simulate ember lofting, and evaluate suppression barrier effectiveness. Outputs generated per parcel 7025 may include modeled flame spread patterns, projected ember exposure zones, and assessments of local defensive features. This framework supports structure-specific wildfire consequence modeling and improves predictive fidelity for insurance, mitigation, or planning applications.

AI MODEL ARCHITECTURE FOR PARCEL RISK INFERENCE - The property risk scoring pipeline may leverage a modular AI architecture composed of spatial encoders, environmental interpreters, and risk aggregation layers. Inputs such as gridded simulation outputs, parcel boundaries, structure metadata, vegetation classifications, and wind field overlays may be passed through a convolutional neural network or vision transformer block. These spatial features are then fused with tabular inputs—such as construction type, slope class, and ingress/egress ratings—using a fully connected layer or temporal attention mechanism. The resulting vector is passed to a scoring head that outputs probability of fire impact, severity index, and loss potential for each property under modeled conditions. Weights may be trained using synthetic simulation data and validated using known historical structure loss datasets.

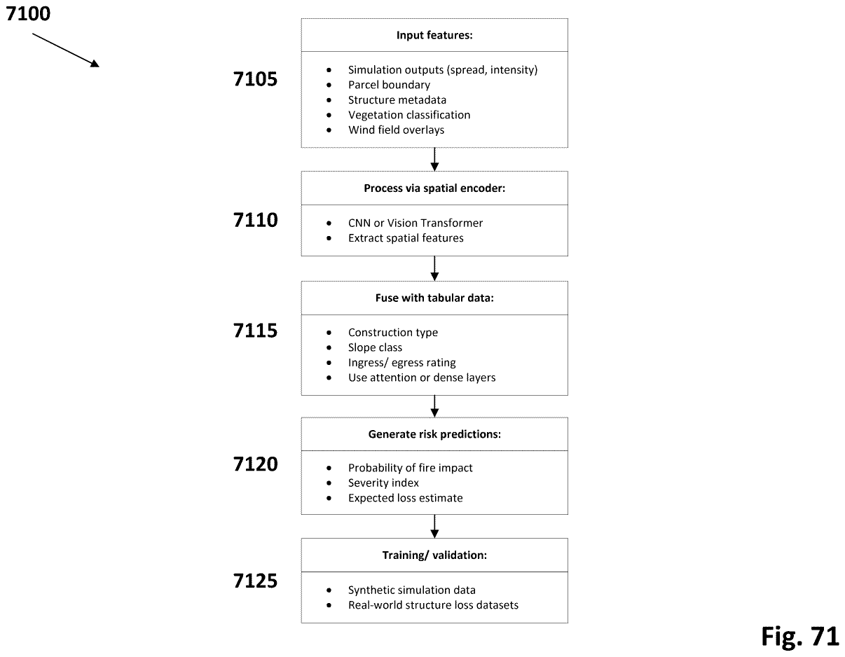

Now referring to FIG. 71, a parcel-level risk scoring architecture 7100 is shown. The system may receive a variety of input features 7105, including simulation outputs (e.g., spread and intensity), parcel boundary, structure metadata, vegetation classification, and wind field overlays. These spatial features may be processed by a spatial encoder 7110, such as a convolutional neural network or vision transformer, to extract relevant information. The extracted features may then be fused with tabular data 7115, including construction type, slope class, and ingress or egress ratings, using dense or attention-based layers. The fused representation may be passed to a prediction module 7120 that generates parcel-specific outputs, including probability of fire impact, severity index, and expected loss estimate. Model training and validation 7125 may be performed using synthetic simulation outputs and real-world structure loss datasets.

### Ground Truth Calibration Using Historical Structure Loss

To validate and improve accuracy, the system may perform calibration using historical fire perimeters intersected with actual structure loss data. Public or commercial datasets such as Damage Inspection Specialist (DINS) reports, parcel-level claims records, or post-incident aerial surveys may be ingested into the system and matched to prior simulations. A loss calibration engine evaluates false positive and false negative predictions against actual structure outcomes, adjusting feature weights or tuning parameters such as flame height thresholds, ember travel distance, or terrain penalty functions. In some embodiments, the system maintains a feedback loop that continually refines risk model behavior over time as new wildfire events and verified damage outcomes are recorded.

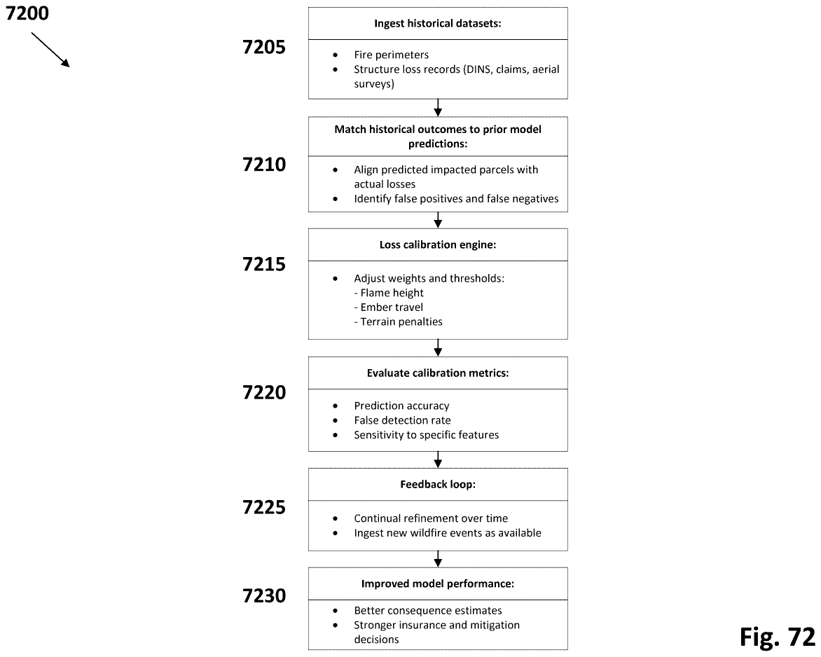

Now referring to FIG. 72, the system includes a calibration workflow 7200 for improving predictive accuracy using historical loss data. The process begins by ingesting datasets 7205 such as fire perimeters and verified structure loss records, including DINS reports, insurance claims, and aerial surveys. These are matched to prior model predictions 7210 to align predicted impacted parcels with actual loss outcomes and identify false positives and false negatives. A loss calibration engine 7215 may then adjust model thresholds or weights related to flame height, ember travel distance, and terrain penalties. The system evaluates calibration quality 7220 using metrics such as prediction accuracy, false detection rate, and sensitivity to specific features. This feedback loop 7225 enables continuous refinement over time by ingesting new wildfire events as additional data becomes available. The result is improved model performance 7130 with more accurate consequence estimates and better support for insurance and mitigation decisions.

### Future Scenario Simulation for Insurance Risk and Policy Design

In another embodiment, the system supports simulation of future insurance policy exposure under variable environmental and development scenarios. Users may model changes such as increased drought frequency, new residential developments, removal of defensible space, or installation of hardened roofing materials. These variables may be input manually or derived from planning datasets or satellite-detected land cover change. The system projects the resulting impact on parcel-level risk scores and aggregates these into portfolio-level changes in expected loss, reinsurance need, and risk class migration. This allows insurers to stress test future climate and growth scenarios, model market entry into new geographies, and pre-position risk-adjusted policy offerings.

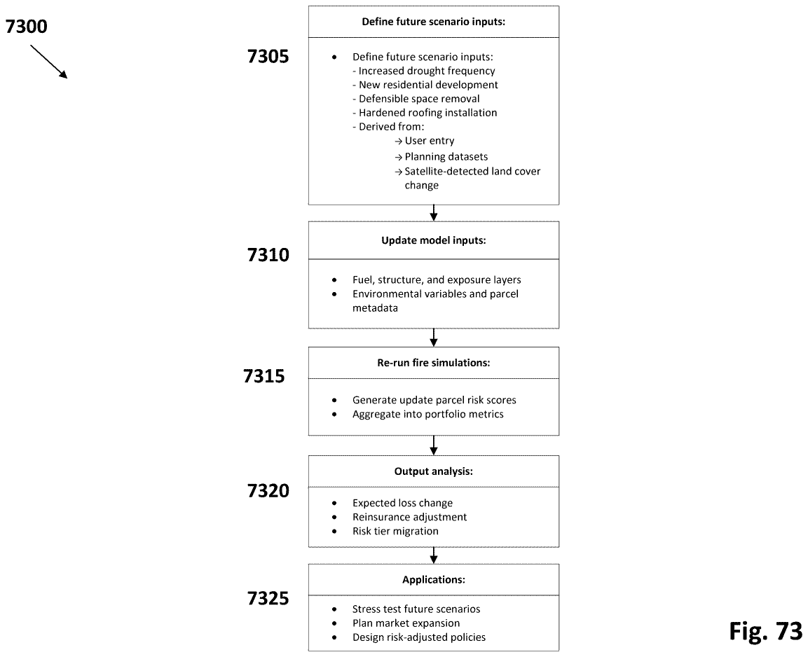

Now referring to FIG. 73, a future scenario simulation framework 7300 is illustrated for projecting insurance portfolio risk under changing environmental and development conditions. A user may define future scenario inputs 7305 such as increased drought frequency, new residential construction, removal of defensible space, or installation of hardened roofing. These changes may be entered manually or derived from planning datasets and satellite-detected land cover change. The system updates model inputs 7310 including fuel, structure, exposure, and environmental variables, then re-runs fire simulations 7315 to generate updated parcel-level risk scores. Results may be aggregated into portfolio-level metrics such as expected loss change, reinsurance adjustment, and risk tier migration 7320. Final applications 7325 may include stress testing of future scenarios, expansion into new markets, or design of risk-adjusted policy offerings.

### Vegetation Management Impact Analysis Tool

In one embodiment, the system includes a dedicated dashboard interface for evaluating the wildfire risk reduction benefits of vegetation management activities using AI-based fire propagation simulations. This tool builds upon the system's core fire modeling architecture and enables users to quantify the change in ignition potential, spread dynamics, and consequence severity before and after fuel treatments. It is intended for use by utilities, fire safe councils, public land managers, and state and federal agencies overseeing prescribed burn programs or mechanical thinning operations.

Users may ingest vegetation management areas into the system by drawing polygons directly on the map or by uploading spatial files such as shapefiles, GeoJSON, or KML. Each mitigation polygon may be tagged with metadata including treatment type, responsible party, and date of activity. The system leverages Sentinel-2 and other satellite imagery to ingest red-edge, near-infrared (NIR), and shortwave infrared (SWIR) spectral bands to characterize vegetation structure at the treatment site over time. The model uses this input to simulate fire spread from many points within and surrounding the defined mitigation area, both before and after mitigation based on the observed vegetation conditions at corresponding timestamps.

To evaluate risk reduction, the system runs matched ignition scenarios for each polygon under multiple configurations: pre-and post-treatment vegetation state, current weather, and user-defined extreme fire weather conditions. These may include custom inputs such as 50 mph wind from a specified direction, low relative humidity, and 5% Fuel Moisture Content, or percentile-based weather scenarios representing historical worst-case conditions. Simulations may incorporate terrain slope, aspect, and access constraints to evaluate suppression difficulty and time to impact.

The resulting outputs include side-by-side comparisons of modeled acres burned, asset exposure, population risk, and estimated financial loss under each scenario. The system also tracks degradation over time by allowing re-evaluation of a mitigation polygon as vegetation regrows or dries, using updated satellite data. This enables long-term performance tracking and return-on-investment calculations for each treatment, facilitating prioritization of future projects or identifying re-treatment intervals. Data may be visualized through dynamic maps, impact tables, or exported to support compliance reporting and funding justifications.

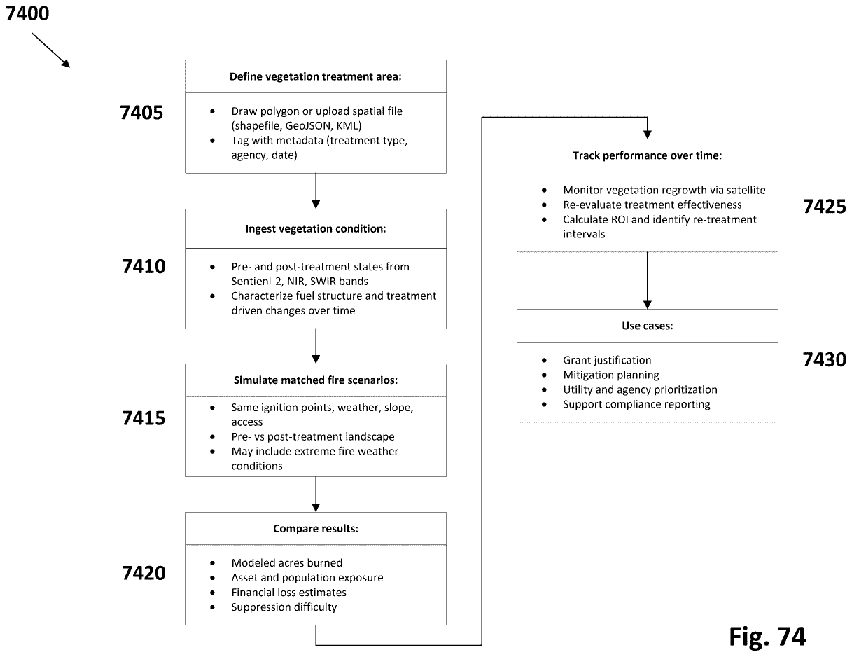

Now referring to FIG. 74, a vegetation treatment impact analysis framework 7400 is illustrated. Users may define a vegetation treatment area 7405 by drawing a polygon or uploading a spatial file, tagging it with metadata such as treatment type, agency, and date. The system ingests pre-and post-treatment vegetation condition 7410 using satellite imagery such as Sentinel-2, NIR, and SWIR bands to characterize fuel structure and treatment-driven changes over time. To evaluate mitigation effectiveness, the system simulates matched fire scenarios 7415 using identical ignition points, weather, slope, and access across pre-and post-treatment landscapes, optionally including extreme fire weather conditions. It then compares results 7420 such as modeled acres burned, asset and population exposure, financial loss estimates, and suppression difficulty. Over time, the system tracks vegetation regrowth and treatment effectiveness 7425 to support ROI calculations and identify re-treatment intervals. The outputs support use cases 7430 including grant justification, mitigation planning, utility and agency prioritization, and compliance reporting.

### Line-Level Vegetation Data Integration for Utility Risk Modeling

In one embodiment, the system supports the integration of high-resolution line-level vegetation data from third-party satellite analytics providers. These datasets may include AI-identified vegetation encroachment near overhead utility lines, classified by proximity, vegetation type, and severity of infringement. The system imports this data via API, direct shapefile upload, or periodic satellite tasking and uses it to enhance fire consequence modeling along utility corridors. Encroachment layers are aligned with utility GIS maps and dynamically intersected with simulated or forecasted fire perimeters. The system may apply increased ignition probability, spread acceleration, or consequence weighting to areas of known overgrowth or poor clearance. When paired with vegetation management history or scheduled maintenance, this integration enables utilities to evaluate risk across thousands of line segments, prioritize vegetation clearing, and assess mitigation effectiveness at the asset level.

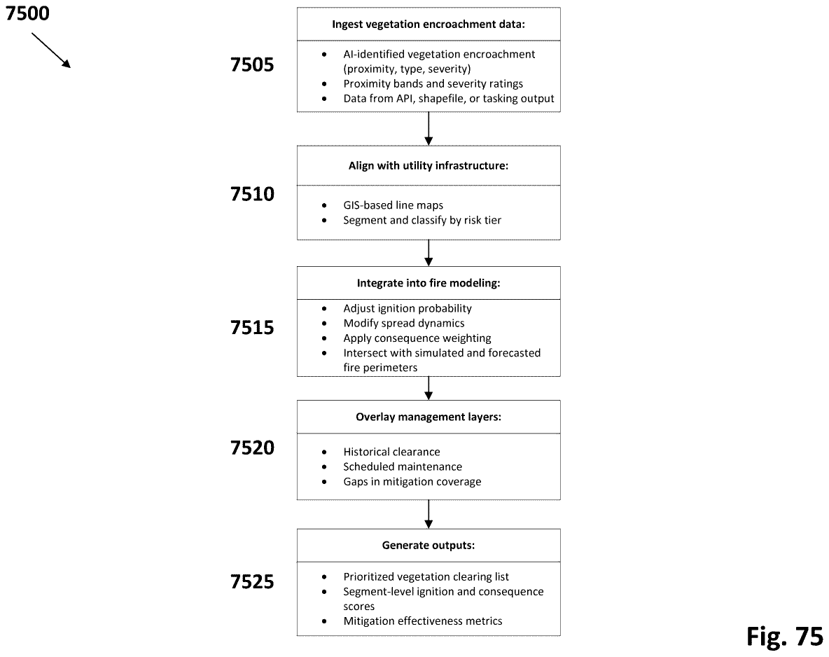

Now referring to FIG. 75, a utility vegetation risk integration workflow 7500 is shown for enhancing fire consequence modeling along line corridors. The system ingests AI-identified vegetation encroachment data 7505, classified by proximity, vegetation type, and severity, from satellite analytics providers via API, shapefile, or scheduled tasking. These layers are aligned with utility GIS infrastructure maps 7510 and segmented by line-level risk tier. The system integrates the vegetation data into fire modeling workflows 7515 by adjusting ignition probabilities, spread dynamics, and consequence weighting, while intersecting with simulated and forecasted fire perimeters. Historical mitigation activity, scheduled maintenance, and coverage gaps are overlaid 7520 to contextualize operational exposure. The resulting outputs 7525 include prioritized vegetation clearing lists, ignition and consequence scores by line segment, and effectiveness metrics for utility mitigation planning.

### Prescribed Fire Management Tool

In another embodiment of the present invention, the C&C system may include a prescribed fire management tool designed to enhance wildfire monitoring and provide users with configurable control over alert generation and the visibility of prescribed fire activity. The prescribed fire management tool enables users to input scheduling details for planned prescribed burns, including start and end dates and times of day, burn location, expected perimeter, and responsible agency or personnel. This ensures planned burns are accurately documented and displayed within the system. In some embodiments, user roles or permissions may be used to control who can create, edit, or view prescribed fire entries.

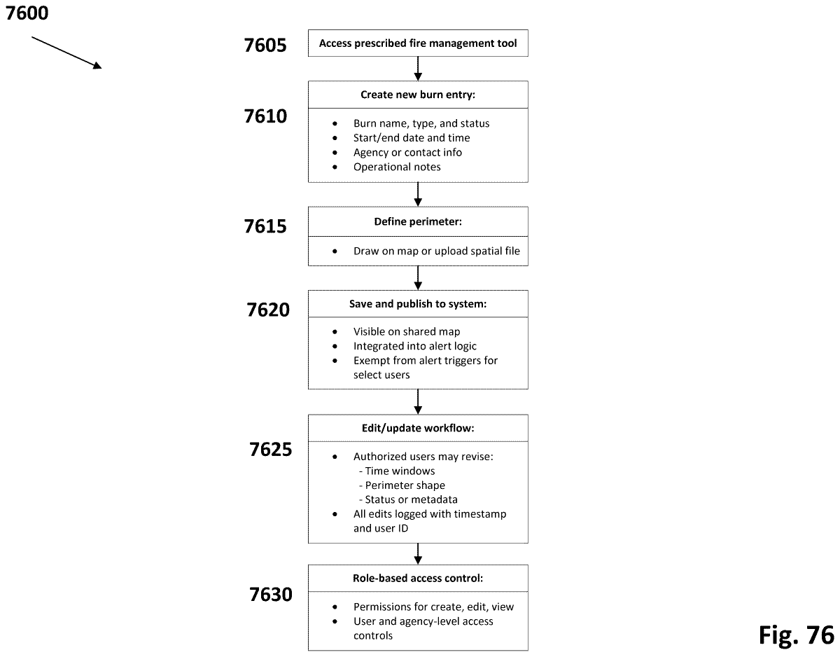

Now referring to FIG. 76, a prescribed fire management workflow 7600 is shown. Users may access a dedicated interface 7605 to document planned, prescribed burns. Within the tool, users may create new burn entries 7610 including burn name, type, status, scheduled time windows, agency or contact information, and operational notes. A perimeter may be defined 7615 by drawing on the map or uploading a spatial file such as a shapefile or GeoJSON. Once complete, the entry is published 7620 to the system, making it visible on a shared map and integrated into alert logic. In some configurations, prescribed burns may be exempt from triggering alerts for designated user groups. Authorized users may edit burn entries 7625 including start or end times, shape, status, or metadata, with all changes logged by user ID and timestamp. Role-based access control 7630 governs permissions for creating, editing, or viewing prescribed fire entries, with access restricted at the user or agency level.

### Ingestion and Visualization of Prescribed Fire Datasets

The system may ingest prescribed fire information from external sources including state forestry agencies, federal interagency fire maps, tribal land managers, utility vegetation contractors, and public alerting platforms. Data may be pulled via API, imported from scheduled endpoints, or uploaded manually using formats such as GeoJSON, KML, or shapefiles. Each prescribed burn record may include attributes such as burn type, ignition and control dates, managing agency, contact information, geographic perimeter, and operational status (e.g., planned, active, completed). These data may be visualized within the interface as map overlays with configurable display options such as outlines, semi-transparent fill, or color-coded layers based on agency, status, or proximity to monitored assets. Users may interact with burn layers to view metadata, filter by time window or region, and adjust visibility based on relevance. These visualizations support both user situational awareness and automated alert suppression workflows by distinguishing authorized prescribed burns from unplanned ignitions.

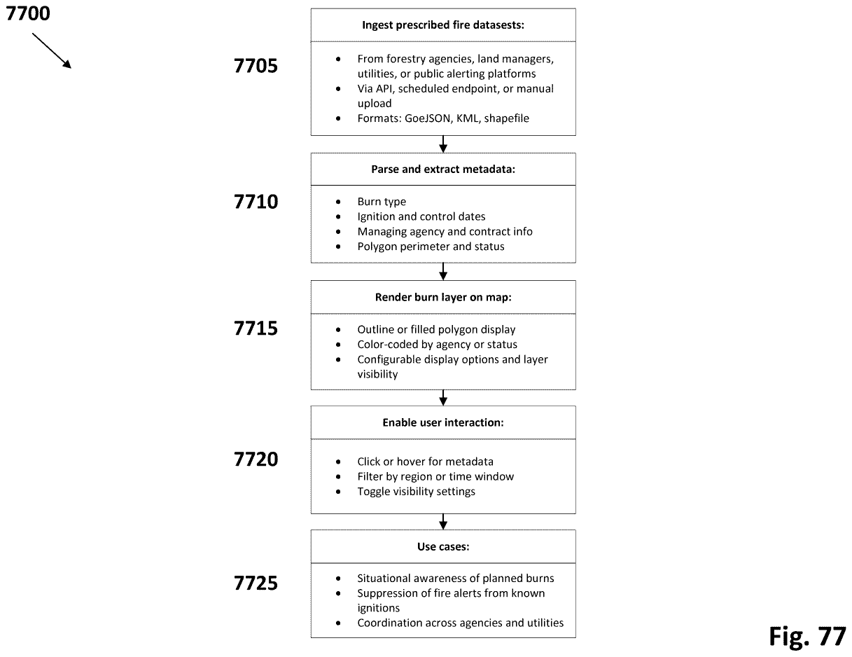

Now referring to FIG. 77, the system supports ingestion and visualization of prescribed fire datasets 7700 to enhance situational awareness and prevent false alerting from known ignitions. The system ingests prescribed fire data 7705 from external sources such as state forestry agencies, land managers, utilities, or public alerting platforms. Data may be pulled via API, scheduled endpoint, or manual upload in formats such as GeoJSON, KML, or shapefile. The system parses and extracts metadata 7710 including burn type, ignition and control dates, managing agency, contact information, polygon perimeter, and operational status. This information is rendered on the map 7715 using outline or filled polygon displays, with configurable display options and layer visibility based on agency or status. Users may interact with burn overlays 7720 to view metadata, filter by time window or region, and adjust visibility settings. This functionality supports key use cases 7725 such as coordinated awareness of planned burns, suppression of fire alerts from authorized ignitions, and multi-agency coordination.

### Custom Alert Controls for Prescribed Fires

Users may manually enable or disable AI-generated fire detection alerts for prescribed burns, allowing notifications to be received only when relevant. This functionality may be applied on a per-event, per-region, per-user, per-organization, per-device, per-alert-type, per-season, or system-wide basis. In some embodiments, alert controls may also be configured based on additional factors, including but not limited to: (i) a predefined time window, such that alerts are only active during specified hours or operational periods; (ii) the operational status of the prescribed burn (e.g., scheduled, active, completed, or unsupervised); and (iii) a calculated or forecasted risk score associated with the burn, such that alerts are only triggered if the event exceeds a threshold for potential spread, structural impact, or financial loss. These configurable controls provide flexibility for agencies, utilities, and users to tailor alert sensitivity and notification behavior based on operational needs, jurisdictional policies, or risk tolerance levels.

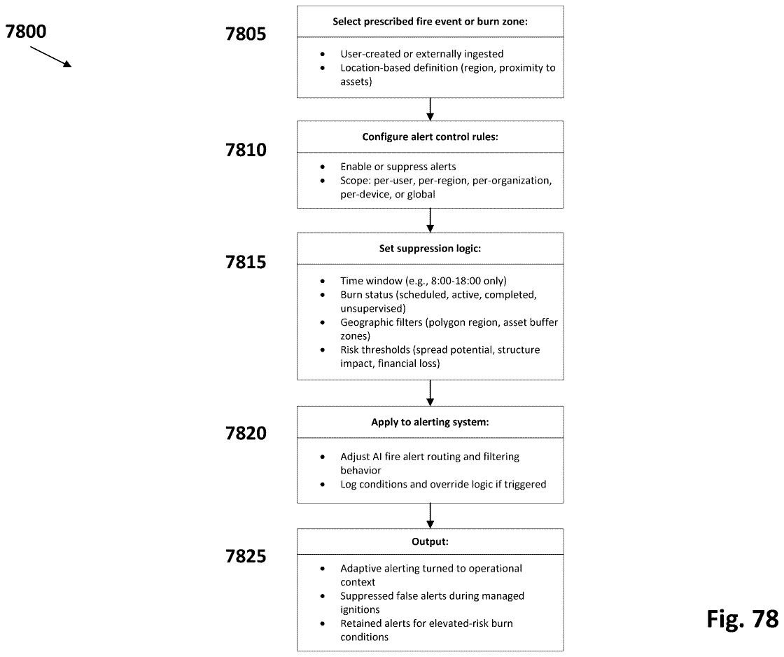

Now referring to FIG. 78, the system provides custom alert controls for prescribed fire scenarios 7800 to reduce false positives and tailor notifications to operational needs. Users may select a prescribed fire event or burn zone 7805, whether user-created or externally ingested, and define location-based parameters. The system allows configuration of alert rules 7810 to either enable or suppress alerts, with scoping options that include per-user, per-region, per-organization, per-device, or global levels. Suppression logic 7815 may incorporate factors such as defined time windows, burn status, geographic filters, or risk thresholds based on spread potential, structural impact, or financial loss. These configurations are applied to the alerting system 7820, adjusting AI-based detection routing and logging override logic when activated. The resulting output 7825 includes adaptive alerting behavior, suppression of false alerts during controlled burns, and retained alerts for high-risk conditions.

### Conditional Alert Suppression And Escalation Logic

Integration of the prescribed fire management tool with the system's alerting and AI components enables conditional suppression or escalation of alerts based on prescribed criteria. Alerts related to prescribed burns may be suppressed unless one or more defined thresholds or conditions are met. These may include: (i) the fire exceeding a specified perimeter size or spread rate; (ii) modeled encroachment into infrastructure, structures, or high-risk areas; (iii) real-time or projected crossing of jurisdictional boundaries (such as from private to public land); (iv) acreage burned exceeding a predefined threshold; (v) a calculated financial impact exceeding a specified limit, as determined by an internal or third-party risk model; (vi) deviation from the scheduled time window or burn location; or (vii) observed fire behavior inconsistent with expected prescribed fire characteristics, such as flame height, thermal signature, or smoke dispersion pattern. In some embodiments, alerts may also be conditionally triggered based on smoke detection models mapping plumes to fire perimeters, satellite-or drone-based thermal imaging, or cross-referencing with live meteorological and wind condition data to assess spread risk.

The system may include automated workflows for the notification of specific personnel or agencies if prescribed fire behavior enters an escalation threshold, and may log all suppression, override, and alert events for audit or compliance tracking. System settings may support automated or manual reclassification of prescribed fires as wildfire incidents if certain deviation conditions are met.

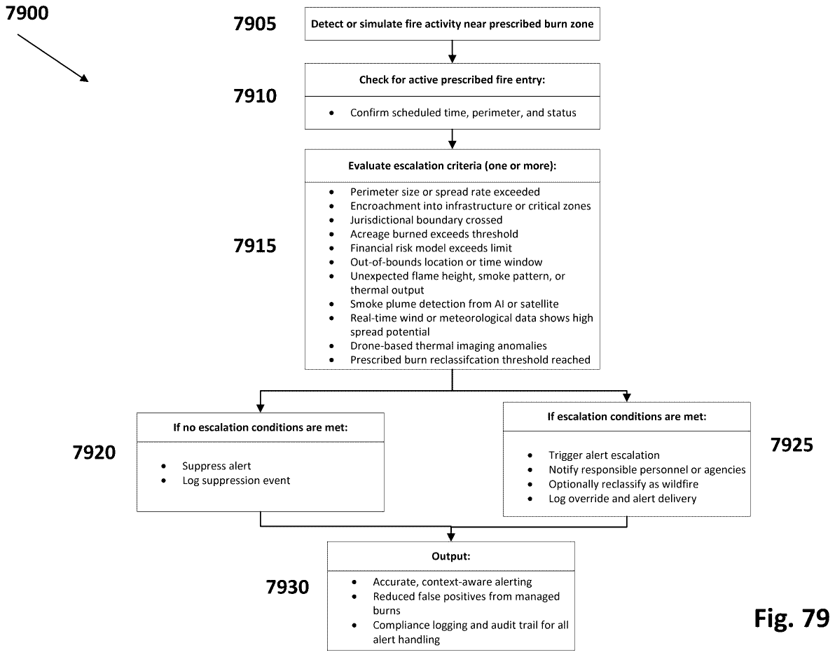

Now referring to FIG. 79, a workflow for conditional alert suppression and escalation is shown in diagram 7900. The system detects or simulates fire activity near a prescribed burn zone and checks for an active prescribed fire entry 7910 to confirm the scheduled time, perimeter, and status. It then evaluates escalation criteria 7915 to determine whether alerts should remain suppressed or be triggered. Escalation may occur if one or more conditions are met, such as perimeter size or spread rate being exceeded, encroachment into infrastructure or critical zones, jurisdictional boundary crossings, acreage burned beyond a threshold, financial risk model limits, out-of-bounds time or location, unexpected flame height, smoke pattern, or thermal output, as well as indicators from AI or satellite-based smoke plume detection, real-time meteorological data showing high spread potential, drone thermal anomalies, or a reclassification threshold being reached. If no escalation conditions are met 7920, the alert is suppressed and the event is logged. If an escalation condition is met 7925, the system triggers an alert, notifies responsible personnel or agencies, optionally reclassifies the fire as a wildfire, and logs the override. The resulting output 7930 includes accurate, context-aware alerting, reduced false positives from managed burns, and a full compliance and audit trail for all alert activity.

### Conductor Contact Risk Forecasting

In some embodiments, the system integrates forecasted or real-time meteorological data with conductor span parameters to assess potential contact risk for utility transmission and distribution assets. Environmental inputs may include sustained wind speed, peak gust magnitude and duration, wind direction relative to span orientation, temperature, precipitation, ice loading, and three-dimensional wind field estimates derived from terrain-aware rotor modeling or numerical weather prediction models. Conductor data may include span length, mid-span sag, bundle configuration, conductor type, mass per unit length, damping ratio, and tension. The system applies these inputs to physics-based swing and blowout models, which may include static deflection equations and dynamic oscillation simulations, to estimate motion envelopes. These motion envelopes are compared against regulatory clearance requirements, historical utility design clearances, and known vegetation encroachment distances to identify spans at elevated risk. The risk assessment output may be color-coded and displayed within a utility's geographic asset management interface for operational review.

### Dynamic Line Rating and Motion Correlation

In some embodiments, the system incorporates dynamic line rating (DLR) calculations into the contact risk analysis to account for electrical loading effects on conductor clearance. Line temperature, ampacity, and real-time current flow are measured or estimated from supervisory control and data acquisition (SCADA) or phasor measurement unit (PMU) data to calculate sag changes under varying load conditions. These load-related clearance changes are combined with wind-induced deflection estimates to produce an integrated clearance margin. The clearance margin is displayed within a geographic interface alongside live weather radar, wind field overlays, and forecast windows, enabling operators to evaluate risk in the context of both environmental stressors and electrical load. In some embodiments, the system may automatically adjust risk thresholds based on conductor metallurgy, span configuration, and seasonal ambient temperature profiles, consistent with utility dynamic rating policies.

### Arc Event Detection and Classification

In some embodiments, optical analysis of high-resolution camera imagery is used to detect and classify electrical arcing events associated with conductor contact. Video processing routines identify sudden increases in localized brightness along a conductor path and track temporal decay profiles over subsequent frames. Spectral filtering may be applied to distinguish electrical arc signatures from other light sources, such as vehicle headlights or lightning. Temporal features such as multi-stage intensity changes, pulse duration, and re-strike intervals are correlated to utility protection system timing, such as zone distance protection delays, auto-reclose sequences, and fault clearing intervals. The classification engine may label events as high-impedance faults, solid faults, transient contacts, or reclosing attempts, and these labels may be logged with associated geolocation, asset identifiers, and environmental conditions.

### Return Path and Fault Current Inference

In some embodiments, the system infers fault current return paths during suspected conductor contact incidents by correlating optical arc observations with grid telemetry, voltage sag magnitude and timing, feeder topology, and protection trip sequences. Voltage disturbance data may be sourced from utility-owned sensors, third-party distributed sensing networks, or customer-side monitoring devices. By analyzing the relative timing and amplitude of voltage sags across different network locations, the system may determine whether fault current returned via energized phase conductors, static shield wires, or earth ground. In some cases, the analysis may reveal current flow through circuits outside the immediate protection zone, such as coupled higher-voltage transmission lines operated by interconnected utilities. The inferred return path data can be used for forensic reporting, protection coordination review, and operational mitigation planning.

### Post-Event Forensic Reconstruction

In some embodiments, the system performs retrospective analysis of suspected conductor contact events by combining camera footage, high-resolution weather datasets, protection system logs, and dynamic modeling. The system aligns contact timing with wind gust profiles, rotor progression patterns, and conductor swing model outputs to reconstruct the environmental and mechanical conditions that led to contact. Historical numerical weather prediction reanalysis products, lidar-based vegetation clearance surveys, and SCADA archives may be ingested to provide context for the reconstruction. The analysis may determine whether the event was caused by wind-induced blowout, galloping due to ice accumulation, thermal sag from overloading, or a combination of these factors. Output reports may include animated event timelines, risk factor attribution, and clearance exceedance estimates, which may be provided to utility engineering, operations, and regulatory compliance teams.

### Preventive Asset Prioritization

In some embodiments, risk analysis results are aggregated across an electrical network to generate a prioritized list of spans and structures for operational mitigation. The prioritization algorithm may weigh factors such as modeled clearance exceedance probability, potential fault current magnitude, proximity to wildfire risk zones, and historical performance data. Mitigation actions may include targeted Public Safety Power Shutoff (PSPS) operations during forecasted high-risk periods, realignment of spans to reduce rotor exposure, reconductoring with lighter or lower-sag materials, or installation of interphase spacers. The system may store historical risk scores for each asset, enabling year-over-year trend analysis to evaluate the effectiveness of grid hardening investments and adjust capital planning strategies accordingly.

In certain embodiments, the system utilizes three-dimensional LiDAR data acquired along an overhead line corridor to determine line spacing, span geometry, and structure locations. LiDAR point cloud data may be processed to extract conductor sag profiles, crossarm positions, insulator attachment coordinates, structure locations, and structure heights. These measurements may then be fused with engineering drawing information such as plan and profile diagrams, sag-tension charts, and mechanical loading specifications. By aligning LiDAR-derived conductor positions with engineering records, the system may achieve centimeter-level accuracy in estimating span geometry and line-to-line spacing. This enhanced geometric fidelity improves the accuracy of models designed to predict conductor-to-conductor contact, particularly under dynamic wind conditions.

In one embodiment, the system processes time-series LiDAR or video data to estimate changes in conductor sag and sway over time. By comparing successive catenary fits across a span, the system may detect oscillation frequency, amplitude, and directionality of conductor motion. Such data may be combined with weather station inputs, including wind velocity and direction at multiple heights, to model the interaction between aerodynamic loading and conductor response. The system may also incorporate high-resolution forecast models, such as the High-Resolution Rapid Refresh (HRRR) and the North American Mesoscale (NAM) model, which provide gridded forecasts of wind, temperature, and boundary-layer turbulence. The integration of real-time station data with HRRR and NAM model outputs allows the system to resolve both measured and forecasted span conditions.

To supplement geometry-based modeling, dedicated sensor nodes may be attached directly to conductors. These sensor nodes may be mounted either near tower attachment points or mid-span using narrow clamp mechanisms designed to withstand line vibration and thermal expansion. Each sensor may include an accelerometer, gyroscope, inclinometer, and magnetometer to capture sway amplitude, angle offsets, and vibration signatures. A timestamped data stream from these sensors may record motion in three dimensions relative to gravity and a stationary frame of reference, allowing the system to resolve conductor angle deviations and dynamic offsets between phases.

The sensor nodes may be powered by miniature solar panels with integrated energy storage. In some embodiments, vibration-based energy harvesting may be included to extend operational life during low-sunlight conditions. The nodes may transmit data using a variety of communications techniques, including sub-GHz mesh radios, private LTE, cellular modems, or satellite links, depending on the remoteness of the installation. Data may be routed through tower-mounted gateways for aggregation and backhaul into the monitoring platform.

By integrating sensor data with weather station measurements, LiDAR-derived geometry, and mesoscale forecast outputs from HRRR and NAM, the system may train an artificial intelligence model configured to estimate hyper-local wind conditions at conductor height. The AI model may incorporate features such as conductor length, attachment geometry, sway amplitude, vibration spectra, gust factors, and wind direction relative to span orientation. Using supervised learning from labeled historical events, including relay trip records, maintenance logs, and confirmed arcing incidents, the model may output a probability distribution of conductor-to-conductor contact for each span under current and forecasted conditions.

In certain implementations, the system may generate real-time probability time series for each monitored span, updating at intervals of seconds to minutes depending on available data bandwidth. The probability output may be aggregated at circuit, substation, or regional levels, allowing operators to visualize risk concentrations across their network. When the estimated probability exceeds a configurable threshold, the system may trigger an alert, command nearby cameras to focus on the relevant span, or adjust risk weighting in fire propagation and consequence models.

The described integration of LiDAR, engineering drawings, conductor-mounted sensors, weather station data, and forecast models such as HRRR and NAM provides a multi-layered approach to conductor contact forecasting. LiDAR and engineering records establish accurate static geometry, while sensors and weather stations capture dynamic environmental response. Forecast model data extends prediction capability beyond immediate measurements by resolving evolving mesoscale conditions. The AI model synthesizes these data sources to continuously refine hyper-local risk predictions. Over time, retraining on newly collected sensor, forecast, and weather data enables the model to adapt to seasonal vegetation changes, conductor aging, and structural modifications.

In some embodiments, the system incorporates lookback study capabilities for potential previous conductor contact analysis. Historical operational datasets such as outage records, relay and recloser trip settings, oscillograph waveforms, SCADA logs, synchrophasor streams, and maintenance inspection reports may be correlated with camera imagery, historical weather station archives, and archived weather model data sets to identify prior events where conductor motion may have approached or exceeded clearance thresholds and made contact. The lookback analysis may also ingest records of historical utility-caused fires to assess whether weather and operational conditions at ignition sites align with modeled line contact scenarios. Signal processing and event correlation techniques may also be applied to distinguish between load-driven trips, wind-induced conductor slap, vegetation contacts, and other transient causes. Such retrospective studies provide utilities with forensic insight into whether past weather events or operational anomalies likely produced conductor interactions and may inform adjustments to operational thresholds, span reinforcement, or system protection settings.

In certain embodiments, the system determines safe operating thresholds for each line segment by fusing conductor geometry, sensor inputs, and forecasted weather conditions. The system may calculate clearance margins under varying wind speeds, directions, and gust profiles, and assign a probability score representing the likelihood of conductor-to-conductor or conductor-to-structure contact. Thresholds may be dynamically adjusted based on the wind angle of incidence relative to the span, such that a given speed parallel to a line may yield a lower risk percentage than the same speed acting perpendicularly. The system may also distinguish between sustained winds and gust spread in determining effective loading on conductors. Historical weather station data and archived weather model datasets, such as retrospective HRRR or NAM outputs, may be incorporated to validate and calibrate the forecasting model. In addition to probability thresholds, the system may generate known safe windspeeds for each monitored span, expressed as maximum sustained and gust speeds under which conductor contact is not expected to occur for given approach angles. These safe windspeeds may be displayed alongside forecast conditions, providing utilities with clear operating guidance. Resulting thresholds and safe windspeed values may inform Public Safety Power Shutoff (PSPS) decision-making if forecast conditions indicate that lines may exceed modeled safe operating limits. In some implementations, machine learning models trained on historical utility-caused fire events and associated weather records may provide span-specific probability distributions and safe windspeed values under both current and forecasted conditions.

Those skilled in the art will recognize that the systems, methods, and architectures described herein may be instantiated as a distributed collection of interoperable modules. These modules may be configured to operate independently or as part of an orchestrated system pipeline and may execute across heterogeneous compute environments, including cloud platforms, edge devices, embedded processors, or hybrid infrastructures. Modules may exchange data and instructions via RESTful APIs, message brokers, event-driven interfaces, or shared memory layers, and may adhere to stateless or stateful architectural principles.

System functionality may be decomposed into discrete modules comprising, without limitation: sensing and acquisition layers (e.g., optical, radio-frequency, environmental), AI-based detection and classification engines, simulation and modeling systems, vegetation monitoring and management tools, alerting and escalation workflows, risk assessment and scoring services, GIS-based visualization interfaces, user interaction and annotation tools, third-party integration bridges, communication and telemetry services, and administrative control planes. These modules may be deployed in monolithic, microservice, or containerized formats and may be horizontally or vertically scaled based on load, policy, or failure state.

Acquisition modules may include hardware and software subsystems configured to capture structured or unstructured data from image sensors, time-lapse recorders, software-defined radios, environmental probes, satellite streams, or third-party telemetry feeds. Sensor data may be received continuously or triggered by external events, policy constraints, or manual overrides. Sensor fusion may occur upstream or downstream from model input stages, with configurable resolution, frequency, and modality-based routing.

AI-driven processing modules may apply convolutional, transformer-based, or hybrid encoder architectures to perform detection, segmentation, classification, or forecasting. These may include multi-stage inference pipelines for identifying smoke plumes, vegetation encroachment, equipment anomalies, or environmental changes. Models may be executed on GPU, CPU, TPU, or FPGA-based hardware and may support version-controlled updates, ensemble voting, or confidence filtering.

Modeling and simulation components may include real-time or batch-executed fire propagation engines, fuel and wind-sensitive forecast models, consequence prediction layers, or time-to-impact estimators. Inputs to these modules may be drawn from current conditions, scenario toggles, or archived incident data. Outputs may include predicted perimeters, vector field flows, risk gradient maps, and prioritization rankings for operational assets or regions.

Alerting and escalation modules may implement configurable rule engines, proximity analyzers, tiered buffer evaluators, and temporal forecasting thresholds. Alerts may be scored, categorized, and routed to individuals, groups, or integrated systems based on metadata including asset class, geographic zone, detection confidence, or modeled severity. Alert delivery may include dashboard display, third-party push notification, system log entry, or activation of physical devices.

Visualization and GIS tools may render spatial data layers, asset overlays, vegetation indices, radio coverage predictions, and fire perimeter projections. Interfaces may support map-based interaction, polygon manipulation, scenario toggling, and time-series playback. Views may be filtered or enriched based on user role, region, data source, or system state, and may support mobile, desktop, or embedded visualization endpoints.

Communication and interoperability modules may facilitate bidirectional integration with CAD platforms, SCADA systems, dispatch interfaces, Watch Duty feeds, vegetation planning databases, and public alerting frameworks. Supported protocols may include HTTPS, MQTT, WebSockets, gRPC, or custom-defined handlers. Access may be governed by token-based authentication, role-based access control, and end-to-end encryption policies.

Administrative and configuration modules may include system health dashboards, audit logs, deployment monitors, scenario configuration interfaces, user and permission management, and module orchestration tools. These modules may support dynamic policy updates, real-time diagnostics, failure isolation, and rollback of model or logic changes. Event tracing, version tagging, and historical playback tools may support operational review and compliance reporting.

Modular extensibility is supported across data ingestion, AI processing, visualization, integration, and control layers. New models, connectors, user interfaces, alert types, and policy modules may be registered or instantiated at runtime. Modules may be dynamically bound or decoupled based on detected system topology, connectivity state, or mission objective, without requiring codebase recompilation or system redeployment.

This architecture enables deployment of the disclosed system as a fully integrated wildfire intelligence and response platform or as a federated collection of interoperable subsystems supporting wildfire detection, vegetation management, infrastructure protection, radio coverage planning, emergency alerting, and situational awareness. Operational modes may include always-on monitoring, event-triggered activation, scheduled risk scanning, or on-demand analysis. The system may serve as a primary control layer or as an augmentation module embedded within existing emergency management or utility operations infrastructure.

Although the invention has been described in detail with reference to several embodiments, additional variation and modifications exist within the scope and spirit of the invention as described and defined in the following claims.

We claim:

1. A monitoring system, comprising:
a plurality of digital image-capturing devices positioned in an area for which monitoring is desired;
one or more displays for presenting images captured by said digital image-capturing devices to users of said monitoring system;
a user interface; and
control software utilizing artificial intelligence configured to:
(i) analyze imagery from said digital image-capturing devices to automatically detect one or more objects of interest including fire and/or smoke;
(ii) determine a geolocation of said one or more detected objects of interest using one or more of: pixel-based image matching, precise camera position data with a digital elevation model and landmark comparison;
(iii) generate and transmit an alert containing said one or more detected objects of interest together with associated image data, geographic location and/or map overlay;
(iv) initiate a fire propagation model predicting spread of said one or more detected objects of interest over time, said propagation model producing outputs including tabular and graphical data of projected burn area, threatened infrastructure, population exposure and/or estimated financial loss; and
(v) filter, suppress and/or prioritize alerts based on said propagation model outputs, including one or more thresholds for area burned, structures impacted, population affected and/or financial loss.

2. The monitoring system of claim 1, wherein said plurality of digital image-capturing devices comprise static, pan, tilt, and/or zoom functionality.

3. The monitoring system of claim 1, wherein said alert includes embedded camera imagery and a snapshot of said fire propagation model outputs.

4. The monitoring system of claim 1, wherein said fire propagation model outputs include a time series of tables and graphs showing projected spread at multiple forecast intervals.

5. The monitoring system of claim 1, further comprising one or more APIs configured to communicate alerts and propagation outputs to third-party systems including utility operations, dispatch centers or mobile devices.

6. The monitoring system of claim 1, wherein said control software is further configured to scan said area in a pre-established camera pattern, interrupt said pattern based on priority inputs, and resume said pattern after priority imagery is captured.

7. The monitoring system of claim 1, wherein said control software is further configured to generate a panoramic image by capturing imagery from multiple cameras at a common azimuth and different elevations.

8. The monitoring system of claim 1, wherein said control software is further configured to, upon receipt of a user-selected target location, direct one or more cameras toward said target location and display imagery of said target location in a quilt format.

9. The monitoring system of claim 1, wherein said alert filtering comprises suppressing alerts unless predicted spread exceeds a pre-determined threshold of burned acreage.

10. The monitoring system of claim 1, wherein said alert filtering comprises prioritizing alerts when predicted spread threatens critical infrastructure including utility transmission or distribution assets.

11. The monitoring system of claim 1, wherein said artificial intelligence is trained using historical imagery, environmental data, satellite data, aircraft telemetry, and contextual data processed by convolutional encoders, transformer models and/or self-attention networks.

12. The monitoring system of claim 1, wherein said propagation model incorporates weather data, vegetation and fuel mapping, land cover data, and terrain data in combination with real-time camera imagery.

13. The monitoring system of claim 1, wherein said alerts are communicated to users via one or more of: system display interface, email, text message, mobile application notification and dispatch system integration.

14. The monitoring system of claim 1, wherein said control software is further configured to generate an incident log comprising detections, alert transmissions and associated propagation model outputs for use in after-action analysis.

15. A method for monitoring and predictive wildfire analysis, comprising:
(i) capturing imagery of an area of interest using a plurality of digital image-capturing devices;
(ii) analyzing said captured imagery with artificial intelligence to automatically detect an object of interest including fire and/or smoke;
(iii) determining a geolocation of said detected object of interest using one or more of: pixel-based image matching, precise camera position data with a digital elevation model and landmark comparison;
(iv) generating and transmitting an alert containing said detected object of interest together with associated image data, geographic location and/or map overlay;
(v) executing a fire propagation model predicting spread of said detected object of interest over time, said propagation model producing outputs including tabular and graphical data of projected burned area, threatened infrastructure, population exposure and estimated financial loss; and
(vi) filtering, suppressing, or prioritizing alerts based on said propagation model outputs, including one or more thresholds for acres burned, structures impacted, population affected and/or financial loss.

16. The method of claim 15, further comprising capturing imagery of an area of interest using a plurality of digital image-capturing devices with static, pan, tilt, and/or zoom functionality.

17. The method of claim 15, further comprising embedding said captured image and a snapshot of said propagation model outputs in the alert.

18. The method of claim 15, further comprising scanning said area of interest in a pre-established camera pattern, interrupting said pattern responsive to a priority input, and resuming said pattern once said priority imagery is captured.

19. The method of claim 15, further comprising generating a panoramic image by capturing imagery from multiple cameras at a common azimuth and different elevations.

20. The method of claim 15, further comprising, responsive to a user selection of a target location within an image, directing one or more cameras to said target location and displaying captured imagery in a quilt format.

21. The method of claim 15, further comprising filtering by suppressing alerts unless predicted fire spread exceeds a pre-determined acreage threshold.

22. The method of claim 15, further comprising filtering by prioritizing alerts when predicted fire spread threatens critical infrastructure including utility transmission or distribution assets.

23. The method of claim 15, further comprising training said artificial intelligence using historical imagery, environmental data, satellite data, aircraft telemetry, and contextual data processed by convolutional encoders, transformer models, or self-attention networks.

24. The method of claim 15, further comprising incorporating into said fire propagation model weather data, vegetation and fuel mapping, land cover data and terrain data in combination with real-time camera imagery.

25. The method of claim 15, further comprising communicating said alert to users via one or more of: system display interface, email, text message, mobile application notification and dispatch system integration.

26. The method of claim 15, further comprising generating an incident log comprising detections, alert transmissions, and associated propagation model outputs for use in after-action analysis.

27. A non-transitory computer-readable medium storing instructions that, when executed by one or more processors, cause the processors to perform a method comprising:
(i) capturing imagery of an area of interest using a plurality of digital image-capturing devices;
(ii) analyzing said captured imagery with artificial intelligence to automatically detect an object of interest including fire and/or smoke;
(iii) determining a geolocation of said detected object of interest using one or more of: pixel-based image matching, precise camera position data with a digital elevation model and landmark comparison;
(iv) generating and transmitting an alert containing said detected object of interest together with associated image data, geographic location and/or map overlay;
(v) executing a fire propagation model predicting spread of said detected object of interest over time, said propagation model producing outputs including tabular and graphical data of projected burned area, threatened infrastructure, population exposure and/or estimated financial loss; and
(vi) filtering, suppressing, and/or prioritizing alerts based on said propagation model outputs, including one or more thresholds for acres burned, structures impacted, population affected and financial loss.

28. The non-transitory computer-readable medium of claim 27, wherein said alert includes embedded camera imagery and a snapshot of said fire propagation model outputs.

29. The non-transitory computer-readable medium of claim 27, wherein said instructions further cause the processors to scan said area of interest in a pre-established camera pattern, interrupt said pattern responsive to a priority input, and resume said pattern after priority imagery is captured.

30. The non-transitory computer-readable medium of claim 27, wherein said instructions further cause the processors to generate a panoramic image by capturing imagery from multiple cameras at a common azimuth and different elevations.

31. The non-transitory computer-readable medium of claim 27, wherein said instructions further cause the processors to, responsive to a user selection of a target location within an image, direct one or more cameras to said target location and display captured imagery in a quilt format.

32. The non-transitory computer-readable medium of claim 27, wherein said filtering comprises suppressing alerts unless predicted fire spread exceeds a pre-determined acreage threshold.

33. The non-transitory computer-readable medium of claim 27, wherein said filtering comprises prioritizing alerts when predicted fire spread threatens critical infrastructure including utility transmission or distribution assets.

34. The non-transitory computer-readable medium of claim 27, wherein said artificial intelligence is trained using historical imagery, environmental data, satellite data, aircraft telemetry, and contextual data processed by convolutional encoders, transformer models, or self-attention networks.

35. The non-transitory computer-readable medium of claim 27, wherein said fire propagation model incorporates weather data, vegetation and fuel mapping, land cover data, and terrain data in combination with real-time camera imagery.

36. The non-transitory computer-readable medium of claim 27, wherein said instructions further cause the processors to generate an incident log comprising detections, alert transmissions, and associated propagation model outputs for use in after-action analysis.
